(19) United States
(12) Patent Application Publication
(10) Pub. No.: US 2026/0172123 A1
(43) Pub. Date: Jun. 18, 2026

(54) DEVICE, SYSTEMS, AND METHODS FOR BODY AREA NETWORK COMMUNICATIONS

(71) Applicant: Meta Platforms Technologies, LLC, Menlo Park, CA (US)

(72) Inventors: Vignesh Manohar, Toronto (CA); Benjamin Cook, Woodinville, WA (US); Eduardo Jorge Da Costa Bras Lima, Santa Clara, CA (US); Liang Han, Sunnyvale, CA (US); Sean Korphi, Menlo Park, CA (US); Djordje Tujkovic, Los Altos, CA (US); Jiang Zhu, Hillsborough, CA (US); Junfeng Xu, Sammamish, WA (US); Abhishek Kumar Agrawal, Bellevue, WA (US); Arsalan Khan, Santa Clara, CA (US); Claudio Rafael Cunha Monteiro Da Silva, Santa Clara, CA (US); Hongyu Zhou, Burlingame, CA (US)

(21) Appl. No.: 19/425,877

(22) Filed: Dec. 18, 2025

Related U.S. Application Data
(60) Provisional application No. 63/735,335, filed on Dec. 18, 2024.
(60) Provisional application No. 63/760,327, filed on Feb. 19, 2025.
(60) Provisional application No. 63/780,662, filed on Mar. 31, 2025.
(60) Provisional application No. 63/781,783, filed on Apr. 1, 2025.
(60) Provisional application No. 63/841,847, filed on Jul. 10, 2025.

(51) Int. Cl. H04B 13/00; H04B 1/034

(52) U.S. Cl. CPC H04B 13/005; H04B 1/0343

(57) ABSTRACT

A wearable device configured to communicate via a body area network is disclosed herein. The wearable device includes a transmitter integrated into the wearable device including at least one transmitter electrode electrically coupled to a body of a wearer, the transmitter configured to transmit one or more signals to a second wearable device, a variable impedance component coupled to the transmitter, and at least one floating ground integrated into the wearable device and electrically insulated from the body of the wearer.

### PRIORITY AND RELATED APPLICATIONS

This application claims priority to U.S. Provisional Application No. 63/735,335, titled “Devices, Systems, And Methods For Enhancing Wearable Device Communication,” filed Dec. 18, 2024, U.S. Provisional Application No. 63/760,327, titled “Human Body Communication Via Electronic Wrist-Worn Devices,” filed Feb. 19, 2025, U.S. Provisional Application No. 63/780,662, titled “Outphasing Transmitter System For Body Area Network,” filed Mar. 31, 2025, U.S. Provisional Application No. 63/781,783, titled “Adaptive Impedance Tuning For Human Body Communications Networks,” filed Apr. 1, 2025, and U.S. Provisional Application No. 63/841,847, titled “Electronic Devices For Generating A Body Area Network For Robust Body Communication,” filed Jul. 10, 2025, each of which is hereby incorporated by reference in its entirety.

### TECHNICAL FIELD

The present disclosure generally relates to Body Area Network (BAN) communication systems for wearable devices, including but not limited to electronic devices with multiple electrical contacts and impedance matching networks that utilize the human body as a conductive medium for signal transmission.

### BACKGROUND

Wireless communication technologies have enabled connectivity between electronic devices in various contexts. Traditional wireless communication methods, such as Bluetooth, Wi-Fi, and Ultra-Wideband (UWB), transmit signals through the air between devices. These technologies have been widely adopted in consumer electronics, including wearable devices such as smartwatches, fitness trackers, earbuds, and head-mounted displays.

However, traditional wireless communication methods face several challenges when implemented in wearable devices, including high power consumption that reduces battery life, susceptibility to interference from other wireless devices, and body shadowing effects where human tissue absorbs or reflects electromagnetic energy, creating areas of reduced signal strength that degrade communication quality between devices positioned on different parts of the body. Security concerns also arise as radio frequency signals can propagate beyond the immediate vicinity of the user, potentially allowing unauthorized devices to intercept communications involving sensitive personal data such as health monitoring or biometric information.

### SUMMARY

Human body communication, also known as BAN communication, represents an alternative approach that leverages the electrical conductivity and permittivity characteristics of human tissue to transmit signals between devices at certain frequencies. A BAN can leverage the properties of human body conductivity and permittivity to establish a quasi-static field distribution. This approach significantly reduces interference and enhances the security of data transmission within the network. A BAN may be implemented using Human Body Communication (HBC) technology which includes placing electrodes in contact with the human body. For example, one electrode may be positioned to contact the body directly, while another is positioned away from the body to remain floating. This configuration can facilitate the creation of the quasi-static field distribution, which allows for reduced/minimized interference from external sources and improved communication security.

However, implementing BAN communication presents technical challenges, including accounting for impedance characteristics of human tissue that vary significantly between individuals and change based on factors such as skin moisture, contact pressure, body position, and environmental conditions. Electrode design and placement also present challenges, as maintaining consistent electrical contact between electrodes and the user's skin can be difficult while accommodating different user anatomies and wearing preferences, and minimizing parasitic capacitance while ensuring adequate signal coupling requires careful consideration of electrode positioning and circuit design.

The present disclosure addresses these challenges through various approaches for implementing BAN communication in wearable devices. For example, having at least one electrode firmly contacting the user's body poses a significant challenge as the contact between the electrode and the body will depend largely on how the user handles and/or positions the device. As an example, if glasses are considered, tightness of fit, thickness of hair, presence of hats/caps, etc. can impact the quality of contact. If the contact between the electrode and the body is poor, the communication link drops significantly.

Additionally, BAN systems face a conflict between data rate and power consumption. Some designs may achieve low power consumption by using constant-envelope modulations such as on-off keying (OOK) or frequency-shift keying (FSK) that enable the use of nonlinear amplifiers with high efficiency, but these modulations limit the achievable data rate. To boost data rate, higher-order modulations such as quadrature phase-shift keying (QPSK) or quadrature amplitude modulation (QAM) may be used, but due to their high peak-to-average power ratio (PAPR), linear amplifiers must be used which have relatively low efficiency. The present disclosure addresses this challenge through an outphasing transmitter system that decomposes an input signal into two constant-amplitude signals with specific phase angles, allowing the use of highly efficient switch-mode amplifiers for each path while still achieving the desired amplitude-modulated output signal through vector combination, thereby enhancing power efficiency while maintaining high data rate capability.

In some aspects, wearable devices may include multiple electrical contact points positioned at different locations on the device (e.g., to provide redundancy in establishing body contact), which allows the devices to maintain reliable communication links even when one or more contact points experience reduced contact quality due to factors such as hair thickness, device fit tightness, or the presence of clothing/accessories. For example, a head-wearable device such as augmented-reality glasses may include contact points at the nose bridge, nose pads, and temple arms, allowing the system to select contact points with the best signal quality for transmission. By incorporating multiple electrodes that can contact the body at different locations, the wearable device is able to provide a robust communication link, even if one or more contact points are temporarily disrupted. The use of multiple contact points addresses the challenge of maintaining firm electrode contact, thereby enhancing the reliability and effectiveness of HBC in electronic devices.

In some aspects, wearable devices may incorporate variable impedance components that can be adjusted based on detected body impedance conditions, allowing the devices to adapt to variations in body impedance that occur (e.g., due to user movement, changes in device positioning, or environmental factors). The variable impedance components may operate using closed-loop feedback from a receiver to adjust transmission impedance, or may use open-loop approaches that select impedance values from lookup tables based on detected conditions. This adaptive impedance tuning can provide improved signal-to-noise ratio, enhanced communication range and stability, reduced power consumption by optimizing transmission efficiency, and more robust system performance across varying user scenarios and environmental conditions.

In some aspects, floating ground electrodes may be integrated into wearable devices using conductive structures such as display shields, touch sensors, transparent conductive layers, or antenna elements, which can provide sufficient surface area for return path capacitance while being positioned away from the user's skin (e.g., to reduce parasitic capacitance that could degrade link performance). This configuration can provide improved link budget by maximizing return path capacitance to earth ground, reduced signal attenuation by minimizing parasitic coupling between the floating ground and the body, and efficient use of existing device components to serve dual purposes without requiring additional dedicated hardware.

In some aspects, the electrodes used for BAN signaling can be shared with other functions such as charging contacts in earbuds or electromyography sensors in wrist-wearable devices, using time-sharing circuitry and/or frequency-based separation thereby allowing the electrodes to serve multiple purposes. This electrode sharing approach can provide reduced device complexity and component count, more compact form factors suitable for small wearable devices, lower manufacturing costs, and optimized use of limited surface area available for skin contact in constrained device geometries.

In some embodiments, a wearable device is configured to communicate via a body area network. The wearable device includes a transmitter having at least one transmitter electrode electrically coupled to a body of a wearer, the transmitter configured to transmit one or more signals to a second wearable device. The wearable device also includes a variable impedance component coupled to the transmitter, and at least one floating ground integrated into the wearable device and electrically insulated from the body of the wearer. This configuration can provide improved signal-to-noise ratio through optimized impedance matching that adapts to variations in body impedance, enhanced communication range and link stability by maximizing return path capacitance to earth ground while minimizing parasitic capacitance between the floating ground and the body, reduced power consumption through efficient signal transmission that leverages the body's conductivity and permittivity characteristics, and improved security due to signals being concentrated in or around the human body and decaying quickly with distance, thereby reducing the risk of interception by external devices.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a block diagram of an example device and system for wearable device communication, in accordance with some embodiments.

FIGS. 2A and 2B illustrate example wearable devices configured for BAN communication, in accordance with some embodiments.

FIGS. 3A-3F illustrate example wearable devices configured for BAN communication, in accordance with some embodiments.

FIGS. 4A-4C illustrate example BANs between devices, in accordance with some embodiments.

FIGS. 4C and 4D illustrate example circuits for BAN communication, in accordance with some embodiments.

FIG. 5 illustrates another example BAN system, in accordance with some embodiments.

FIGS. 6A-6D illustrate example components for BAN communication, in accordance with some embodiments.

FIG. 7 is a flow diagram of an example method for BAN communications, in accordance with some embodiments.

FIG. 8 illustrates example outphasing signals, in accordance with some embodiments.

FIG. 9 illustrates an example architecture for an outphasing transmitter system for a BAN device, in accordance with some embodiments.

FIG. 10 illustrates an example transmitter portion for an outphasing transmitter system for a BAN device, in accordance with some embodiments.

FIG. 11 is a flow diagram of an example method for transmitting a signal in a BAN system using an outphasing transmitter system, in accordance with some embodiments.

FIGS. 12A, 12B, 12C-1, 12C-2, 12D-1, and 12D-2 illustrate example MR and AR systems, in accordance with some embodiments.

FIG. 13A is an illustration of an example wrist-wearable device of an artificial-reality system, in accordance with some embodiments.

FIG. 13B is an illustration of an example wearable artificial-reality system, in accordance with some embodiments.

FIG. 14A is an illustration of an example augmented-reality system, in accordance with some embodiments.

FIG. 14B-1 is an illustration of an example virtual-reality system, in accordance with some embodiments.

FIG. 14B-2 is an illustration of another perspective of the virtual-reality system shown in FIG. 14B-1, in accordance with some embodiments.

FIG. 14C is a block diagram showing example system components of artificial-and virtual-reality systems, in accordance with some embodiments.

FIGS. 15A and 15B illustrate an example intermediary device, in accordance with some embodiments.

FIGS. 16A and 16B illustrate an example haptic feedback device, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

As described in greater detail below, the present disclosure describes, amongst other things, devices configured to communicate via a body area network. Such devices may include a transmitter including at least one transmitter electrode electrically coupled to a body of a wearer, where the transmitter is configured to transmit one or more signals to a remote device (e.g., a different device worn by the user). Such devices can further include a variable impedance component (e.g., an impedance-matching circuit) coupled to the transmitter, and at least one floating ground that is electrically insulated from the body of the wearer. The example device can provide improved signal-to-noise ratio through impedance matching that adapts to variations in body impedance, enhanced communication range and link stability by improving return path capacitance to earth ground while reducing parasitic capacitance between the floating ground and the body, reduced power consumption through efficient signal transmission that leverages the body's conductivity and permittivity characteristics, and improved security as compared to conventional wireless communication systems.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

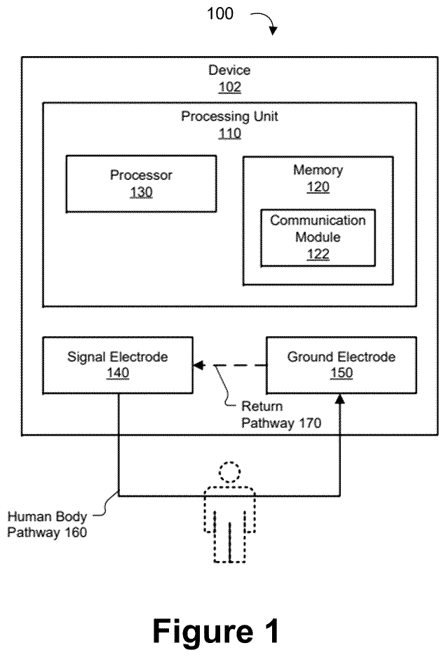

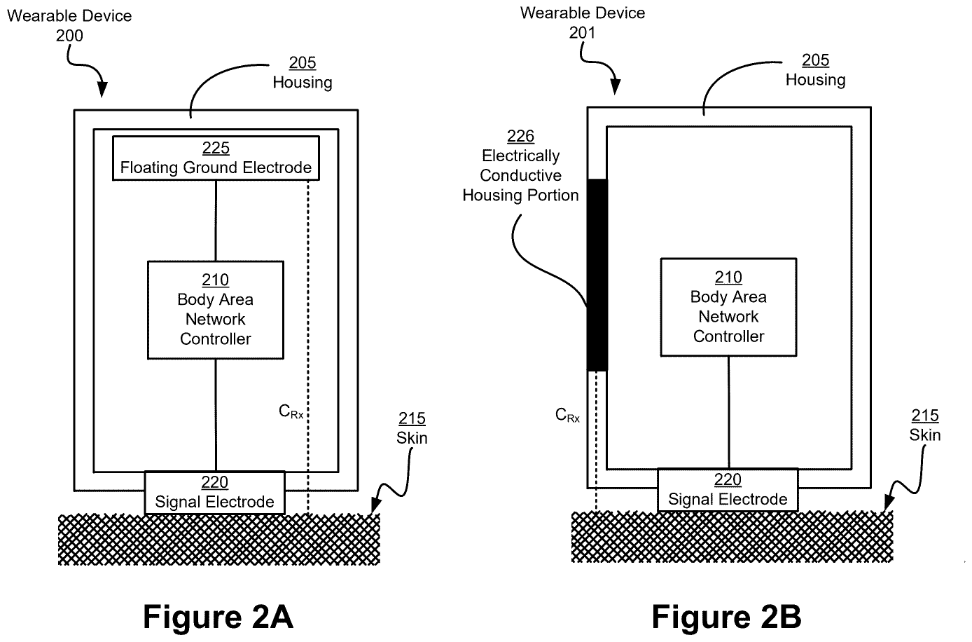

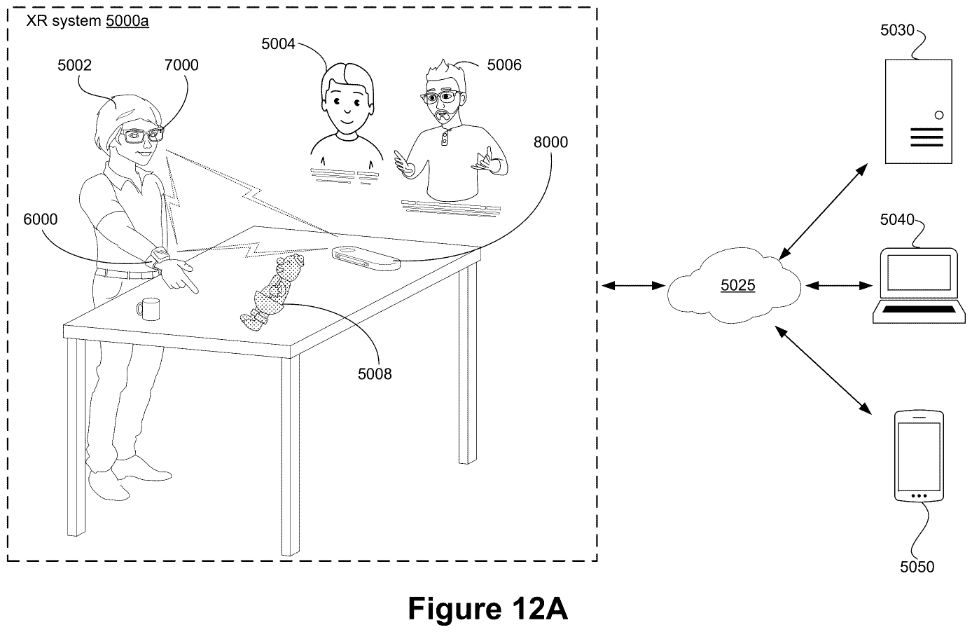

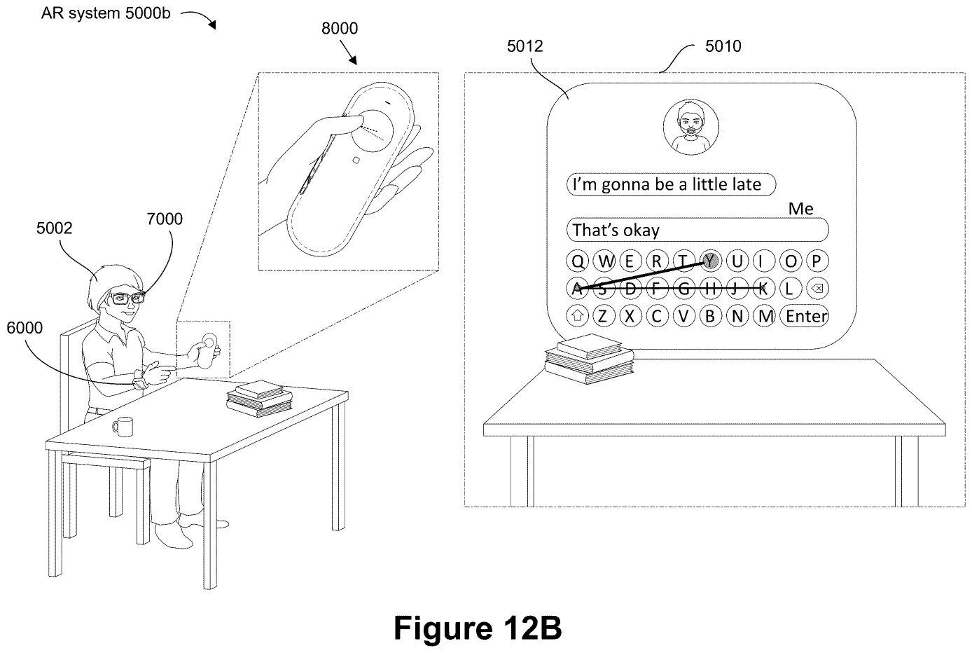

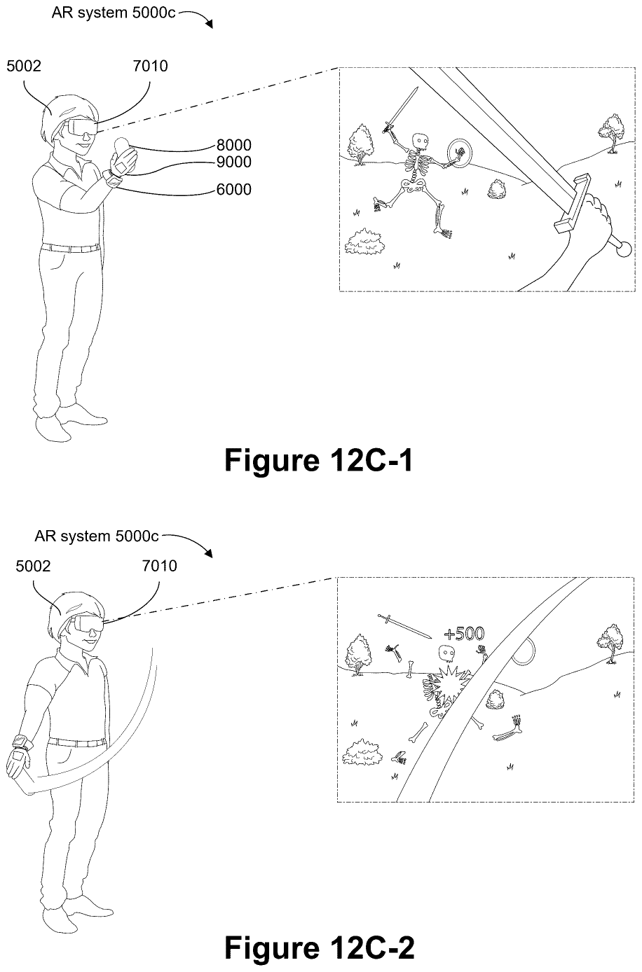

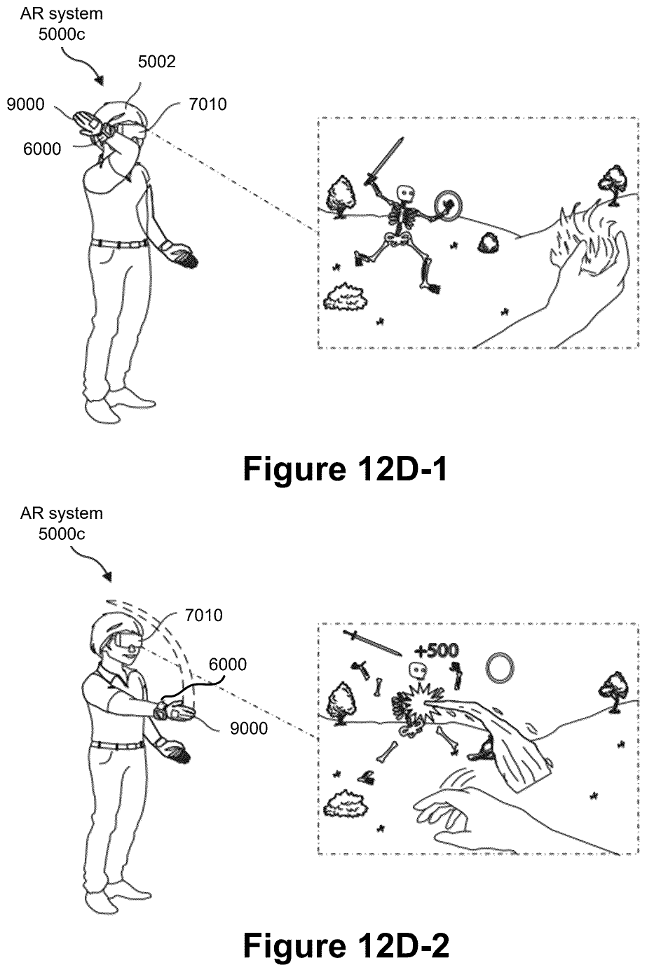

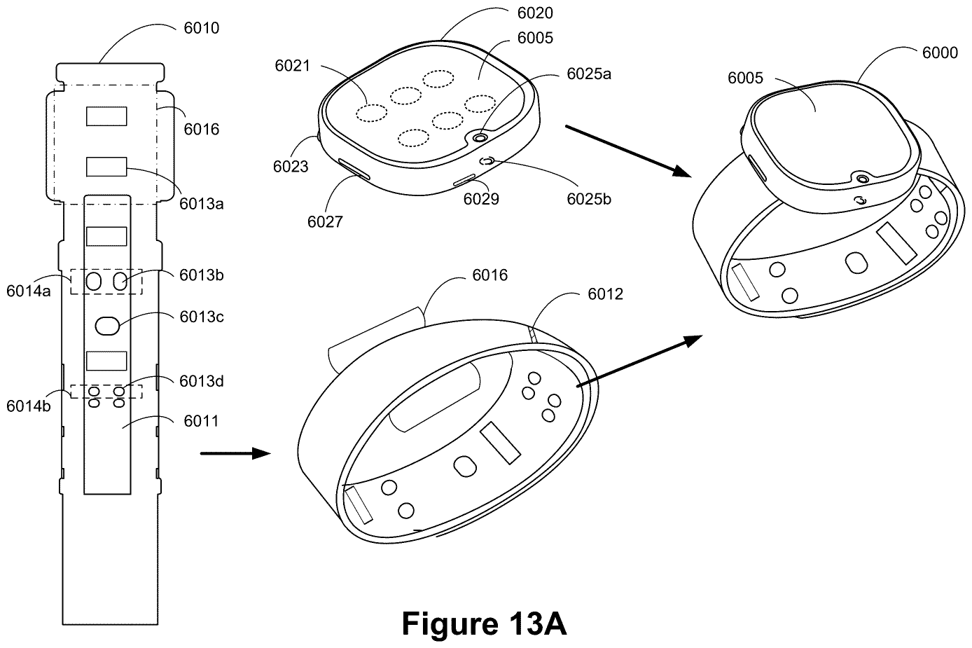

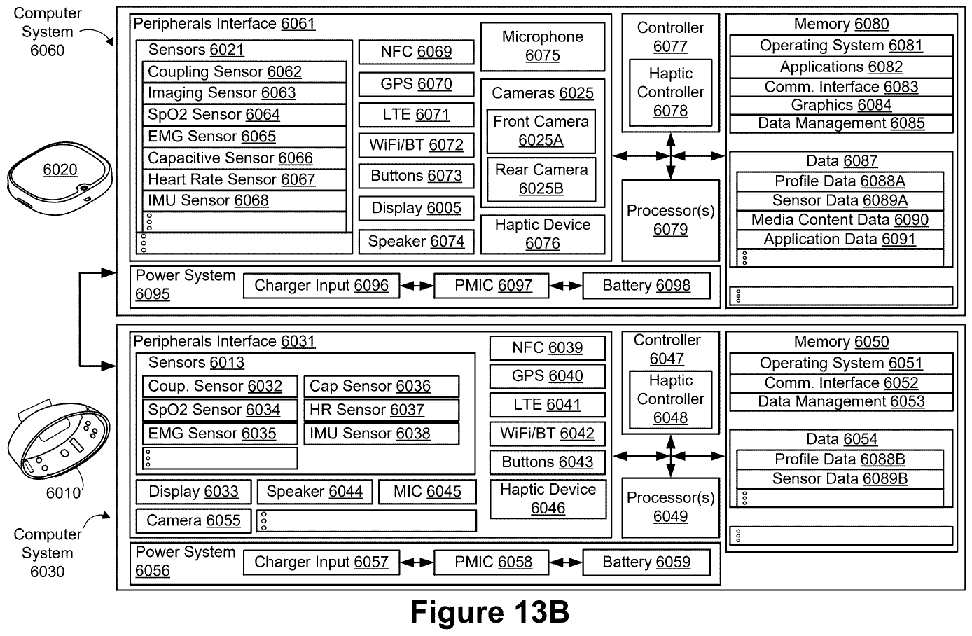

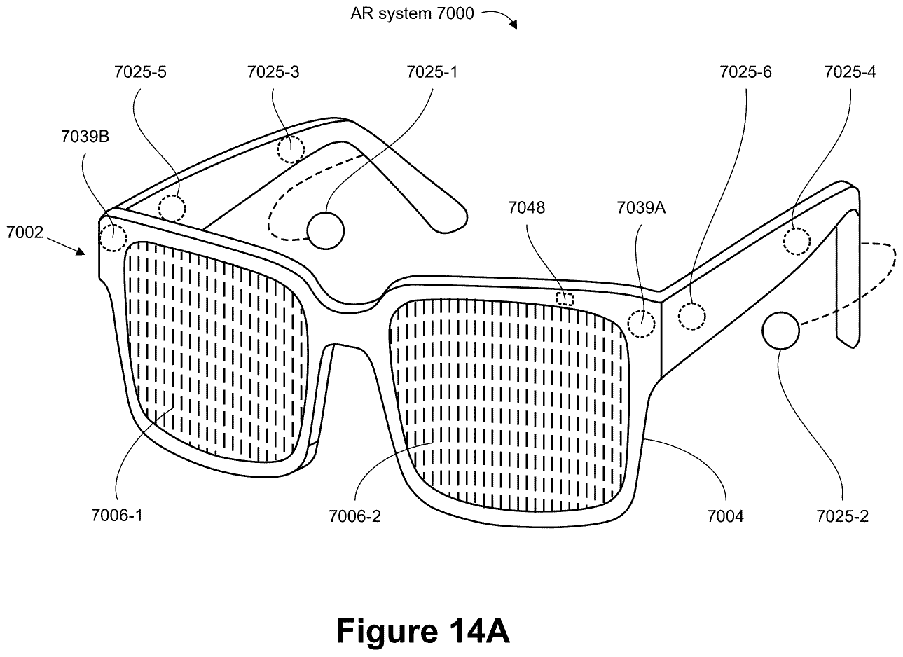

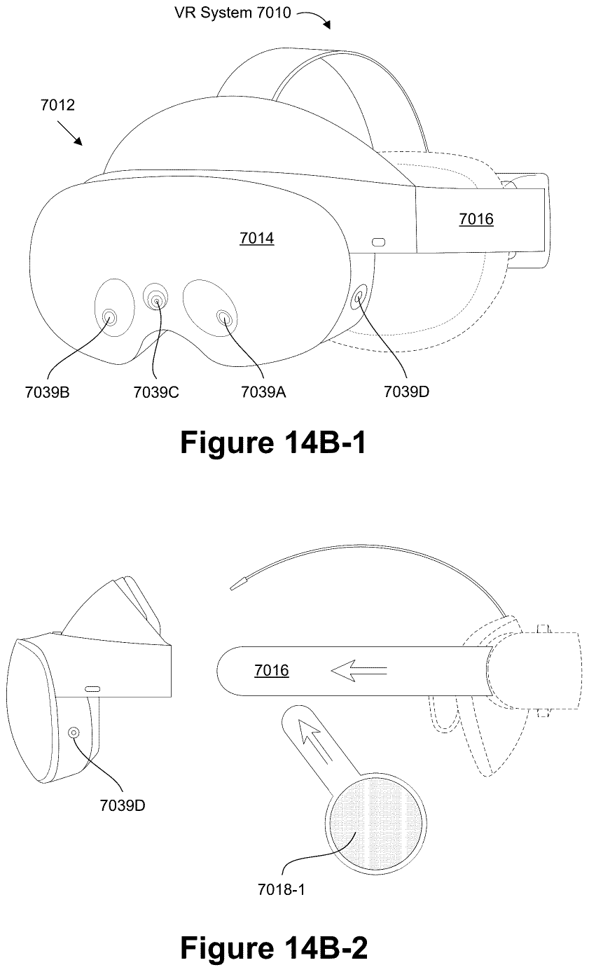

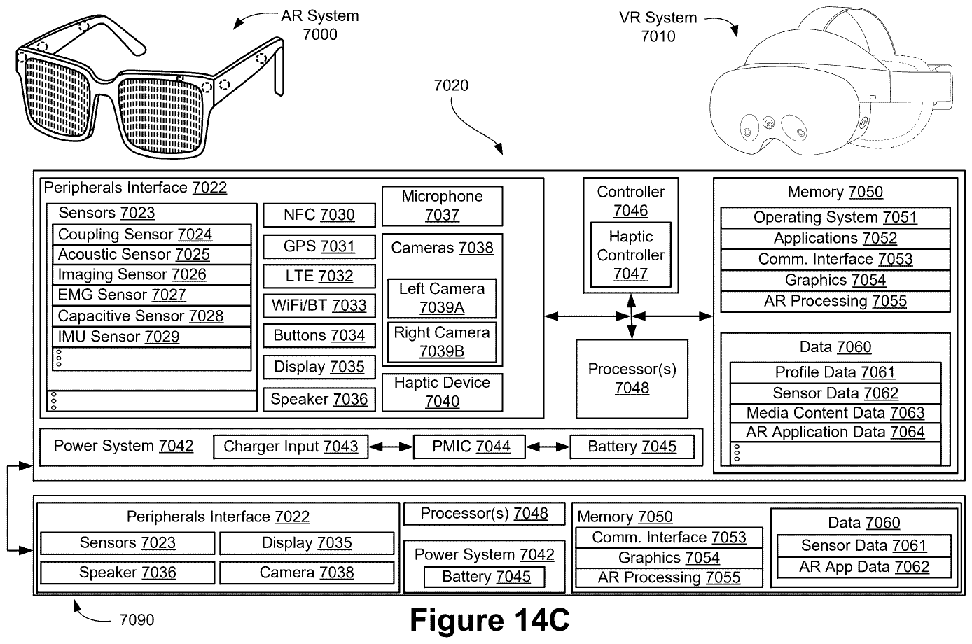

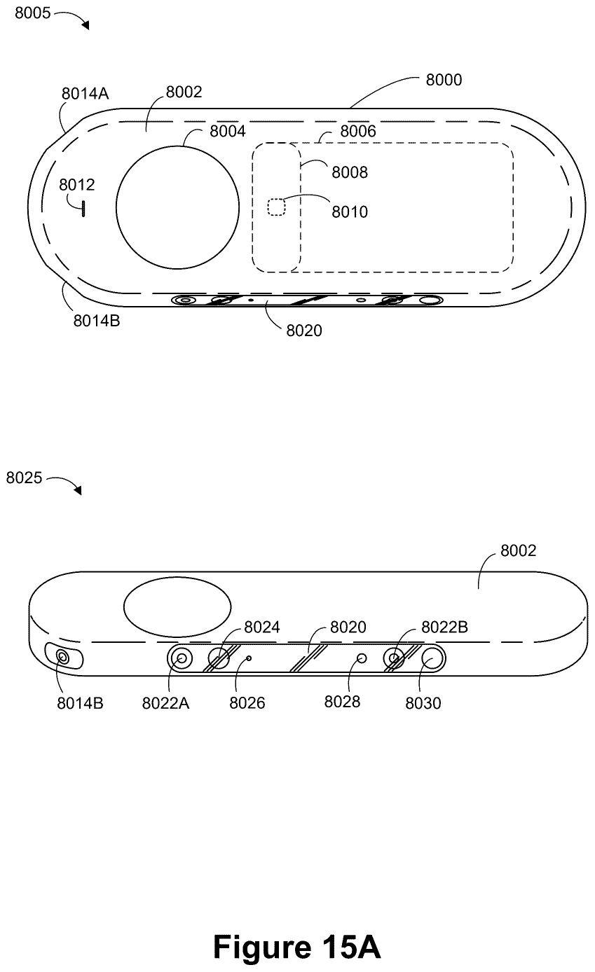

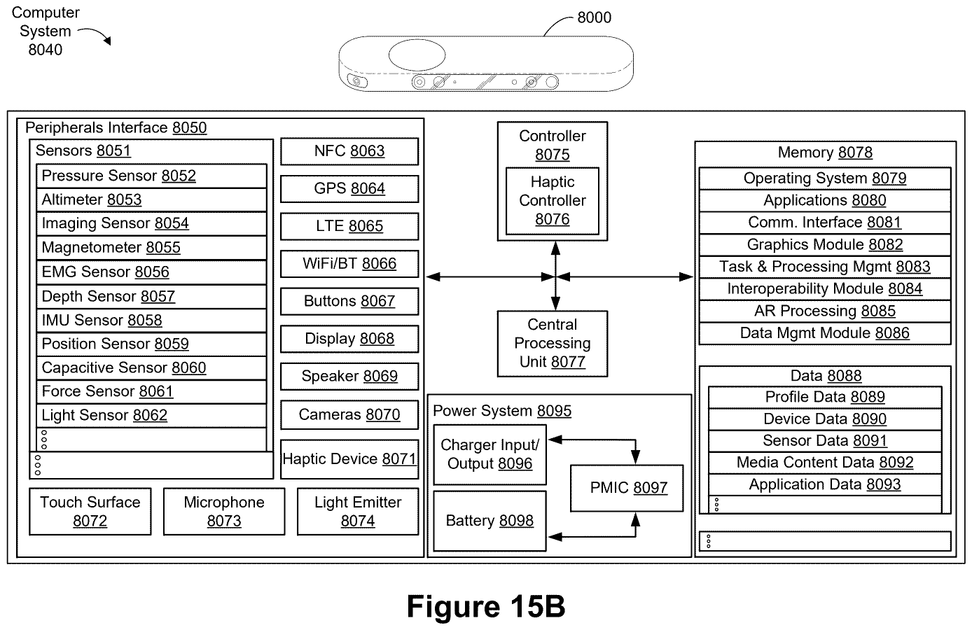

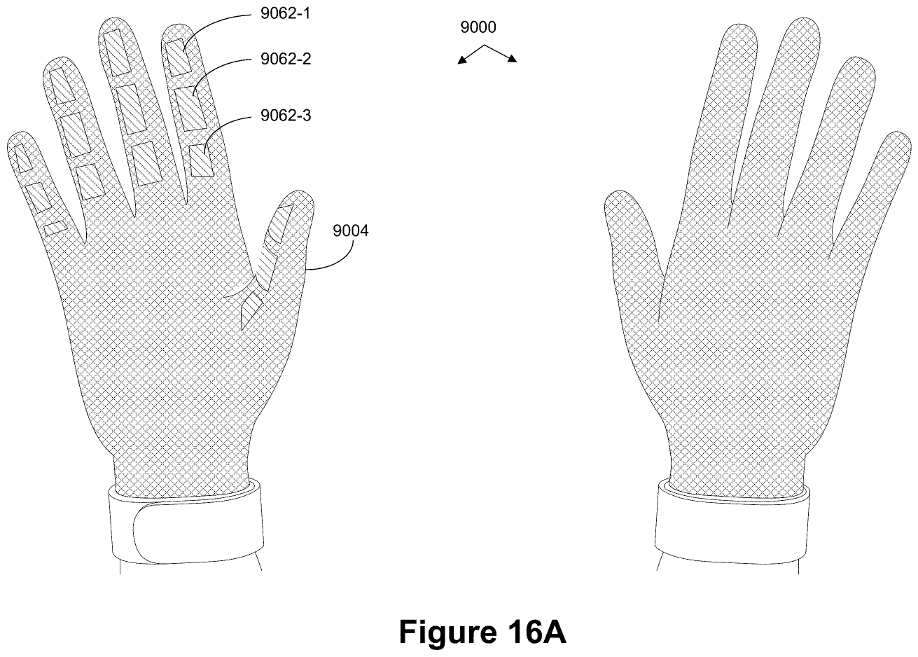

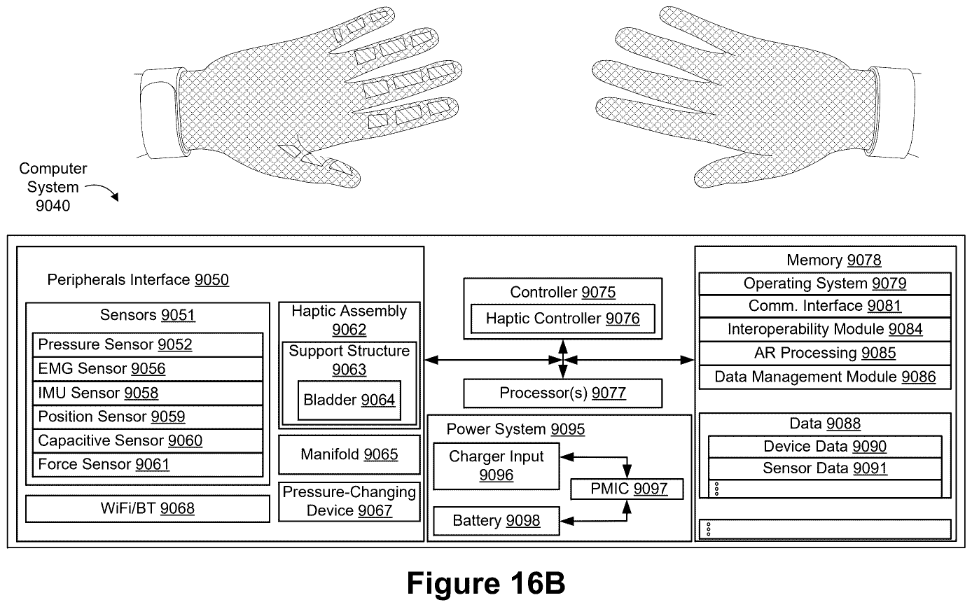

The following detailed description is organized to provide an understanding of body area network communication systems and their implementation in various devices (e.g., wearable devices). An overview of extended-reality systems and their relationship to body area network communications is first presented. Body area network systems are then described with reference to FIGS. 1 through 11, including device architectures, electrode configurations, circuit models, impedance matching components, and methods for establishing body area network communications. The detailed description continues with example extended-reality systems illustrated in FIGS. 12A through 12D-2, followed by descriptions of example wrist-wearable devices in FIGS. 13A and 13B, example augmented-reality and virtual-reality systems in FIGS. 14A through 14C, intermediary processing devices in FIGS. 15A and 15B, and haptic feedback devices in FIGS. 16A and 16B.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Body Area Network Systems

As mentioned above, Body Area Network (BAN) technology enables communication between devices by utilizing the human body as a transmission medium for electrical signals. BAN systems may be implemented across various device configurations, including communication between earbuds (e.g., left and right earbuds communicating through the user's head), communication between earbuds and smartwatches or wrist-wearable devices, communication between augmented-reality glasses or head-mounted displays and wrist-wearable devices, and communication between smartphones, glasses, earbuds and/or other wearable devices. BAN technology can provide advantages in scenarios where traditional wireless communication faces challenges, such as when body shadowing effects attenuate radio frequency signals traveling around the body, or when low power consumption is desired for battery-constrained wearable devices. Examples for BAN communication include streaming audio data between devices, transmitting sensor data from wrist-wearable devices to head-mounted displays, synchronizing device states across multiple wearables worn by a user, and enabling gesture-based control inputs detected at one device to control functions at another device. The quasi-static field distribution established through BAN communication may concentrate signal energy in or around the human body, which can reduce interference with external devices and provide security benefits by limiting the propagation of signals beyond the immediate vicinity of the user's body.

However, BAN systems can suffer from high noise, and thus improving the Signal-to-Noise Ratio (SNR) is important for reliable operation. For example, noise from the body and electrode interface is known to be higher than thermal noise, which can degrade receiver sensitivity. Reducing the noise contribution from BAN circuitry can improve the overall system SNR. In some embodiments, noise reduction may be achieved through wideband noise matching between the BAN circuitry and the non-standard body/electrode impedance, which may differ from conventional 50 Ohm impedance values. Additionally, if the signal level can be boosted through impedance matching codesign, the transmitter power level can be reduced, thereby reducing overall power consumption while providing additional margins against regulatory emission limits.

An example scenario includes a user wearing AR glasses and a smartwatch while slicing through floating virtual targets by making subtle wrist and finger gestures that the smartwatch detects via EMG/IMU sensors and relays via a BAN to the AR glasses. The BAN link provides low-latency, reliable device-to-device communication so actions appear on the holographic overlay the moment the user moves. Adaptive impedance and floating-ground return paths maintain a robust connection as the user turns and moves, keeping gameplay smooth and uninterrupted. The smartwatch can also deliver haptic taps with each successful hit, reinforcing a seamless, controller-free experience. In this scenario, BAN communication has advantages over traditional wireless protocols such as Bluetooth or Wi-Fi because the quasi-static field distribution established through the body provides lower latency and reduced power consumption compared to radio frequency transmission, while also overcoming body shadowing effects that can attenuate wireless signals traveling around the body between the wrist and head.

Another example scenario includes a user wearing earbuds and a smartwatch during a fitness workout, where the earbuds stream audio content while simultaneously transmitting heart rate and blood oxygen data detected at the ear canal to the smartwatch via a BAN, enabling real-time health monitoring without requiring separate sensor attachments or consuming additional wireless bandwidth. The BAN communication between the earbuds allows for synchronized audio playback and enables silent speech detection by analyzing signal variations transmitted through the user's head as the user mouths commands, providing hands-free control without audible voice input. BAN is advantageous in this fitness scenario because the energy efficiency is significantly lower than traditional wireless technologies, extending battery life in the compact form factors of earbuds and smartwatches, and the signal path through the body is not affected by the user's physical movements or body position changes that would otherwise cause signal degradation in conventional wireless links.

Yet another example scenario includes a user wearing AR glasses and earbuds during a video conference call, where the earbuds capture audio input from the user's voice and transmit it via a BAN to the AR glasses for processing and transmission to remote participants, while the AR glasses simultaneously stream incoming audio to the earbuds for playback, all while maintaining energy-efficient communication that extends battery life compared to traditional wireless protocols. BAN communication also provides security benefits in this scenario because the signal energy is concentrated in or around the human body and decays quickly with distance, reducing the risk that external devices could intercept sensitive audio communications, unlike radio frequency signals that propagate beyond the immediate vicinity of the user.

FIG. 1 is a block diagram of an example device and system for wearable device communication in accordance with some embodiments. In the example of FIG. 1, the human body is used as a conductive medium for communication in system 100. The system 100 includes a device 102, such as a wearable device, configured with various components to enable communication. The device 102 includes a processing unit 110 that includes a memory 120, a communication module 122, and a processor 130. The processing unit 110 is operatively connected to a signal electrode 140 and a ground electrode 150. The signal electrode 140 is configured to transmit electrical signals through a human body pathway 160, while the ground electrode 150 facilitates a return path for the signals and reduces parasitic capacitance. Together, these components enable efficient communication through the user's body.

The device 102 includes a processing unit 110, which comprises a memory 120, a communication module 122, and a processor 130. Memory 120 generally represents any type or form of volatile or non-volatile storage device or medium capable of storing data and/or computer-readable instructions. In one example, memory 120 may store, load, and/or maintain one or more modules (e.g., communication module 122) that enable management of communication of electrical signals through the device 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

The communication module 122 may also facilitate data exchange with external devices, such as smartphones, smartwatches, earbuds, or augmented-reality glasses. In some embodiments, the communication module 122 supports BAN communication that utilizes the human body as a conductive medium for signal transmission between devices. In some embodiments, the communication module 122 supports wireless communication protocols including Bluetooth, Bluetooth Low Energy (BLE), Wi-Fi, Ultra-Wideband (UWB), near-field communication (NFC), and/or millimeter-wave communication. In some embodiments, the communication module 122 supports wired communication interfaces including Universal Serial Bus (USB), micro-USB, Universal Asynchronous Receiver/Transmitter (UART), and/or other physical connectors for data exchange with coupled devices.

The processor 130 executes the instructions stored in the memory 120, processes the transmitted and received signals, and controls other operations of the device 102. The processor 130 generally represents any type or form of hardware-implemented processing unit capable of interpreting and/or executing computer-readable instructions. In one example, the processor 130 may access and/or modify one or more modules stored in memory 120, such as communication module 122. Additionally or alternatively, the processor 130 may execute one or more modules to provide device communication. Examples of the processor 130 include, without limitation, microprocessors, microcontrollers, central processing units (CPUs), Graphics Processing Units (GPUs), Sensor Processing Units (SPUs), Neural Processing Units (NPUs), Digital Signal Processors (DSPs), Field-Programmable Gate Arrays (FPGAs), Application-Specific Integrated Circuits (ASICs), portions of one or more of the same, variations or combinations of one or more of the same, or any other suitable physical processor.

The processing unit 110 may be operatively connected to a signal electrode 140 and a ground electrode 150. The signal electrode 140 may be configured to make physical contact with the user's body and transmit electrical signals through the human body pathway 160. These signals may utilize the physical body of the user as a conductive medium, allowing data communication without the need for conventional wireless transmission in certain contexts. An example includes, without limitation, earbuds that use the signal electrode to establish a connection with other devices worn on the body, such as AR/VR glasses or smartwatches.

The ground electrode 150 is positioned on the device 102 and is spaced apart from the signal electrode 140. The ground electrode 150 provides a return pathway 170 for the electrical signals, completing the circuit for communication. The placement of the ground electrode 150 may be selected to reduce parasitic capacitance by maintaining a sufficient distance from the user's body. For instance, the ground electrode may be integrated with the Bluetooth antenna, Wi-Fi antenna, and/or a touch sensor on an earbud, leveraging its location and conductive surface to facilitate signal return.

In some embodiments, the device 102 includes multiple signal electrodes positioned at different locations on the device (e.g., to ensure reliable contact with the user's body). For example, the device 102 may include a first signal electrode and a second signal electrode positioned at different contact points, such that at least one signal electrode maintains firm contact with the user's body even when the device is worn loosely or when the user's body position changes. The multiple signal electrodes may be configured to provide redundancy, ensuring that a robust communication link is maintained even if one or more contact points are temporarily disrupted. In some embodiments, the device 102 includes a controller configured to select which of the multiple signal electrodes to use for signal transmission based on detected signal quality at each contact point. Similarly, the device 102 may include multiple ground electrodes positioned at different locations on the wearable device to maximize return path capacitance to earth ground. The multiple ground electrodes may be integrated with other device components, such as touch sensors, wireless communication antennas, or display elements, to maximize surface area while maintaining sufficient distance from the user's skin to reduce/minimize parasitic capacitance.

The human body pathway 160 represents the conductive medium through which the signals travel from the signal electrode 140. The return pathway 170 connects ground electrode 150 to signal electrode 140 and ensures reliable communication by completing the signal circuit. The return pathway is depicted as a dashed line in FIG. 1 to distinguish it from the forward path through the human body and also to indicate that the pathway, transmission medium, or other specific configuration of return path 170 may vary from that of the human body pathway 160 among different embodiments.

By leveraging the user's body as a transmission medium, the system 100 enables energy-efficient, secure, and low-latency communication between wearable devices. Specific examples may include using this system in earbuds for inter-bud communication, as well as for communication between and among earbuds and devices such as AR/VR glasses or wrist-worn smartwatches. The strategic placement and functionality of the signal electrode 140 and ground electrode 150 improve energy efficiency while overcoming issues such as body shadowing effects, ensuring robust communication performance.

In some embodiments, the ground electrode in a wearable device of a BAN communication system is arranged to be from the user's body, which reduces the capacitance between the ground electrode and the user's body, and increases the capacitance between the ground electrode and the earth ground. These effects may be further enhanced in some embodiments by configuring the ground electrode to have a large surface area.

In some embodiments, the ground electrode in a wearable device in a BAN communication system is a conductive element that would be present in the wearable device absent the BAN communication system. For instance, an electrode in a wearable device that is used for some purpose other than as an electrode in a BAN communication system can be coupled to a controller of a BAN communication system and act as a ground electrode in that network in addition to its usual purpose. As an example, a display module of a wearable device may include an electrode used as part of the display screen and/or for touch sensing. This electrode may be coupled to a controller of the BAN communication system and act as a ground electrode in the BAN communication system.

In some embodiments, the ground electrode in a wearable device in a BAN communication system is a transparent electrode. In some embodiments, a transparent electrode is present in a wearable device for a purpose other than BAN communication, and the electrode is coupled to a controller of a BAN communication system to act as a ground electrode in that network in addition to its other functions. For example, a display shield for a display module or a metal mesh in an active dimming module of a wearable device may be configured as a transparent electrode (e.g., an indium-tin-oxide (ITO) electrode). An existing transparent conductor (e.g., made of ITO) may be operated as a floating ground electrode in a BAN communication system (e.g., by being coupled to a controller of the BAN communication system).

Utilizing a transparent conductive layer of in a display module (e.g., an ITO layer in the display module) of a wearable device as a floating ground of a BAN communication system can have several advantages. As an example, large surface area of the display surface can provide a large surface area for a ground electrode coupling to the ground electrode of another human body communication device and/or for coupling to the environment for a return signal path. As another example, the display in a device is generally positioned away from the skin of the wearer. It is preferable that the floating ground of a human body communication device is separated from the skin to reduce noise in the BAN communications. A transparent conductor in the display of a wearable device provides such a separation from the user's body.

In some embodiments, the ground electrode in a wearable device in a BAN communication system is at least a portion a housing of a wearable device (e.g., the ground electrode integrated into the frame). The housing may include one or more electrically conductive portions, and these portions may be coupled to a controller of a BAN communication system and act as a ground electrode in a network between BAN communication devices. While a housing may in some cases be located close to the user's body when the wearable device is worn, the portion of the housing selected as the ground electrode that may be oriented perpendicular to, or otherwise away from, the skin can reduce the capacitance between the portion of the housing and the skin.

FIGS. 2A and 2B illustrate example wearable devices configured for BAN communication in accordance with some embodiments. In the example of FIG. 2A, a wearable device 200 includes a BAN controller 210 within a housing 205. A signal electrode 220 is arranged to both couple to the BAN controller 210 and to contact the skin 215 of a user while the device is being worn by the user. The BAN controller 210 is also coupled to a floating ground electrode 225, which has capacitance C_{Rx} with the skin 215. The example of FIG. 2B is the same as FIG. 2A, except that wearable device 201 utilizes an electrically conductive housing portion 226 of the housing 205 as the floating ground electrode. As shown, while the electrically conductive housing portion 226 may be arranged closer to the skin 215 than the floating ground electrode 225, the orientation of the electrically conductive housing portion means that the capacitance CRx with the skin may nonetheless be suitably small.

The examples of FIGS. 2A and 2B are not intended to be limited to any particular shape of wearable device, including the housing shape. For instance, the wearable devices 200 and 201 could each represent a wrist-wearable device (e.g., a watch, bracelet, or wristband), a head-wearable device (e.g., glasses, a headset, earphones, or earbuds), or some other type of wearable electronic device (e.g., a ring, clothing, or gloves).

Both of the wearable devices 200 and 201 may include additional components not shown in these drawings, including, but not limited to, a display, buttons, dials, one or more PCBs or other substrates, one or more processors, one or more sensors, etc. As described above, the floating ground electrode 225 may also be utilized as part of any such component. For instance, as well as being coupled to the BAN controller 210, the floating ground electrode 225 may be used as an electrode in a display or other part of the wearable device 200 separate from the BAN components. In the example of FIG. 2B, the electrically conductive housing portion 226 is utilized as a portion of the housing in addition to being used as a floating ground for the BAN communications.

According to some embodiments, the couplings between the BAN controller 210 and any of the signal electrode 220, floating ground electrode 225, and/or the electrically conductive housing portion 226 may be implemented as direct connections between these elements. However, other couplings that include intervening components (e.g., one or more amplifiers, capacitors, resistors, etc.) may also be arranged between the BAN controller 210 and any of the electrodes. As such, any references herein to coupling between a BAN controller and an electrode should be construed to include each of these types of couplings.

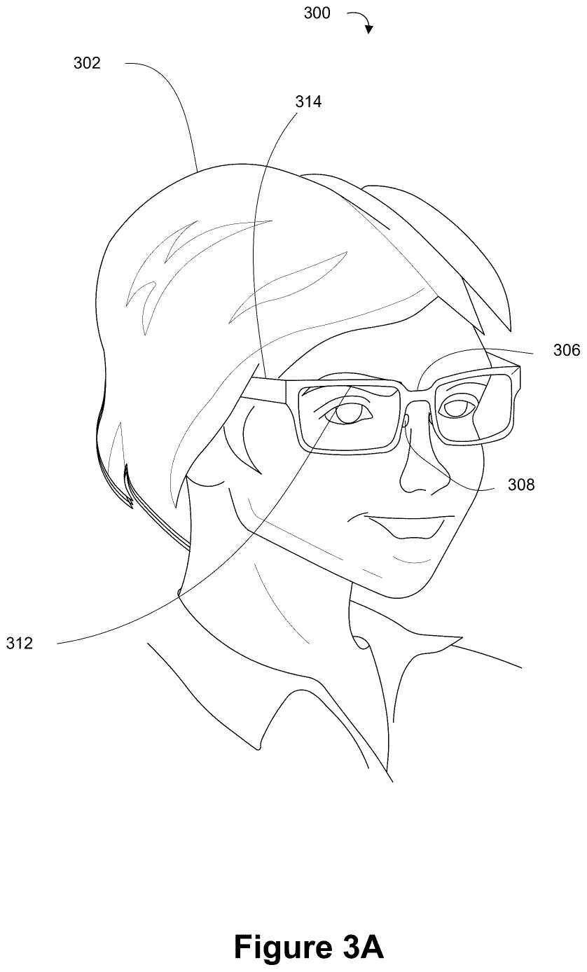

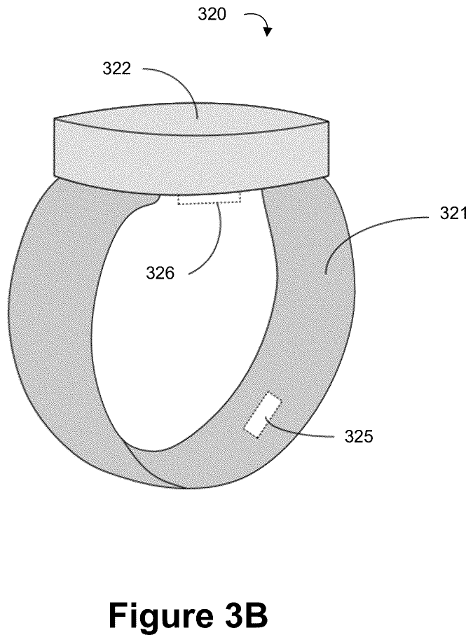

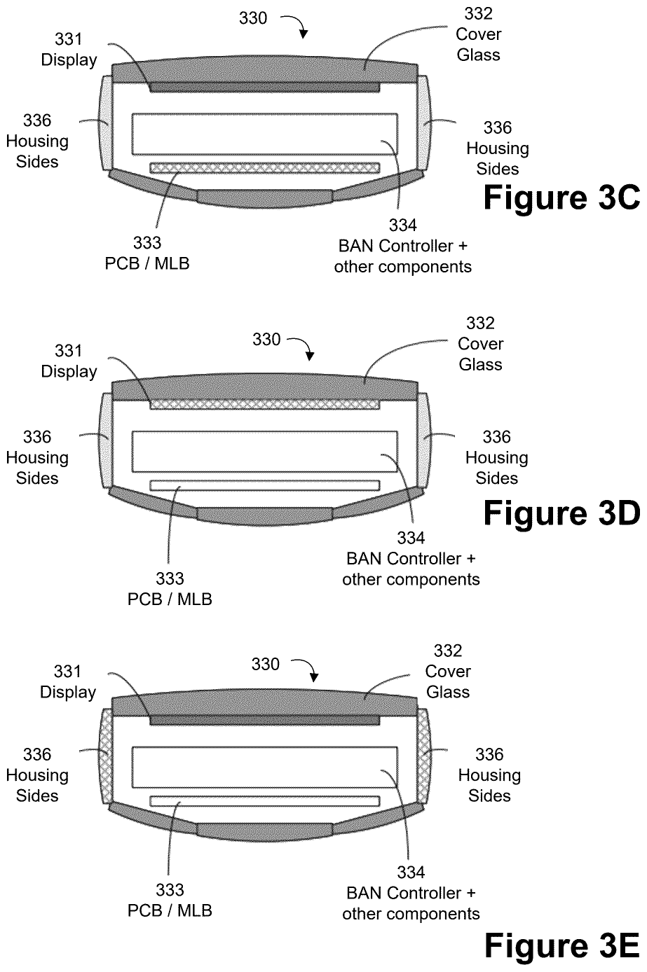

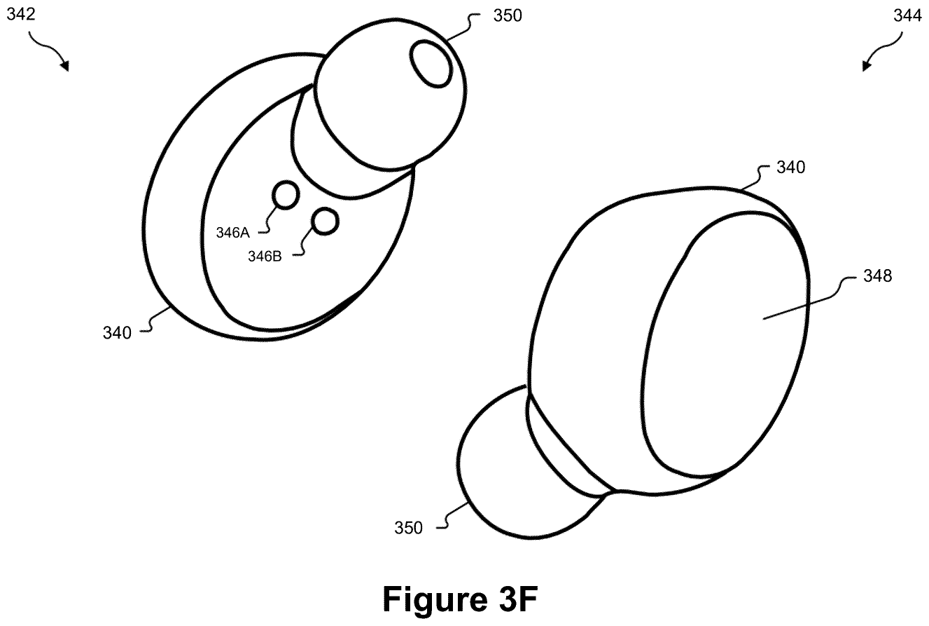

FIGS. 3A-3F illustrate example wearable devices configured for BAN communication in accordance with some embodiments. FIG. 3A illustrates an example head-wearable device 300 worn by a user 302 that includes multiple body contact points (e.g., suitable for BAN transmitter/receiver electrodes). In the example of FIG. 3A, the head-wearable device 300 includes contact points on the nose bridge 306, nose pad 308, and temple arm 314 of the head-wearable device (e.g., to provide redundancy when generating/using the BAN). The head-wearable device 300 may also include a floating ground electrode in the lens frame 312, within the lenses of the head-wearable device 300, and/or one of the temple arms 314. Additional details of example head-wearable devices are described further in relation to FIGS. 14A-14C below.

A wrist-wearable device 320 is shown in FIG. 3B as an example of a wearable device that may be used for BAN communications (e.g., may be used as either of wearable devices 200 or 201 described above). In some embodiments, the wrist-wearable device 320 includes a floating electrode and an electrode coupled to the user's body. The wrist-wearable device 320 may be configured to receive one or more transmitted signals from another device coupled to the user's body, such as the head-wearable device 300 illustrated in FIG. 3A. Additional details of example wrist-wearable devices are described further in relation to FIGS. 13A and 13B below.

In the example of FIG. 3B, the wrist-wearable device 320 includes a strap 321 and a capsule 322. In accordance with some embodiments, the capsule 322 includes a housing inside which a BAN controller and other components described above may be arranged. The wrist-wearable device 320 optionally includes electrodes 325 and 326. As shown in FIG. 3B, the electrodes may be arranged on the strap 321 and/or the capsule 322. The electrode 325 is arranged within the strap 321, and may be coupled to a BAN controller within the capsule 322 via wires and/or other conductive paths that run through the strap. The electrode 326 is arranged on an underside of the capsule 322 and may or may not protrude below the capsule housing as shown (e.g., the electrode 326 may be flush with the bottom surface of the housing of the capsule).

FIGS. 3C-3E illustrate cross-sectional views of example wrist-wearable devices, with different components of those devices being utilized as the floating ground in a BAN communication system in accordance with some embodiments. In each of FIGS. 3C-3E, a wrist-wearable device 330 includes a display 331, a cover glass 332 arranged over the display, a circuit board 333 (e.g., a printed circuit board, flexible circuit board, or multilayer board), and other electronic components including a BAN controller 334. The devices in FIGS. 3C-3E include sides of the housing 336.

In the example of FIG. 3C, the circuit board 333 is utilized as a floating ground for a BAN communication system and is coupled to the BAN controller 334. The couplings between elements is not shown in FIGS. 3C-3E for clarity. For example, the circuit board 333 in FIG. 3C may be an instance of the floating ground electrode 225 shown in FIG. 2A. In some cases, this configuration may, however, result in too large of a capacitance between the circuit board 333 and the user's skin, leading to signal degradation.

In the example of FIG. 3D, the display 331 (or a portion thereof) is utilized as a floating ground for a BAN communication system and is coupled to the BAN controller 334. The display 331 may already include, for instance, a transparent electrode (e.g., an indium-tin-oxide electrode) that may be coupled to the BAN controller 334 to act as the floating ground. For example, the display 331 may include a touch sensor layer or a display shield that comprises a transparent electrode.

In the example of FIG. 3E, the sides of the housing 336 are utilized as a floating ground for a BAN communication system and are coupled to the BAN controller 334. For example, the sides of the housing 336 in FIG. 3E may be instances of the electrically conductive housing portion 226 shown in FIG. 3B. In some embodiments, the sides of the housing 336 may comprise a metal ring that is arranged on an exterior side of the housing.

FIG. 3F illustrates perspective views of an example wearable device 340 (e.g., an earbud) configured for BAN communication, including a perspective view 342 and a perspective view 344. The perspective view 342 illustrates the placement of signal electrodes 346, including a signal electrode 346A and a signal electrode 346B, positioned on a skin-contacting surface of the device (e.g., the surface that is in contact with an ear of the user while the wearable device 340 is being worn). The signal electrodes 346 may also function as charging dots, providing an interface to transfer an electrical charge from a charging device to a battery included in wearable device 340. The signal electrodes 346 are arranged to make physical contact with the user's skin when the wearable device 340 is being worn, thereby facilitating the transmission of electrical signals through the user's body to other devices, such as smartwatches or augmented-reality glasses.

The perspective view 344 shows a ground electrode 348 positioned on the outer surface (e.g., the surface facing away from the user's body while the device is being worn) of the wearable device 340. In accordance with some embodiments, the ground electrode 348 is spaced apart from the signal electrodes 346 to reduce parasitic capacitance, thereby improving signal efficiency and providing a reliable return path for the signals. The ground electrode 348 may also function as a touch sensor and/or antenna, thereby providing control features (e.g., volume adjustment) and/or enabling wireless communication with external devices. In accordance with some embodiments, the wearable device 340 includes an ear interface 350 configured to conform to the user's ear (e.g., ensuring secure placement and enabling effective audio transmission).

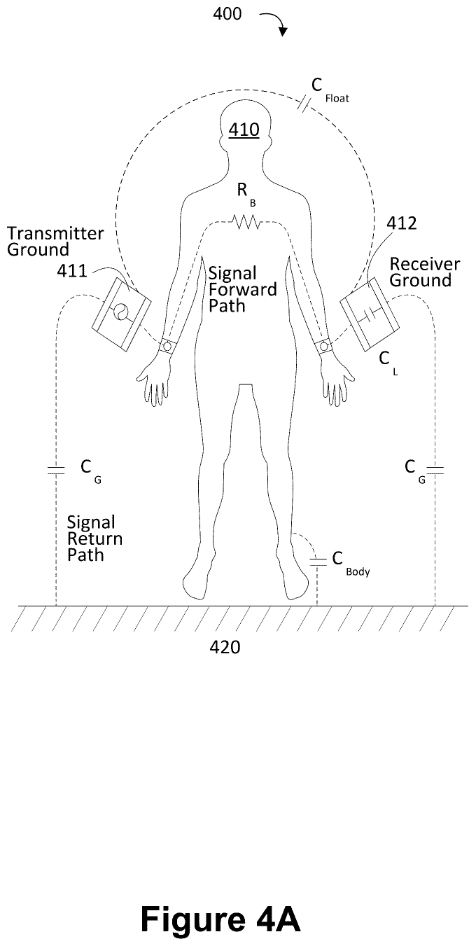

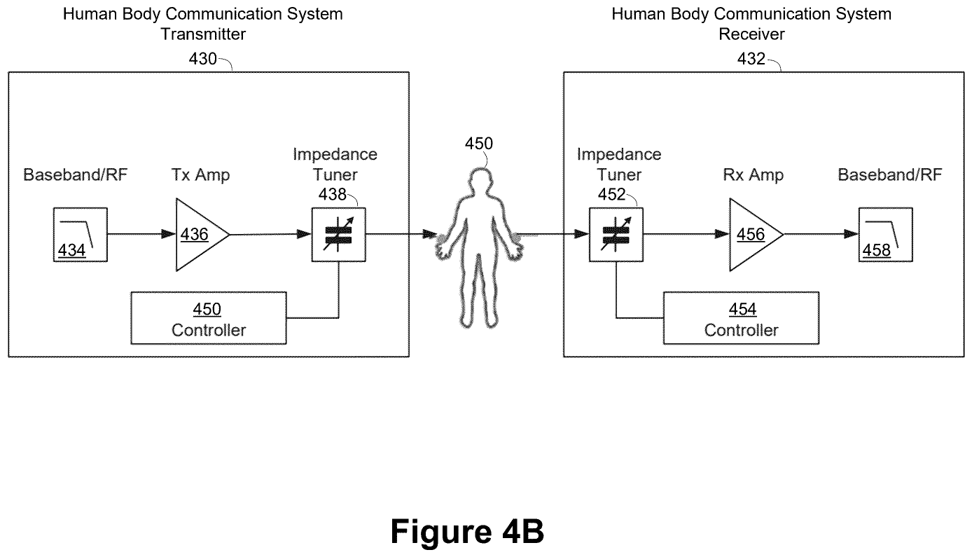

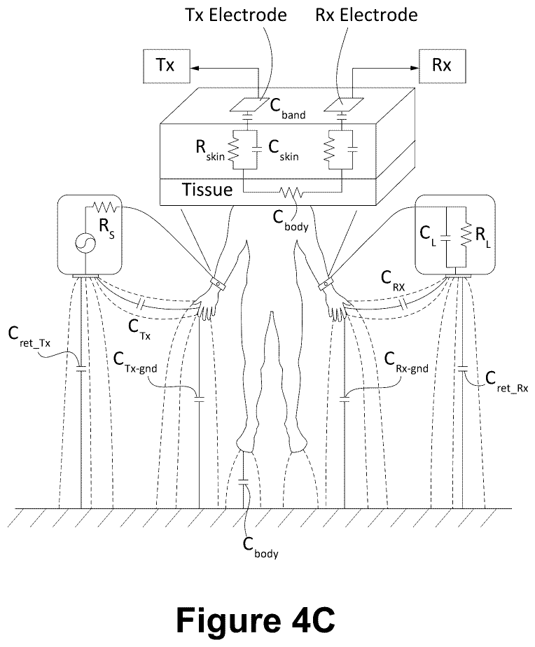

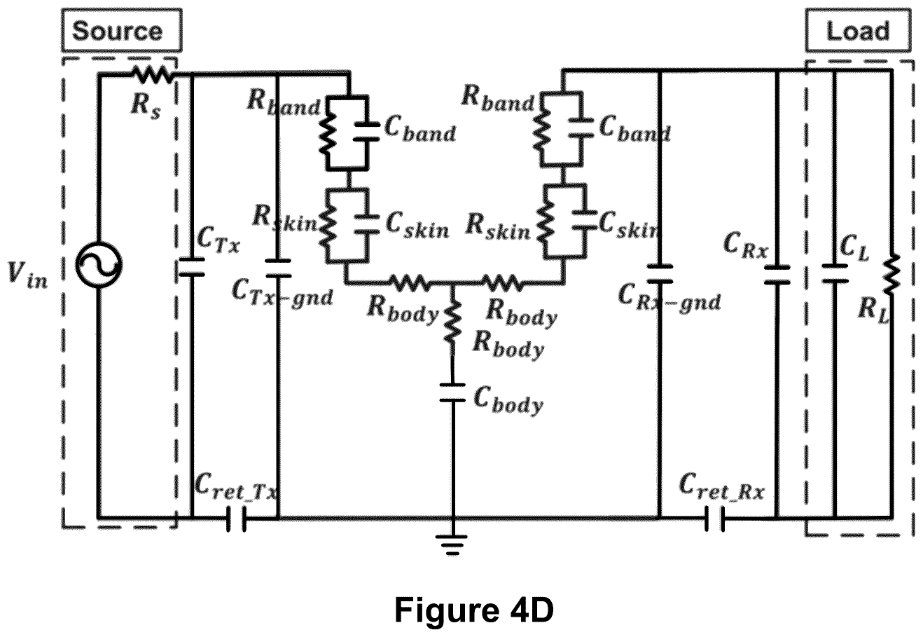

In BAN communication, electronic devices communicate with one another (e.g., two-way or one-way communication) by sending electrical signals via the human body. Advantages of this approach for communication versus wireless communication include lower power demands, lower latency, and greater physical security. FIG. 4A illustrates an example BAN between devices 411 and 412, which communicate through a user's body 410 via a signal forward path with resistance RB. As shown, each of the devices 411 and 412 has an electrode that couples to the user's skin and between which a signal propagates during communication. In addition, both devices have a floating ground electrode that have a parasitic capacitance CFloat between them. During operation, the return path of the signal passes from the ground electrodes of the devices into the earth ground 420 and up to the ground electrode of the other device. Capacitances CG are associated with this signal path, which completes the electrical circuit between the devices 411 and 412.

One of the challenges with this arrangement is that the transmitter of device 411 and/or the receiver of device 412 can exhibit a range of impedances during use. For instance, variations in the user's body type and body state, how the devices are worn against the user's skin, the user's activities (e.g., the user's posture and/or whether the user is contacting other surfaces) and/or the ambient environment can all affect the impedance. As such, a fixed impedance communication link will vary in performance. The techniques described herein include techniques for providing adjustable impedance at the transmitter and/or receiver side of this link.

FIG. 4B illustrates an example transmitter device 430 and an example receiver device 432 for a BAN through a user's body in accordance with some embodiments. The transmitter device 430 may be an instance of the transmitter of device 411 and the receiver device 432 may be an instance of the receiver device 412. In accordance with some embodiments, the transmitter device 430 is configured to generate a baseband and/or RF signal 434 and amplify the signal with an amplifier 436. An impedance tuner 438 may be controlled by a controller 450 to vary its impedance. An impedance of the transmitter device 430 may be adjusted by adjusting the impedance of the impedance tuner 438. The receiver device 432 in FIG. 4B is configured to receive signals from the transmitter device 430, and the receiver device's impedance is controlled by an impedance tuner 452, which in some embodiments is controllable by a controller 454. In accordance with some embodiments, the received signal is amplified by the amplifier 456 to produce a baseband and/or RF signal 458. In some embodiments, the transmitter device 430 and/or the receiver device 432 is a transceiver that is capable of transmitting and receiving (e.g., operates as a receiver device and a transmitter device). In some embodiments, a device includes the transmitter components of device 430 and the receiver components of the receiver device 432. In some embodiments, a device includes an impedance tuner (or other type of variable impedance component) for only one of the receiver side and the transmitter side. An impedance tuner (e.g., the impedance tuner 438 or 452) may comprise any component with a variable impedance, such as a variable resistor, a varactor, a variable inductor, or an electronically tunable impedance network.

In some embodiments, the controller 450 and/or 454 is configured to adjust the impedance of the impedance tuner 438 and/or 452 based on an impedance measurement of the user's body and/or of the device 430 and/or 432, respectively. While these measurements may not provide an accurate measure of the impedance between the transmitter and the receiver, they may provide a suitable measurement that a controller utilizes to increase or decrease the impedance of the coupled impedance tuner. In some embodiments, the measurement may be made by a component of a wearable device separate from the transmitter or receiver (e.g., a wearable device may already include an impedance sensor, which may be operated to provide a measurement for the transmitter and/or receiver).

In some embodiments, the controller 450 is configured to adjust the impedance of the impedance tuner 438 based on a measurement of communication performance between a BAN transmitter and receiver (e.g., of the same device or different devices). This measurement may be provided from the receiver to the transmitter (e.g., once a signal is received, the receiver may provide a measurement of signal quality to the transmitter). Adjustments to the impedance tuner 438 may then be made by the controller 450. Similarly, the controller 454 may be configured to adjust the impedance of the impedance tuner 452 based on a measurement of communication performance.

In some embodiments, the controller 450 and/or the controller 454 is configured to adjust the impedance of the impedance tuner 438 and/or impedance tuner 452, respectively, in an open-loop process. In response to a measurement (such as a measurement of inductance or a measurement of communication performance), the transmitter and/or receiver may adjust its impedance using an open-loop process. For example, a target impedance may be obtained from a lookup table that is configured to indicate the preferred impedance based on the result of one or more measurements, and the controller may access this lookup table using the measurement(s) generated.

In some embodiments, the controller 450 and/or the controller 454 is configured to adjust the impedance of the impedance tuner 438 and/or impedance tuner 452, respectively, in a close-loop process. In response to a measurement (such as a measurement of inductance or a measurement of communication performance), the transmitter and/or receiver may adjust its impedance using a closed-loop process.

As an example of a closed-loop process, the impedance may be adjusted at the transmitter and/or receiver sides based on one or more measurements. After the adjustment, the one or more measurements may be made again, which informs a new adjustment of the impedance (e.g., until the communication is optimized with optimal values of the impedance at the transmitter and/or receiver side). As another example, the impedance may be adjusted through a range of preset values by the controller (e.g., a parametric sweep) and for each, the performance of the communication may be evaluated by the controller. The best performing impedance may then be identified from this range of values.

Example circuit models for a BAN communication system are depicted in FIGS. 4C and 4D in accordance with some embodiments. The return signal path between the load and the source has capacitances denoted as C_{ret_Tx} and C_{ret_Rx}. The techniques described herein may be based on an observation that the strength of the signal forward path through the body increases as the capacitances C_{ret_Tx} and C_{ret_Rx} increase. For instance, at a capacitance of 3 pF for C_{ret_Tx} and C_{ret_Rx}, the signal strength through the forward path through the body may be 5-10 dB greater than the signal strength at a capacitance of 1 pF for C_{ret_Tx} and C_{ret_Rx}. Conversely, the greater the capacitances C_{Tx_gnd}, C_{L}, C_{body}, and C_{Rx}, the lower the signal strength of the signal forward path through the body due to these parasitic couplings compromising the return signal path through the earth ground. While C_{Rx} could be decreased by reducing the size of the ground electrode, this would also reduce C_{ret_Rx}, which acts against an increased signal strength. Instead, by keeping the ground of the wearable device further from the skin, Rx can be reduced while keeping C_{ret_Rx} suitably large.

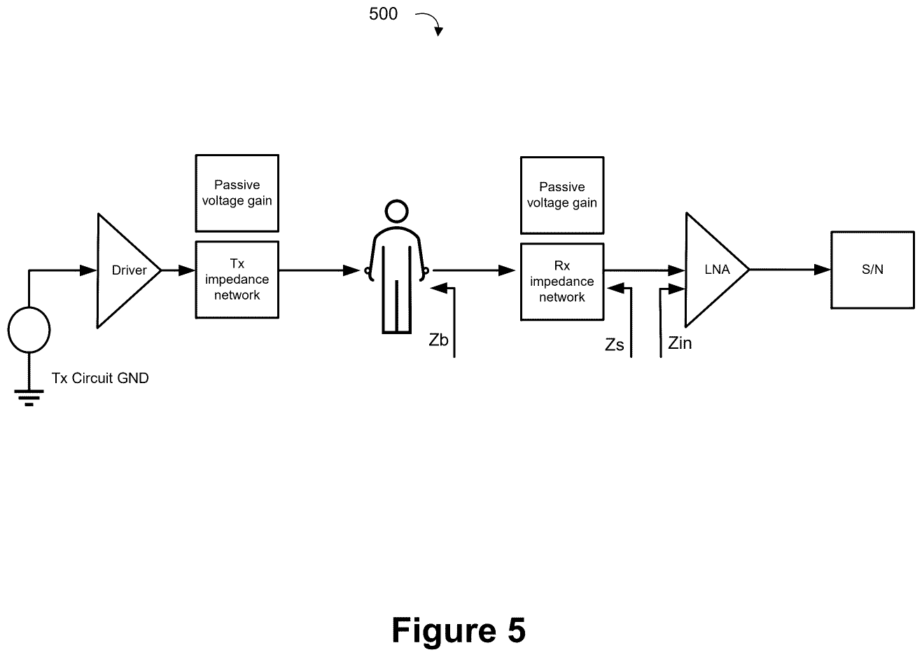

FIG. 5 illustrates an example BAN system in accordance with some embodiments. The BAN system 500 in FIG. 5 includes a transmitter side with a circuit ground (e.g., a floating ground electrode), a driver, and a transmitter impedance network. The BAN system 500 also includes a receiver side (e.g., on the same or different device) that includes a receiver impedance network and an amplifier (e.g., a low-noise amplifier). In some embodiments, body and/or electrode modeling is used to accurately represent the body's impedance (Zb). For example, this can be achieved by utilizing precise measurements and/or conducting electromagnetic (EM) simulations. By modeling the body impedance effectively, the system can better accommodate the variations in human body characteristics, leading to improved signal integrity and system reliability.

The BAN system 500 may include two radios integrated into a single device, comprising both transmission (Tx) and reception (Rx) radios. These components work in tandem to facilitate communication within the BAN system. The Tx radio may include a baseband processor, RF circuitry, a front-end driver amplifier, and a Tx impedance matching network. The Rx radio may include a baseband processor, RF circuitry, a front-end low-noise amplifier, and an Rx impedance matching network. These radios may couple to a human body through electrodes for signal transmission. In some embodiments, the electrodes are components of a wearable device such as a smartwatch. In some embodiments, an Rx LNA (or other type of amplifier) is used in the receiver front end to interface with the body/electrode. In some embodiments, the LNA is codesigned by the constraints of system specifications and body interface. In some embodiments, the BAN system 500 includes an Rx impedance matching network. The Rx impedance matching network may be arranged between the body/electrode interface and the input of the receiver, e.g., the input of an amplifier such as an LNA. To achieve wideband performance, multi-stage LC networks and/or transformers can be used, e.g., depending on design considerations.

An electrode impedance matching focused on matching the amplifier's impedance (Zopt) while adhering to current density constraints can be used to ensure that the electrodes are designed in harmony with the amplifier, thereby facilitating efficient signal transmission and reception within the BAN system.

The amplifier may be configured such that the Zopt of the amplifier corresponds to a minimum noise figure (NFmin). By matching the body impedance (Zb), the system can reduce noise interference, thereby enhancing the quality of the transmitted signals. This approach helps ensure that the amplifier operates at its optimal performance level, contributing to the overall efficiency of the BAN system. In some embodiments, the amplifier is configured to reduce voltage division loss by ensuring that the amplifier's input impedance (Zin) is significantly greater than Zopt (e.g., an order of magnitude greater). This reduces/minimizes voltage division loss, which improves signal strength and integrity across the network. In some embodiments, an impedance matching network, in which an impedance (Zs=Zopt) is used with the amplifier to approach/achieve NFmin, helps ensure that the amplifier receives the optimal impedance, thereby reducing noise and enhancing the system's performance.

Achieving a high-voltage gain boosts the system's link budget. By increasing voltage gain, the BAN system can extend its communication range and improve the reliability of data transmission, which can be particularly important in dynamic body environments. The amplifier used in the receiver is subject to specific constraints that impact its performance. These constraints include achieving the desired noise figure and impedance matching to enhance receiver sensitivity. The configuration of the Rx impedance matching network can be used to reduce noise and increase signal integrity.

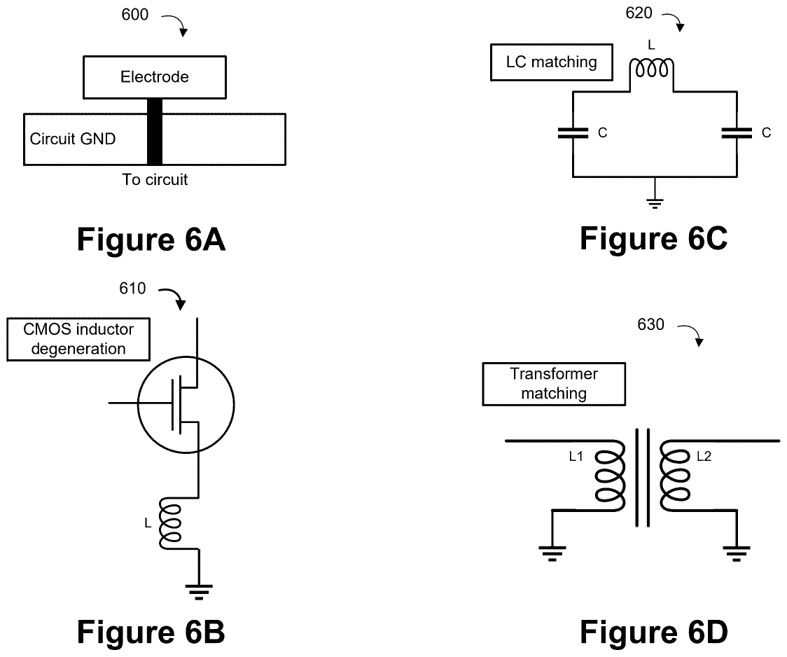

FIGS. 6A-6D illustrate example components for BAN communication in accordance with some embodiments. The electrode configuration 600 illustrates an interface between the body and the BAN circuitry. Its design and placement are important in ensuring effective signal transmission and reception. By modifying an electrode's shape, gap to ground, etc., its impedance can be changed, e.g., changed toward amplifier's Zopt. The CMOS inductor degeneration 610 is an example CMOS inductor degenerator. The LC matching network 620 and the transformer matching network 630 are examples of networks that can be used to configure a BAN system such as wearable devices 200 and 201.

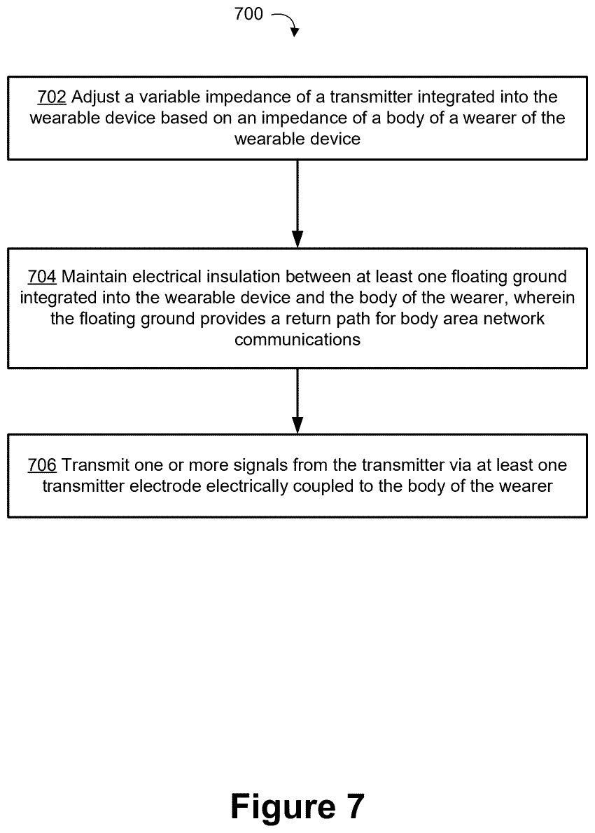

FIG. 7 is a flow diagram of a method 700 for BAN communications in accordance with some embodiments. The method 700 is performed at a computing system (e.g., a wearable device, intermediary device, server device, and/or service platform) having one or more processors (e.g., CPUs, controllers, and/or other types of control circuitry) and memory. In some embodiments, the memory stores one or more programs configured for execution by the one or more processors. At least some of the operations shown in FIG. 7 correspond to instructions stored in a computer memory or a computer-readable storage medium. In some embodiments, the computing system comprises a wearable device, such as a wrist-wearable device, a head-wearable device, or other type of wearable device.

(A1) In accordance with some embodiments, the method 700 of communicating via a body area network using a wearable device includes adjusting (702) a variable impedance of a transmitter integrated into the wearable device based on an impedance of a body of a wearer of the wearable device, and maintaining (704) electrical insulation between at least one floating ground integrated into the wearable device and the body of the wearer where the floating ground provides a return path for body-area network communications. The method 700 further includes transmitting (706) one or more signals from the transmitter via at least one transmitter electrode electrically coupled to the body of the wearer. For example, the wearable device may be a head-wearable device such as augmented-reality glasses, and the transmitter electrode may be positioned at a nose bridge, nose pad, or temple arm location to contact the wearer's skin. In another example, the wearable device may be an ear-wearable device such as an earbud, and the transmitter electrode may comprise one or more charging contacts that contact the wearer's ear canal when the earbud is worn. In yet another example, the wearable device may be a wrist-wearable device such as a smartwatch, and the transmitter electrode may be positioned on an inner surface of a band or capsule to contact the wearer's wrist. The variable impedance may be adjusted using an impedance tuner comprising a variable capacitor, a varactor, a variable inductor, or an electronically tunable impedance network. The floating ground may be integrated with a display shield, a touch sensor, a wireless communication antenna, a transparent conductive layer, or an electrically conductive housing portion of the wearable device.

(A2) In some embodiments of A1, the transmitter includes a plurality of transmitter electrodes and the method further comprises selecting the at least one transmitter electrode from the plurality of transmitter electrodes based on a signal quality metric for the at least one transmitter. For example, the plurality of transmitter electrodes may include electrodes positioned at different body contact points on a head-wearable device, such as a first electrode at a nose bridge location, a second electrode at a nose pad location, and a third electrode at a temple arm location. The signal quality metric may comprise a signal-to-noise ratio, a received signal strength indicator, a bit error rate, and/or a link quality indicator. In some embodiments, the method includes periodically evaluating the signal quality metric for each of the plurality of transmitter electrodes and dynamically switching between transmitter electrodes based on changes in contact quality (e.g., due to factors such as user movement, device repositioning, hair thickness, or the presence of hats or other accessories). In some embodiments, the method includes simultaneously transmitting signals through multiple transmitter electrodes and combining the signals at a receiver (e.g., to improve overall link reliability). In some embodiments, the method includes selecting a subset of the plurality of transmitter electrodes that exhibit signal quality metrics above a threshold value and distributing signal transmission across the selected subset.

(A3) In some embodiments of any of A1-A2, the electrical insulation between the at least one floating ground integrated into the wearable device and the body of the wearer is maintained using one or more frequency-based separation components. For example, the frequency-based separation components may include one or more bandpass filters, highpass filters, lowpass filters, or notch filters configured to isolate body area network communication signals from other signals present on the floating ground. In some embodiments, the floating ground is shared with a touch sensor that operates at a first frequency range, and the frequency-based separation components include a filter configured to separate body area network signals operating at a second frequency range from the touch sensor signals. In some embodiments, the floating ground is shared with a wireless communication antenna such as a Bluetooth or Wi-Fi antenna, and the frequency-based separation components include a diplexer or multiplexer configured to route signals to appropriate circuitry based on frequency. The frequency-based separation components may also include decoupling circuits comprising capacitors, inductors, or resonant circuits configured to provide frequency-selective isolation between the body area network circuitry and other device functions sharing the floating ground electrode.

(A4) In some embodiments of any of A1-A3, the method further comprises performing an operation at the wearable device that comprises using the transmitter electrode for a function that is distinct from transmitting the one or more signals. For example, the transmitter electrode may be used for charging the wearable device when the device is placed in a charging case, such as when the wearable device is an earbud or wristband and the transmitter electrode comprises a charging contact configured to receive electrical power from charging pins. In another example, the transmitter electrode may be used for biometric sensing, such as detecting electromyography (EMG) signals, electrocardiography (ECG) signals, or bioimpedance measurements from the wearer's body. In some embodiments, the method includes time-sharing the transmitter electrode between body area network communication and the distinct function, such that the transmitter electrode performs body area network communication during a first time period and performs the distinct function during a second time period. In some embodiments, the method includes frequency-sharing the transmitter electrode between body area network communication and the distinct function using frequency-based separation components to isolate the different functions.

(A5) In some embodiments of any of A1-A4, the function that is distinct from transmitting the one or more signals comprises a sensing function. For example, the sensing function may comprise detecting EMG signals from muscles of the wearer, such as detecting neuromuscular signals from the wearer's forearm when the wearable device is a wrist-wearable device. In another example, the sensing function may comprise detecting ECG signals from the wearer's heart. In yet another example, the sensing function may comprise measuring bioimpedance of the wearer's body tissue for health monitoring applications. The sensing function may also comprise detecting touch inputs or proximity of the wearer's body to the transmitter electrode. In some embodiments, the sensing function comprises detecting body movement of the wearer by analyzing changes in electrical characteristics at the transmitter electrode, such as detecting silent speech by monitoring signals transmitted between earbuds through the wearer's head. The sensing function may operate at a different frequency than the body area network communication signals, enabling simultaneous operation through frequency-based separation.

(A6) In some embodiments of any of A1-A5, the method further comprises receiving one or more incoming signals from the body area network using a receiver integrated into the wearable device. The receiver includes at least one receiver electrode electrically coupled to the body of the wearer. For example, the receiver electrode may be the same electrode as the transmitter electrode, with the wearable device configured as a transceiver that alternates between transmitting and receiving modes. Alternatively, the receiver electrode may be a separate electrode from the transmitter electrode, positioned at a different location on the wearable device. In some embodiments, the receiver includes a low-noise amplifier (LNA) coupled to the receiver electrode, and the method further comprises adjusting a variable impedance of the receiver to match an optimal source impedance of the LNA for minimum noise figure. The method may further comprise implementing wideband noise matching between the receiver circuitry and the body/electrode impedance to improve signal-to-noise ratio. In some embodiments, the receiver includes an impedance matching network positioned between the receiver electrode and the LNA, the impedance matching network configured to present an optimal impedance to the LNA while providing passive voltage gain to boost the received signal level.

(A7) In some embodiments of any of A1-A6, the variable impedance of the transmitter is adjusted using open-loop feedback. For example, the open-loop feedback may comprise selecting an impedance value from a lookup table based on one or more detected conditions, such as a detected body impedance measurement, a detected device positioning, a detected user activity level, or a detected environmental condition. In some embodiments, the lookup table is populated with impedance values determined through prior characterization of body impedance variations across different users, use cases, and environmental conditions. The open-loop feedback may comprise measuring an impedance at the transmitter electrode interface and selecting a corresponding impedance tuning value from the lookup table without requiring feedback from a receiver device. In some embodiments, the open-loop feedback comprises detecting a change in device positioning using an inertial measurement unit (IMU) and adjusting the variable impedance based on the detected positioning change. The open-loop approach may provide faster impedance adjustment compared to closed-loop approaches by eliminating the latency associated with receiving feedback from a remote device.

(A8) In some embodiments of any of A1-A7, the variable impedance of the transmitter is adjusted using closed-loop feedback. For example, the closed-loop feedback may comprise receiving a signal quality indicator from a receiver device and adjusting the variable impedance based on the received signal quality indicator. The signal quality indicator may comprise a received signal strength indicator (RSSI), an SNR measurement, a bit error rate (BER), or a packet error rate. In some embodiments, the closed-loop feedback comprises iteratively adjusting the variable impedance and monitoring changes in the signal quality indicator to converge on an optimal impedance value. The closed-loop feedback may comprise transmitting a test signal, receiving feedback indicating the quality of the received test signal, and adjusting the variable impedance based on the feedback before transmitting data signals. In some embodiments, the closed-loop feedback operates continuously during data transmission, with the variable impedance being dynamically adjusted in response to changes in body impedance that occur due to user movement, changes in device positioning, and/or environmental factors. The closed-loop approach may provide more accurate impedance matching compared to open-loop approaches by directly measuring the effect of impedance adjustments on actual signal transmission quality.

(B1) In accordance with some embodiments, a wearable device configured to communicate via a body area network includes a transmitter integrated into the wearable device including at least one transmitter electrode electrically coupled to a body of a wearer where the transmitter is configured to transmit one or more signals to a second wearable device. The wearable device further includes a variable impedance component coupled to the transmitter and at least one floating ground integrated into the wearable device and electrically insulated from the body of the wearer. In some embodiments, the floating ground is positioned at least 5 millimeters away from the physical body of the wearer (e.g., to reduce parasitic capacitance). In some embodiments, the floating ground is integrated into a display of the head-wearable device. In some embodiments, the floating ground comprises a touch sensor. In some embodiments, the floating ground comprises a display shield layer. In some embodiments, the floating ground comprises a transparent metal layer. In some embodiments, the floating ground is composed of indium-tin-oxide (ITO). In some embodiments, the floating ground electrode comprises a conductive surface spaced apart from the transmitter electrode. For example, the ground electrode may be configured to minimize parasitic capacitance and to facilitate a return path for the electrical signals. In some embodiments, the floating ground electrode is configured to provide a return path capacitance to earth ground. For example, the return path capacitance is formed between the floating ground and earth ground to complete a communication circuit through the body. In some embodiments, the at least one floating ground comprises at least one of a printed circuit board, an antenna, or a touch sensor integrated into the wearable device.

(B2) In some embodiments of B1, the wearable device is a head-wearable device, and the transmitter is electrically coupled to a nose, temple, or forehead of the wearer. In some embodiments, the transmitter is configured to communicate electrical signals using the physical body of the wearer as a conductive medium for the electrical signals. In some embodiments, the transmitter electrode is arranged to contact an ear of the wearer while the wearable device is being worn. In some embodiments, the at least one floating ground comprises at least one of a transparent conductor on a lens, an active dimming layer, an ITO layer, a metal mesh, or a transparent antenna integrated into the head-wearable device.

(B3) In some embodiments of any of B1-B2, the wearable device is an ear-wearable device, and the transmitter comprises one or more charging contacts integrated into the ear-wearable device. In some embodiments, the one or more charging contacts are configured to perform dual functions of charging the ear-wearable device and transmitting signals via the body area network.

(B4) In some embodiments of any of B1-B3, the wearable device is a wrist-wearable device, and the transmitter electrode is electrically coupled to a wrist of the wearer. In some embodiments, the wrist-wearable device comprises a capsule and a wrist strap and the electrode is arranged within the wrist strap. In some embodiments, the at least one floating ground comprises at least one of a display, a display shield, an ITO layer, a metal mesh from a touch sensor, or a metal ring housing of the wrist-wearable device.

(B5) In some embodiments of any of B1-B4, the transmitter electrode comprises a dry electrode contacting the wearer's skin. In some embodiments, the transmitter electrode is a transparent electrode. In some embodiments, the transmitter electrode is integrated into a polymer material configured to conform to a portion of the body of the wearer when the device is worn by the wearer. In some embodiments, the transmitter electrode is composed of a biocompatible material (e.g., to ensure safe and prolonged contact with a portion of the body of the wearer). In some embodiments, the transmitter is configured to transmit signals through the body to the receiver using quasi-static field distribution.

(B6) In some embodiments of any of B1-B5, the transmitter comprises multiple contact points positioned at different locations on the wearable device. For example, the transmitter may switch between using different contact points to ensure reliable contact with the physical body of the wearer. The transmitter includes multiple contact points positioned at different locations on the head-wearable device to ensure reliable contact with the physical body of the wearer. In some embodiments, an impedance of the transmitter electrode is adjustable by modifying at least one of electrode shape or gap to ground. In some embodiments, the wearable device comprises a controller configured to select which of the multiple contact points to use for signal transmission based on detected signal quality at each contact point.

(B7) In some embodiments of any of B1-B6, the variable impedance component is configured to generate a transmission impedance that matches a receiver impedance of the second wearable device. In some embodiments, the variable impedance component is configured to adjust the impedance based on one or more received signals. In some embodiments, the variable impedance component is configured to adjust the impedance based on an impedance measurement (e.g., an impedance measured between a transmit electrode and a receiver electrode of the wearable device). In some embodiments, the variable impedance component is configured to perform a parametric sweep of a plurality of impedances to obtain a plurality of measurements of communication performance from the second wearable device, and to select one of the plurality of impedances based on the plurality of measurements of communication performance. In some embodiments, the variable impedance component comprises a variable resistor, a varactor and/or a variable inductor. In some embodiments, the variable impedance component is configured to select an impedance by accessing a lookup table based on one or more measurements (e.g., impedance measurements). In some embodiments, the variable impedance component is configured to dynamically adjust impedance based on detected body impedance variations. In some embodiments, the variable impedance component is configured to operate using a closed-loop algorithm that receives feedback from a receiver to adjust transmission impedance. In some embodiments, the variable impedance component is configured to operate using an open-loop algorithm that selects impedance values from a lookup table based on detected impedance conditions. In some embodiments, the variable impedance component comprises at least one of a tunable capacitor or an RF switch. In some embodiments, the variable impedance component comprises at least one of a multi-stage LC network or a transformer network configured to achieve wideband performance. In some embodiments, the variable impedance component is configured to provide voltage gain to boost a system link budget. In some embodiments, the variable impedance component is configured for passive voltage gain to enhance signal-to-noise ratio of the body area network system.

(B8) In some embodiments of any of B1-B7, the at least one floating ground is integrated with a wireless communication antenna of the wearable device. For example, the floating ground shares a conductive surface area with the wireless communication antenna for improved signal performance.

(B9) In some embodiments of any of B1-B8, the transmitter electrode is further configured to perform a second function distinct from transmitting the one or more signals, and the wearable device further includes a controller configured to manage operation of the transmitter electrode. In some embodiments, the second function comprises sensing neuromuscular signals from the wearer. In some embodiments, the second function comprises a charging function of the wearable device. In some embodiments, the transmitter electrode is shared with an electromyography (EMG) sensor, and the wearable device further comprises time-sharing circuitry configured to alternate between BAN signaling and EMG sensing. In some embodiments, the BAN signaling operates at a different frequency than EMG sensing to enable decoupling between the two functions.

(B10) In some embodiments of any of B1-B9, the transmitter comprises a transceiver. For example, the wearable device comprises a transceiver that operates as both a transmitter and a receiver (e.g., switches between the modes). In some embodiments, the variable impedance component is configured to adjust both transmission and receiving impedances.

(B11) In some embodiments of any of B1-B10, the wearable device further comprises a receiver integrated into the wearable device including at least one receiver electrode electrically coupled to the body of the wearer and the receiver is configured to receive one or more signals from the body area network. In some embodiments, the receiver comprises an LNA coupled to the receiver electrode. In some embodiments, the wearable device further comprises an impedance matching network positioned between the receiver electrode and the LNA. For example, the impedance matching network may be configured to present an optimal impedance to the LNA to achieve a minimum noise figure. In some embodiments, the LNA is configured such that an impedance of the LNA is prematched to a body impedance of the wearer, e.g., to facilitate wideband impedance matching. In some embodiments, the LNA is configured such that an input impedance of the LNA is greater than an optimal impedance of the LNA to reduce voltage division loss.

(B12) In some embodiments of any of B1-B11, the wearable device further comprises control circuitry configured to determine body movement of the wearer by analyzing signal transmission via the body area network. For example, the control circuitry may be configured to detect speech (e.g., silent or mouthed speech) based on body movement signals. In some embodiments, the control circuitry analyzes variations in signal characteristics transmitted through the body area network, such as changes in signal amplitude, phase, or impedance, to infer body movements including jaw movements, facial muscle contractions, head movements, or limb gestures. In some embodiments, the wearable device is an ear-wearable device, and the control circuitry is configured to detect silent speech by analyzing BAN signal variations between a first earbud and a second earbud as the wearer moves their jaw or facial muscles during mouthed speech. In some embodiments, the wearable device is a head-wearable device, and the control circuitry is configured to detect head nods, head shakes, or other head gestures by analyzing changes in BAN signal transmission characteristics between the head-wearable device and a wrist-wearable device worn by the wearer. In some embodiments, the control circuitry is configured to detect swallowing, chewing, or other oral movements based on changes in the BAN signal path through the wearer's head and neck region. In some embodiments, the control circuitry utilizes machine-learning models trained on BAN signal patterns associated with specific body movements to classify detected signal variations into corresponding movement types. In some embodiments, the control circuitry is configured to detect hand gestures or arm movements by analyzing BAN signal transmission between a wrist-wearable device and a head-wearable device or ear-wearable device. In some embodiments, the detected body movements are used to generate control inputs for an extended-reality application, such as controlling virtual objects or navigating user interfaces based on silent speech commands or gesture inputs detected through BAN signal analysis.

### Outphasing Transmitter System for Body Area Network

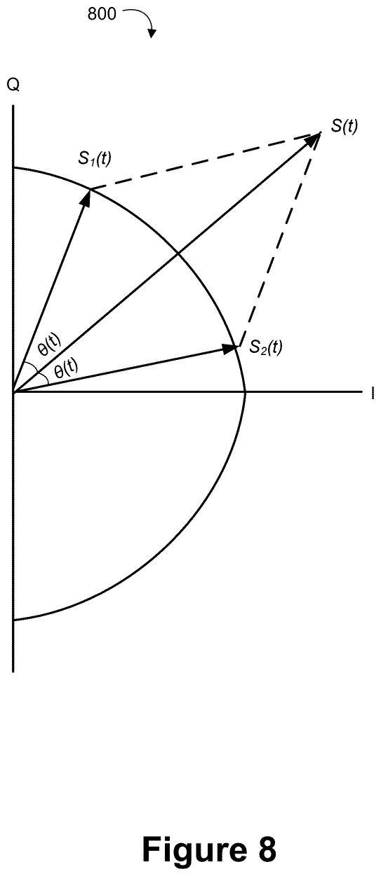

FIGS. 8-11 are directed to enhancing the power consumption in a BAN system while maintaining a high data rate capability. A BAN system may provide low power, high data rate communication systems. However, high data rate often requires high power consumption. For example, many existing low power consumption designs use constant-envelope modulations like OOK or FSK. These modulations may use non-linear amplifiers such as switch mode amps for significantly high efficiency and as well as reduce the SNR requirement. However, the data rate may be fundamentally limited by these modulations.

To boost data rate, common techniques use higher-order modulation like QPSK or QAM but due to their high PAPR, linear amplifiers have to be used, which have relatively low efficiency especially for low amplitudes. Another efficiency enhancement technique is an outphasing transmitter, which may achieve both high efficiency over signal level range and linearity/low distortion of signals. However, outphasing transmitters are often designed for wireless communications, not applicable for BAN applications. With respect to incorporating an outphasing transmitter, there are key fundamental differences between a BAN device and a conventional wireless communication device.

Transmitters in conventional wireless communication devices always have a PA (power amplifier) to deliver RF power to the antenna. Outphasing transmitter for a BAN system device may need to be voltage signaling. In a voltage signaling mode, the BAN transmitter establishes a voltage signal for a certain SNR, rather than injecting a high-power signal into the human body. Thus, the design requirements of an outphasing transmitter in voltage mode for a BAN device is different from that in a power mode designed for a wireless communication device.

Transmitters in conventional wireless communication devices are always designed to deliver target RF power into 50 ohm load (such as a 50 ohm antenna or filter). In a BAN system, the modeling of a human body as well as its electrodes is different from a conventional 50 ohm, but rather includes a complex network of resistances and capacitances including the coupling to the environment itself. To interfacing with such a model, the outphasing transmitter's design and optimization for a BAN system are different from that in a wireless communication device with a 50 ohm load.

Some embodiments of the outphasing transmitter system include a nonlinear amplifier, a combiner, a rectifier, etc., which may be integrated into the BAN chip design to save space and power. Some embodiments include baseband processing which generates the two vector signals on the fly as well as other control functions.

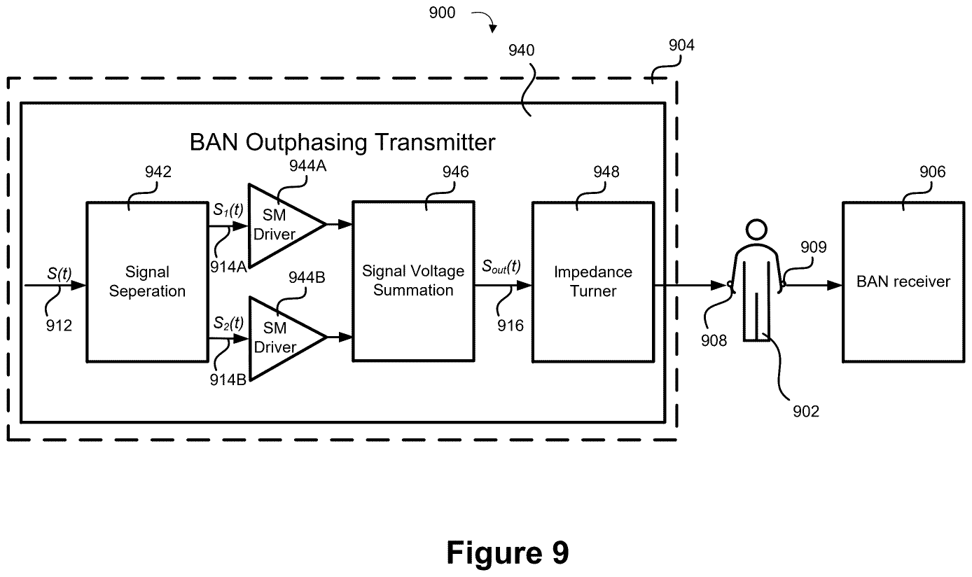

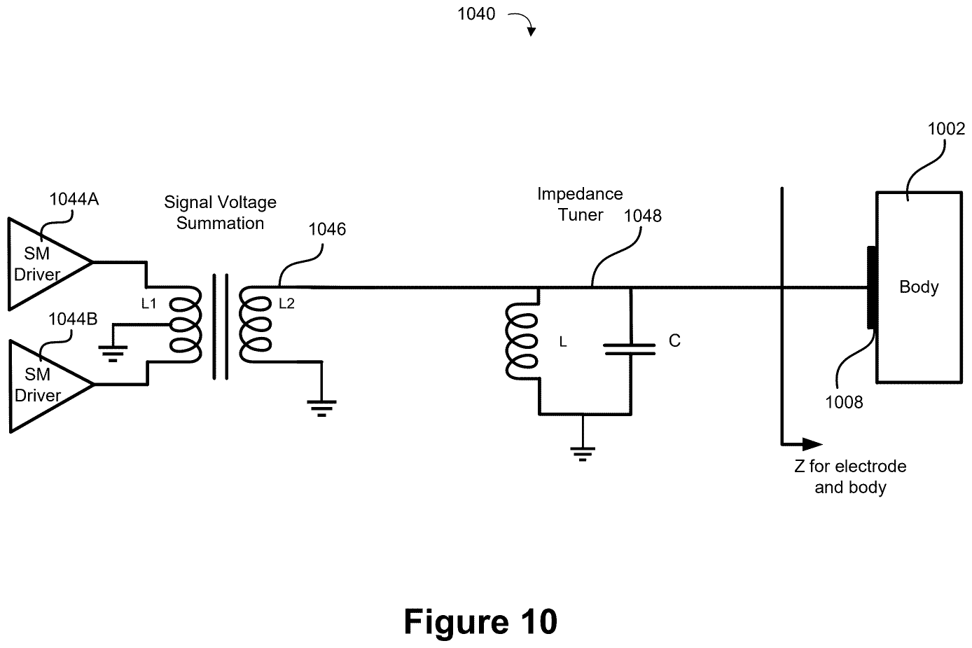

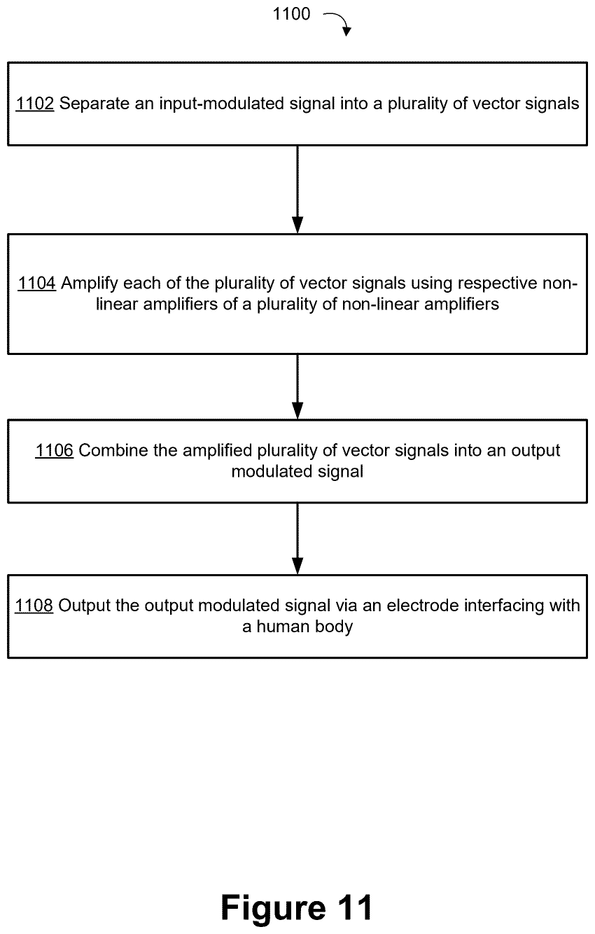

FIGS. 8-11 describe an outphasing transmitter system for a body area network (BAN). Detailed descriptions of outphasing will be provided in connection with FIG. 8. Detailed descriptions of an example outphasing transmitter system will be provided in connection with FIG. 9. Detailed descriptions of a transmitter portion of an example outphasing transmitter system will be provided in connection with FIG. 10. In addition, detailed descriptions of an example process of using an outphasing transmitter system for a BAN will be provided in connection with FIG. 11.

Any I/Q signal may be formed by the vector sum of two constant-amplitude signals with a specific phase angle, also known as outphasing. FIG. 8 illustrates a diagram 800 of outphasing. FIG. 8 illustrates the I/Q signal S(t) equivalent to the vector sum of S₁(t) and S₂(t). As further illustrated in FIG. 8, both S₁(t) and S₂(t) have the same amplitude and phase angle θ(t).

FIG. 9 illustrates a simplified diagram of a BAN system 900 including, a user 902, a BAN transmitter device 904, and a BAN receiver device 906. BAN transmitter device 904 may be coupled to a body of user 902 via an electrode 908 for signal transmission and BAN receiver device 906 may be coupled to the body via an electrode 909 for signal transmission. BAN system 900 may allow transmitting data signals from BAN transmitter device 904 (corresponding to any BAN device and/or portion thereof capable of transmitting data signals) to BAN receiver device 906 (corresponding to any BAN device and/or portion thereof capable of receiving data signals) via the body of user 902.

As further illustrated in FIG. 9, BAN transmitter device 904 may include an outphasing transmitter circuit 940 (e.g., corresponding to a baseband processor sub-system of BAN transmitter device 904), which may further include a signal separation circuit 942, a non-linear amplifier 944A, a non-linear amplifier 944B, a signal voltage summation circuit 946, and an impedance tuner 948.

As described above, a data signal 912 corresponding to S(t) (which may be an input modulated signal such as QPSK or QAM), may be outphased by signal separation circuit 942 (e.g., one or more baseband processors) into two separate vector signals having a certain phase and constant amplitude, a vector signal 914A corresponding to S₁(t) and a vector signal 914B corresponding to S₂(t). Because the amplitude is constant, a non-linear amplifier such as a switch mode amplifier may be used to significantly boost the efficiency without signal distortion. Non-linear amplifier 944A (e.g., a switch mode driver or transmission amplifier) may amplify vector signal 914A, and non-linear amplifier 944B (e.g., a switch mode driver or transmission amplifier) may amplify vector signal 914B. One of both of non-linear amplifier 944A or non-linear amplifier 944B may be designed in a voltage mode (e.g., a MOSFET driver and/or CMOS inverter), or a power mode, depending on a signaling mode of BAN system 900. In some embodiments, a loading effect of a human body and/or its electrode interface is considered in the design of the non-linear amplifiers.

After the amplification of the vector signals (e.g., vector signal 914A and vector signal 914B), the vector signals may be combined by signal voltage summation circuit 946 (e.g., a summing amplifier circuit, a power combiner circuit, etc.). The two amplified vector signals may be summed to form an output modulated signal 916 corresponding to Sout(t). In some embodiments, if BAN system 900 is in a power signaling mode, signal voltage summation circuit 946 corresponds to a power combiner circuit, as illustrated in FIG. 10.

FIG. 10 illustrates a BAN outphasing transmitter circuit 1040 (corresponding to at least portions of outphasing transmitter circuit 940) including a non-linear driver 1044A (corresponding to non-linear amplifier 944A), a non-linear driver 1044B (corresponding to non-linear amplifier 944B), a signal voltage summation circuit 1046 (corresponding to signal voltage summation circuit 946), and an impedance tuner 1048 (corresponding to impedance tuner 948). Signal voltage summation circuit 1046 may be configured as a power combining, if the BAN system is in a power signaling mode. In some embodiments, the loading effect of the human body and its electrode interface is included in the design of signal voltage summation circuit 1046 and/or the power combiner. The summed or combined output signal Sₒᵤₜ(t) may accordingly be an amplified version of the input modulated signal S(t), without any distortion (see, e.g., FIG. 8).

Returning to FIG. 9, in some embodiments, further enhancement of system efficiency can be achieved by the rectification and recovery of DC power. For example, impedance tuner 948 may be used for maximizing signal SNR for output modulated signal 916 to account for the impedance of electrode 908 and high resistance and capacitance of the body of user 902. FIG. 10 further illustrates impedance tuner 1048 account for the impedance (Z) of an electrode 1008 (corresponding to electrode 908) and a body 1002 (corresponding to user 902).

Turning back to FIG. 9, the impedance-tuned output modulated signal 916 may be transmitted through the body (via an electrode interface between electrode 908 and the body of user 902) and received via another electrode interface with electrode 909 to BAN receiver device 906 for processing the signal.

FIG. 11 is a flow diagram of an example method 1100 for transmitting BAN signals using an outphasing transmitter. The method 1100 is performed at a computing system (e.g., a wearable device, intermediary device, server device, and/or service platform) having one or more processors (e.g., CPUs, controllers, and/or other types of control circuitry) and memory. In some embodiments, the memory stores one or more programs configured for execution by the one or more processors. At least some of the operations shown in FIG. 11 correspond to instructions stored in a computer memory or a computer-readable storage medium. In some embodiments, the computing system comprises a wearable device, such as a wrist-wearable device, a head-wearable device, or other type of wearable device. In some embodiments, the method 1100 is performed by the same system as the method 700 described above.

The system separates (1102) an input-modulated signal into a plurality of vector signals. For example, signal separation circuit 942 may separate data signal 912 into vector signal 914A and vector signal 914B. In some embodiments, the signal separation circuit decomposes the input-modulated signal into two constant-amplitude signals with specific phase angles, where the phase angles are determined based on the desired amplitude and phase of the output signal. The signal separation may be performed by a baseband processor that generates the two constant-amplitude vector signals on the fly based on the input data to be transmitted. In some embodiments, the plurality of vector signals consists of two vector signals, while in other embodiments, the plurality of vector signals comprise more than two vector signals for more complex modulation schemes. The signal separation circuit may implement a signal component separator (SCS) algorithm that calculates the required phase angles for each vector signal based on the instantaneous amplitude and phase of the input-modulated signal. In some embodiments, the input-modulated signal comprises a higher-order modulation signal such as quadrature phase-shift keying (QPSK) or quadrature amplitude modulation (QAM), which would otherwise require linear amplification due to high peak-to-average power ratio (PAPR).

The system amplifies (1104) each of the plurality of vector signals using respective non-linear amplifiers of a plurality of non-linear amplifiers. For example, non-linear amplifier 944A may amplify vector signal 914A, and non-linear amplifier 944B may amplify vector signal 914B. In some embodiments, the non-linear amplifiers comprise switch-mode power amplifiers that operate with high efficiency due to the constant-amplitude nature of the vector signals. The switch-mode amplifiers may include Class-D, Class-E, or Class-F amplifier topologies that achieve efficiency levels significantly higher than linear amplifier classes such as Class-A or Class-AB. In some embodiments, each non-linear amplifier is configured to amplify a respective constant-envelope signal without introducing amplitude distortion, since the amplitude of each vector signal remains constant throughout the modulation period. The use of non-linear amplifiers for constant-amplitude signals allows for power efficiency improvements compared to systems that use linear amplifiers for amplitude-modulated signals. In some embodiments, the non-linear amplifiers are integrated into a BAN chip design to reduce space and power consumption. The non-linear amplifiers may be implemented using complementary metal-oxide-semiconductor (CMOS) technology to enable integration with other BAN circuitry on a single integrated circuit.

The system combines (1106) the amplified plurality of vector signals into an output modulated signal. For example, signal voltage summation circuit 946 may combine amplified vector signal 914A and amplified vector signal 914B. In some embodiments, the combining is performed using vector summation, where the two constant-amplitude signals are added together to produce the desired amplitude-modulated output signal. The signal voltage summation circuit may comprise a power combiner that performs the vector addition of the amplified signals. In some embodiments, the combiner is configured to perform the vector sum such that the resulting output signal has the desired amplitude and phase corresponding to the original input-modulated signal. The combining process can reconstruct the original modulation by leveraging the phase relationship between the two vector signals, where the output amplitude is determined by the phase difference between the two constant-amplitude components. In some embodiments, the system further comprises a rectifier configured to recover DC power from the combining process, e.g., thereby further enhancing system efficiency. The rectifier may capture energy that would otherwise be dissipated in the combiner and return it to the power supply. In some embodiments, the combiner comprises a transformer-based combiner, a Chireix combiner, or other power combining topology suitable for outphasing transmitter architectures.

The system outputs (1108) the output modulated signal via an electrode interfacing with a human body. For example, output modulated signal 916 may be output via electrode 908 for transmission through the body. In some examples, impedance tuner 948 may perform impedance tuning on output modulated signal 916 to account for the impedance of the electrode-body interface. In some embodiments, the electrode comprises a dry electrode configured to contact the wearer's skin, such as a charging contact on an earbud device or an EMG electrode on a wrist-wearable device. The electrode may be positioned at a location on the wearable device that naturally contacts the user's body during normal wear, such as a nose bridge, nose pad, or temple arm location on a head-wearable device. In some embodiments, the impedance tuner is configured to dynamically adjust the output impedance based on detected variations in body impedance, which may occur due to user movement, changes in device positioning, or environmental factors. The impedance tuning may be performed using a closed-loop algorithm that receives feedback from a receiver device to optimize transmission impedance, or using an open-loop algorithm that selects impedance values from a lookup table based on detected impedance conditions. The outphasing transmitter system can be suitable for BAN applications because the operating frequency is relatively low, making it easier to control phase error between the vector signals, and the data rate requirements are moderate, resulting in acceptable baseband processing overhead. The outphasing architecture enables the BAN system to achieve high data rates using higher-order modulations while maintaining the power efficiency benefits typically associated with constant-envelope modulations.

As detailed above, an outphasing system may be particularly suitable for BAN applications because the operating frequency is low to allow relative ease in controlling the phase error, and the data rate may be sufficiently low such that the baseband processing overhead may be low. The present disclosure provides a hardware embodiment of nonlinear amplifier(s), combiner(s), rectifier(s), etc., which may be integrated into a BAN chip design to save space and power. The systems and methods provided herein may utilize baseband processing to generate the two vector signals on the fly along with other control functions.

As detailed above, in some examples, the system may include components integrated into a single device, including a signal separation circuit (e.g., baseband processors for generating the two constant-amplitude vector signals with a certain phase), one or more nonlinear PAs (e.g., a switch mode amplifier, which may be used due to the amplitude being constant, to significantly boost the efficiency without signal distortion), a combiner (e.g., for combining the two vector signals after the amplification to form the modulated signal). These components may attach to human body through electrodes for signal transmission.

The systems and methods described herein may advantageously provide low power consumption by using highly efficient switch mode nonlinear amplifiers in the outphasing transmitter system, to achieve BAN efficiency enhancement. In addition, the systems and methods described herein may advantageously provide low signal distortion by achieving the high system linearity, the signal transmitting toward the human body maintains low distortion.

One example of an outphasing transmitter for BAN system, may include nonlinear SM driver amplifiers, signal voltage summation, impedance tuner, etc. These circuits may be integrated into the BAN chip design. Accordingly, the systems and methods described herein may allow for managing the fundamental tradeoff between system data rate and power consumption. By utilizing an outphasing transmitter, this system enhances flexibility and efficiency, making it suitable for high speed, low power BAN device use cases.

(C1) In accordance with some embodiments, a device includes a signal separation circuit configured to separate a data signal into a plurality of vector signals, a plurality of non-linear amplifiers where each non-linear amplifier of the plurality is configured to amplify respective vector signals of the plurality of vector signals, and a signal voltage summation circuit configured to combine the amplified plurality of vector signals into an output modulated signal. For example, the device may be a wearable device configured for body area network communication, such as a smartwatch, augmented-reality glasses, or earbuds. The signal separation circuit may decompose an input signal having varying amplitude and phase into two or more constant-amplitude signals with specific phase angles, enabling the use of highly efficient switch-mode amplifiers for each signal path. In some embodiments, the device further includes a baseband processor configured to generate the plurality of vector signals on the fly based on the data signal. In some embodiments, the device is integrated into a single chip, e.g., to save space and power. The output modulated signal may be a higher-order modulation signal such as quadrature phase-shift keying (QPSK) or quadrature amplitude modulation (QAM) that would otherwise require linear amplifiers with relatively low efficiency.

(C2) In some embodiments of C1, the data signal corresponds to an input modulated signal where the plurality of vector signals corresponds to constant-amplitude vector signals having a common phase angle. For example, the input modulated signal may be an I/Q modulated signal that is decomposed into two constant-amplitude signals S1(t) and S2(t), where each signal has the same amplitude but differs in phase angle theta(t) relative to a reference direction. The vector sum of S1(t) and S2(t) reconstructs the original input modulated signal with its desired amplitude and phase characteristics. In some embodiments, the phase angle theta(t) is dynamically adjusted to achieve any desired amplitude and phase for the combined output signal. In some embodiments, the constant-amplitude vector signals enable the use of nonlinear amplifiers such as switch-mode amplifiers without introducing signal distortion, since the amplitude remains constant throughout the amplification process. The common phase angle may be computed by the signal separation circuit based on the instantaneous amplitude and phase requirements of the input modulated signal.

(C3) In some embodiments of any of C1-C2, the signal separation circuit corresponds to a baseband processor. For example, the baseband processor may be a digital signal processor configured to compute the phase angles for the plurality of vector signals based on the input modulated signal characteristics. In some embodiments, the baseband processor generates the two constant-amplitude vector signals on the fly during signal transmission. In some embodiments, the baseband processor implements control functions for managing the outphasing transmitter system, including phase error correction and signal timing synchronization. The baseband processor may be integrated into a body area network chip design along with other transmitter components. In some embodiments, the baseband processor is configured to handle the processing overhead associated with generating the vector signals, e.g., making phase error control easier to implement.

(C4) In some embodiments of any of C1-C3, at least one of the plurality of non-linear amplifiers corresponds to a switch mode driver. For example, the switch mode driver may be a Class D or Class E amplifier that operates by switching between fully on and fully off states, achieving significantly higher efficiency than linear amplifiers. In some embodiments, each of the plurality of non-linear amplifiers is a switch mode driver, enabling the entire amplification stage to operate with high efficiency. The switch mode driver is particularly suitable for amplifying constant-amplitude signals because the lack of amplitude variation eliminates the need for linear operation. In some embodiments, the switch mode driver achieves efficiency levels exceeding 80% or 90%, compared to linear amplifiers that may achieve only 30% to 50% efficiency. The use of switch mode drivers in the outphasing transmitter system allows body area network devices to achieve high data rates while maintaining low power consumption, addressing the fundamental conflict between data rate and power consumption in conventional designs.

(C5) In some embodiments of any of C1-C4, at least one of the plurality of non-linear amplifiers corresponds to a voltage mode amplifier. For example, the voltage mode amplifier may be configured to provide voltage gain while maintaining the constant-amplitude characteristic of the vector signals. In some embodiments, the voltage mode amplifier is a Class C amplifier or another amplifier topology that operates in a nonlinear region for improved efficiency. The voltage mode amplifier may be designed to interface with the signal voltage summation circuit for proper signal combining. In some embodiments, the voltage mode amplifier is optimized for the operating frequency range of the body area network system, which is typically in the low megahertz range where phase control is more manageable. The voltage mode amplifier may be integrated into the body area network chip design to minimize space and power overhead.

(C6) In some embodiments of any of C1-C5, at least one of the plurality of non-linear amplifiers corresponds to a power mode amplifier. For example, the power mode amplifier may be a Class F amplifier or inverse Class F amplifier configured to maximize power efficiency by shaping the voltage and current waveforms at the transistor output. In some embodiments, the power mode amplifier is designed to deliver sufficient output power for body area network transmission through the human body while maintaining high efficiency. The power mode amplifier may include harmonic tuning networks to achieve the desired waveform shaping for efficient operation. In some embodiments, the power mode amplifier is configured to operate at the specific impedance levels presented by the electrode interface and human body channel. The power mode amplifier may be combined with rectification and recovery circuits to further enhance system efficiency by recovering DC power from reflected signals.

(C7) In some embodiments of any of C1-C6, at least one of the plurality of non-linear amplifiers is configured for a loading effect of an electrode interface on a human body. For example, the non-linear amplifier may be designed with output impedance characteristics that account for the variable impedance presented by the electrode-skin interface and the human body channel. In some embodiments, the non-linear amplifier is configured to operate efficiently across a range of load impedances that may vary based on user body type, skin moisture, contact pressure, and environmental conditions. The non-linear amplifier may include adaptive biasing or tuning elements to accommodate changes in the loading effect during operation. In some embodiments, the non-linear amplifier is co-designed with the electrode geometry and placement to optimize the overall transmitter performance for body area network communication. The loading effect configuration may account for both the forward path coupling through the body and the return path capacitance to earth ground.

(C8) In some embodiments of any of C1-C7, the signal voltage summation circuit corresponds to a power combiner circuit. For example, the power combiner circuit may be a Chireix combiner or Wilkinson combiner configured to efficiently combine the amplified constant-amplitude vector signals into the output modulated signal. In some embodiments, the power combiner circuit is designed to perform vector addition of the two amplified signals, where the phase relationship between the signals determines the amplitude and phase of the combined output. The power combiner circuit may include impedance matching elements to interface with the non-linear amplifiers and the electrode output stage. In some embodiments, the power combiner circuit is configured to minimize power loss during the combining process, maintaining the efficiency benefits achieved by the non-linear amplifiers. The power combiner circuit may be integrated into the body area network chip design along with the signal separation circuit and non-linear amplifiers.

(C9) In some embodiments of any of C1-C8, the signal voltage summation circuit corresponds to a summing circuit. For example, the summing circuit may be an analog summing amplifier or a passive summing network configured to add the amplified vector signals together. In some embodiments, the summing circuit performs direct voltage addition of the two constant-amplitude signals to produce the amplitude-modulated output signal. The summing circuit may be implemented using operational amplifiers, transformers, or transmission line structures depending on the operating frequency and design requirements. In some embodiments, the summing circuit includes isolation elements to prevent interaction between the outputs of the non-linear amplifiers. The summing circuit may be designed to present an appropriate load impedance to each non-linear amplifier for optimal efficiency and signal quality.

(C10) In some embodiments of any of C1-C9, the device further comprises an electrode for interfacing with a human body and an impedance tuner circuit coupled between the electrode and the signal voltage summation circuit. For example, the electrode may be a dry electrode configured to contact the wearer's skin, such as a charging contact on an earbud or an EMG electrode on a wrist-wearable device. The impedance tuner circuit may include variable capacitors, varactors, variable inductors, or electronically tunable impedance networks configured to match the output impedance of the signal voltage summation circuit to the impedance presented by the electrode-body interface. In some embodiments, the impedance tuner circuit is configured to adapt to variations in body impedance that occur due to user movement, changes in device positioning, skin moisture levels, or environmental factors. The impedance tuner circuit may operate using closed-loop feedback from a receiver device or open-loop approaches that select impedance values from lookup tables based on detected conditions. In some embodiments, the impedance tuner circuit is integrated into the body area network chip design to save space and power.

(C11) In some embodiments of any of C1-C10, the impedance tuner is configured based on a desired SNR for the output modulated signal. For example, the impedance tuner may be adjusted to maximize the signal-to-noise ratio at a receiver device by optimizing the power transfer from the transmitter to the human body channel. In some embodiments, the impedance tuner is configured to achieve a target SNR that meets the requirements of the modulation scheme being used, such as QPSK or QAM. The impedance tuner configuration may be determined through measurement-based characterization of impedance ranges across various use cases, user body types, and environmental conditions. In some embodiments, the impedance tuner is dynamically adjusted during operation based on feedback indicating the received signal quality, such as received signal strength indicator (RSSI), bit error rate (BER), or packet error rate measurements. The impedance tuner may also be configured to provide additional margins against regulatory emission limits by optimizing transmission efficiency, allowing the transmitter power level to be reduced while maintaining the desired SNR.

(D1) In accordance with some embodiments, a method includes separating an input modulated signal into a plurality of vector signals, amplifying each of the plurality of vector signals using respective non-linear amplifiers of a plurality of non-linear amplifiers, combining the amplified plurality of vector signals into an output modulated signal, and outputting the output modulated signal via an electrode interfacing with a human body. For example, the method may be performed by an outphasing transmitter system in a wearable device configured for body area network communication. The input modulated signal may be a higher-order modulation signal such as QPSK or QAM that would otherwise require linear amplifiers with low efficiency. In some embodiments, separating the input modulated signal includes computing phase angles for two constant-amplitude vector signals such that their vector sum equals the input modulated signal. The method enables the use of highly efficient switch-mode amplifiers for each signal path while still achieving the desired amplitude-modulated output signal through vector combination. In some embodiments, the method further includes generating control signals for managing the phase relationships between the vector signals during the separation and combining processes.

(D2) In some embodiments of D1, the plurality of vector signals corresponds to constant-amplitude vector signals having a common phase angle. For example, the constant-amplitude vector signals may be two signals S1(t) and S2(t) that each have the same fixed amplitude but differ in their phase angles relative to a reference direction, where the phase angle theta(t) is adjusted to achieve the desired amplitude and phase of the combined output signal. In some embodiments, the common phase angle is computed by a baseband processor based on the instantaneous amplitude and phase requirements of the input modulated signal. The constant-amplitude characteristic of the vector signals enables the use of nonlinear amplifiers without introducing amplitude distortion, since the amplifiers operate on signals with no amplitude variation. In some embodiments, the phase angle is dynamically adjusted during transmission to track changes in the input modulated signal.

(D3) In some embodiments of any of D1-D2, the method further comprises impedance tuning the output modulated signal. For example, impedance tuning may include adjusting a variable impedance component coupled between the signal combining circuit and the electrode to match the impedance presented by the electrode-body interface. In some embodiments, impedance tuning is performed using closed-loop feedback, where a signal quality indicator is received from a receiver device and the impedance is adjusted based on the received indicator to optimize transmission performance. In some embodiments, impedance tuning is performed using open-loop feedback, where an impedance value is selected from a lookup table based on detected conditions such as body impedance measurements, device positioning, or environmental factors. The method may include iteratively adjusting the impedance and monitoring changes in signal quality to converge on an optimal impedance value. In some embodiments, impedance tuning is performed continuously during data transmission to adapt to changes in body impedance that occur due to user movement or changes in device positioning. Impedance tuning may also include adjusting the impedance to achieve a target signal-to-noise ratio at the receiver while minimizing transmitter power consumption.

In another aspect, some embodiments include a computing system (e.g., comprising one or more wearable devices) including control circuitry and memory coupled to the control circuitry, the memory storing one or more sets of instructions configured to be executed by the control circuitry, the one or more sets of instructions including instructions for performing one or more of the methods described herein (e.g., the methods 700 and 1100 as well as A1-A8 and D1-D3). In yet another aspect, some embodiments include a non-transitory computer-readable storage medium storing one or more sets of instructions for execution by control circuitry of a computing system, the one or more sets of instructions including instructions for performing one or more of the methods described herein (e.g., the methods 700 and 1100 as well as A1-A8 and D1-D3).

Embodiments of this disclosure can include or be implemented in conjunction with various types or embodiments of artificial-reality systems. Artificial reality (AR), as described herein, is any superimposed functionality and or sensory-detectable presentation provided by an artificial-reality system within a user's physical surroundings. Such artificial realities can include and/or represent virtual reality (VR), augmented reality, mixed artificial reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality systems may be implemented in a variety of different form factors and configurations. Some artificial-reality systems include a near-eye display (NED), which provides visibility into the real world (e.g., the augmented-reality system 7000 in FIG. 14A) or that visually immerses a user in an artificial reality (e.g., the virtual-reality system 7010 in FIG. 10B). While some artificial-reality devices are self-contained systems, other artificial-reality devices communicate and/or coordinate with external devices to provide an artificial-reality experience to a user. Examples of such external devices include handheld controllers, mobile devices, desktop computers, devices worn by a user (e.g., the wearable device 6000 in FIG. 13A), devices worn by one or more other users, and/or any other suitable external system.

The devices described above are further detailed below, including wrist-wearable devices, headset devices, systems, and haptic feedback devices. Specific operations described above may occur as a result of specific hardware; such hardware is described in further detail below. The devices described below are not limiting, and features on these devices can be removed or additional features can be added to these devices.

### Example Systems

FIGS. 12A-12D-2 illustrate example AR systems in accordance with some embodiments. FIG. 15A shows an AR system 5000a and first example user interactions using a wrist-wearable device 6000, a head-wearable device (e.g., AR system 7000), and/or a handheld intermediary processing device (HIPD) 8000. FIG. 12B shows an AR system 5000b and second example user interactions using the wrist-wearable device 6000, the AR system 7000, and/or an HIPD 8000. FIGS. 12C-1 and 12C-2 show an AR system 5000c and third example user interactions using a wrist-wearable device 6000, a head-wearable device (e.g., VR headset 7010), and/or an HIPD 8000. FIGS. 12D-1 and 12D-2 show a fourth AR system 5000d and fourth example user interactions using a wrist-wearable device 6000, VR system 7010, and/or device 9000 (e.g., wearable haptic gloves). The above-example AR systems (described in detail below) can perform the various functions and/or operations described above with reference to FIGS. 1-7.

The wrist-wearable device 6000 and its components are described below in reference to FIGS. 13A-13B; the head-wearable devices and their components are described below in reference to FIGS. 14A-14C; and the HIPD 8000 and its components are described below in reference to FIGS. 15A-15B. Wearable gloves and their components are described below in reference to FIGS. 16A-16B. As shown in FIG. 12A, the wrist-wearable device 6000, the head-wearable devices, and/or the HIPD 8000 can communicatively couple via a network 5025 (e.g., cellular, near field, Wi-Fi, personal area network, or wireless LAN). Additionally, the wrist-wearable device 6000, the head-wearable devices, and/or the HIPD 8000 can also communicatively couple with one or more servers 5030, computers 5040 (e.g., laptops, computers, etc.), mobile devices 5050 (e.g., smartphones, tablets, etc.), and/or other electronic devices via the network 5025 (e.g., cellular, near field, Wi-Fi, personal area network, wireless LAN, etc.) Similarly, the device 9000 can also communicatively couple with the wrist-wearable device 6000, the head-wearable devices, the HIPD 8000, the one or more servers 5030, the computers 5040, the mobile devices 5050, and/or other electronic devices via the network 5025.

Turning to FIG. 12A, a user 5002 is shown wearing the wrist-wearable device 6000 and the AR system 7000 and having the HIPD 8000 on their desk. The wrist-wearable device 6000, the AR system 7000, and the HIPD 8000 facilitate user interaction with an AR environment. In particular, as shown by the AR system 5000a, the wrist-wearable device 6000, the AR system 7000, and/or the HIPD 8000 cause presentation of one or more avatars 5004, digital representations of contacts 5006, and virtual objects 5008. As discussed below, the user 5002 can interact with the one or more avatars 5004, digital representations of the contacts 5006, and virtual objects 5008 via the wrist-wearable device 6000, the AR system 7000, and/or the HIPD 8000.

The user 5002 can use any of the wrist-wearable device 6000, the AR system 7000, and/or the HIPD 8000 to provide user inputs. For example, the user 5002 can perform one or more hand gestures that are detected by the wrist-wearable device 6000 (e.g., using one or more EMG sensors and/or IMUs, described below in reference to FIGS. 13A-13B) and/or AR system 7000 (e.g., using one or more image sensor or camera, described below in reference to FIGS. 14A-10C) to provide a user input. Alternatively, or additionally, the user 5002 can provide a user input via one or more touch surfaces of the wrist-wearable device 6000, the AR system 7000, and/or the HIPD 8000, and/or voice commands captured by a microphone of the wrist-wearable device 6000, the AR system 7000, and/or the HIPD 8000. In some embodiments, the wrist-wearable device 6000, the AR system 7000, and/or the HIPD 8000 include a digital assistant to help the user in providing a user input (e.g., completing a sequence of operations, suggesting different operations or commands, providing reminders, or confirming a command). In some embodiments, the user 5002 provides a user input via one or more facial gestures and/or facial expressions. For example, cameras of the wrist-wearable device 6000, the AR system 7000, and/or the HIPD 8000 can track the user 5002's eyes for navigating a user interface.

The wrist-wearable device 6000, the AR system 7000, and/or the HIPD 8000 can operate alone or in conjunction to allow the user 5002 to interact with the AR environment. In some embodiments, the HIPD 8000 is configured to operate as a central hub or control center for the wrist-wearable device 6000, the AR system 7000, and/or another communicatively coupled device. For example, the user 5002 can provide an input to interact with the AR environment at any of the wrist-wearable device 6000, the AR system 7000, and/or the HIPD 8000, and the HIPD 8000 can identify one or more back-end and front-end tasks to cause the performance of the requested interaction and distribute instructions to cause the performance of the one or more back-end and front-end tasks at the wrist-wearable device 6000, the AR system 7000, and/or the HIPD 8000. In some embodiments, a back-end task is background processing task that is not perceptible by the user (e.g., rendering content, decompression, or compression), and a front-end task is a user-facing task that is perceptible to the user (e.g., presenting information to the user or providing feedback to the user). As described below in reference to FIGS. 15A-15B, the HIPD 8000 can perform the back-end tasks and provide the wrist-wearable device 6000 and/or the AR system 7000 operational data corresponding to the performed back-end tasks such that the wrist-wearable device 6000 and/or the AR system 7000 can perform the front-end tasks. In this way, the HIPD 8000, which can have more computational resources and greater thermal headroom than the wrist-wearable device 6000 and/or the AR system 7000, performs computationally intensive tasks and reduces the computer resource utilization and/or power usage of the wrist-wearable device 6000 and/or the AR system 7000.

In the example shown by the XR system 5000a, the HIPD 8000 identifies one or more back-end tasks and front-end tasks associated with a user request to initiate an AR video call with one or more other users (represented by the avatar 5004 and the digital representation of the contact 5006) and distributes instructions to cause the performance of the one or more back-end tasks and front-end tasks. In particular, the HIPD 8000 performs back-end tasks for processing and/or rendering image data (and other data) associated with the AR video call and provides operational data associated with the performed back-end tasks to the AR system 7000 such that the AR system 7000 perform front-end tasks for presenting the AR video call (e.g., presenting the avatar 5004 and the digital representation of the contact 5006).

In some embodiments, the HIPD 8000 operates as a focal or anchor point for causing the presentation of information. This allows the user 5002 to be generally aware of where information is presented. For example, as shown in the AR system 5000a, the avatar 5004 and the digital representation of the contact 5006 are presented above the HIPD 8000. In particular, the HIPD 8000 and the AR system 7000 operate in conjunction to determine a location for presenting the avatar 5004 and the digital representation of the contact 5006. In some embodiments, information can be presented a predetermined distance from the HIPD 8000 (e.g., within 5 meters). For example, as shown in the AR system 5000a, virtual object 5008 is presented on the desk some distance from the HIPD 8000. Similar to the above example, the HIPD 8000 and the AR system 7000 can operate in conjunction to determine a location for presenting the virtual object 5008. Alternatively, in some embodiments, presentation of information is not bound by the HIPD 8000. More specifically, the avatar 5004, the digital representation of the contact 5006, and the virtual object 5008 do not have to be presented within a predetermined distance of the HIPD 8000.

User inputs provided at the wrist-wearable device 6000, the AR system 7000, and/or the HIPD 8000 are coordinated such that the user can use any device to initiate, continue, and/or complete an operation. For example, the user 5002 can provide a user input to the AR system 7000 to cause the AR system 7000 to present the virtual object 5008 and, while the virtual object 5008 is presented by the AR system 7000, the user 5002 can provide one or more hand gestures via the wrist-wearable device 6000 to interact and/or manipulate the virtual object 5008.

FIG. 12B shows the user 5002 wearing the wrist-wearable device 6000 and the AR system 7000 and holding the HIPD 8000. In the AR system 5000b, the wrist-wearable device 6000, the AR system 7000, and/or the HIPD 8000 are used to receive and/or provide one or more messages to a contact of the user 5002. In particular, the wrist-wearable device 6000, the AR system 7000, and/or the HIPD 8000 detect and coordinate one or more user inputs to initiate a messaging application and prepare a response to a received message via the messaging application.

In some embodiments, the user 5002 initiates, via a user input, an application on the wrist-wearable device 6000, the AR system 7000, and/or the HIPD 8000 that causes the application to initiate on at least one device. For example, in the AR system 5000b the user 5002 performs a hand gesture associated with a command for initiating a messaging application (represented by messaging user interface 5012); the wrist-wearable device 6000 detects the hand gesture; and, based on a determination that the user 5002 is wearing AR system 7000, causes the AR system 7000 to present a messaging user interface 5012 of the messaging application. The AR system 7000 can present the messaging user interface 5012 to the user 5002 via its display (e.g., as shown by user 5002's field of view 5010). In some embodiments, the application is initiated and ran on the device (e.g., the wrist-wearable device 6000, the AR system 7000, and/or the HIPD 8000) that detects the user input to initiate the application, and the device provides another device operational data to cause the presentation of the messaging application. For example, the wrist-wearable device 6000 can detect the user input to initiate a messaging application; initiate and run the messaging application; and provide operational data to the AR system 7000 and/or the HIPD 8000 to cause presentation of the messaging application. Alternatively, the application can be initiated and ran at a device other than the device that detected the user input. For example, the wrist-wearable device 6000 can detect the hand gesture associated with initiating the messaging application and cause the HIPD 8000 to run the messaging application and coordinate the presentation of the messaging application.

Further, the user 5002 can provide a user input provided at the wrist-wearable device 6000, the AR system 7000, and/or the HIPD 8000 to continue and/or complete an operation initiated are at another device. For example, after initiating the messaging application via the wrist-wearable device 6000 and while the AR system 7000 present the messaging user interface 5012, the user 5002 can provide an input at the HIPD 8000 to prepare a response (e.g., shown by the swipe gesture performed on the HIPD 8000). The user 5002's gestures performed on the HIPD 8000 can be provided and/or displayed on another device. For example, the user 5002's swipe gestured performed on the HIPD 8000 are displayed on a virtual keyboard of the messaging user interface 5012 displayed by the AR system 7000.

In some embodiments, the wrist-wearable device 6000, the AR system 7000, the HIPD 8000, and/or other communicatively couple device presents one or more notifications to the user 5002. The notification can be an indication of a new message, an incoming call, an application update, or a status update. The user 5002 can select the notification via the wrist-wearable device 6000, the AR system 7000, the HIPD 8000, and cause presentation of an application or operation associated with the notification on at least one device. For example, the user 5002 can receive a notification that a message was received at the wrist-wearable device 6000, the AR system 7000, the HIPD 8000, and/or other communicatively couple device and provide a user input at the wrist-wearable device 6000, the AR system 7000, and/or the HIPD 8000 to review the notification, and the device detecting the user input can cause an application associated with the notification to be initiated and/or presented at the wrist-wearable device 6000, the AR system 7000, and/or the HIPD 8000.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, and financial applications. For example, the AR system 7000 can present to the user 5002 game application data and the HIPD 8000 can use a controller to provide inputs to the game. Similarly, the user 5002 can use the wrist-wearable device 6000 to initiate a camera of the AR system 7000, and the user can use the wrist-wearable device 6000, the AR system 7000, and/or the HIPD 8000 to manipulate the image capture (e.g., zoom in or out, apply filters, etc.) and capture image data.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform one or more functions. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

As described herein, a processor (e.g., a central processing unit (CPU)), is an electronic component that is responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing, and/or can be customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, memory refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders); (iii) flash memory, which can be configured to store data in electronic devices (e.g., USB drives, memory cards, and/or solid-state drives (SSDs); and (iv) cache memory configured to temporarily store frequently accessed data and instructions. Memory, as described herein, can include structured data (e.g., SQL databases, MongoDB databases, GraphQL data, and/or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, controllers are electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) which may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs.

As described herein, a power system of an electronic device is configured to convert incoming electrical power into a form that can be used to operate the device. A power system can include various components, including: (i) a power source, which can be an alternating current (AC) adapter or a direct current (DC) adapter power supply; (ii) a charger input, and can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and to ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals, and can provide a means for input and output of data and signals. Examples of peripheral interfaces can include: (i) universal serial bus (USB) and/or micro-USB interfaces configured for connecting devices to an electronic device; (ii) Bluetooth interfaces configured to allow devices to communicate with each other, including Bluetooth low energy (BLE); (iii) near field communication (NFC) interfaces configured to be short-range wireless interface for operations such as access control; (iv) POGO pins, which may be small, spring-loaded pins configured to provide a charging interface; (v) wireless charging interfaces; (vi) GPS interfaces; (vii) Wi-Fi interfaces for providing a connection between a device and a wireless network; (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can includer: (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface); light sensors (e.g., time-of-flight sensors, infrared light sensors, visible light sensors, etc.); . . . . As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and to diagnose neuromuscular disorders; (iv) electrooculography (EOG) sensors conFigure to measure the electrical activity of eye muscles to detect eye movement and diagnose eye disorders.

As described herein, an application stored in memory of an electronic device (e.g., software) includes instructions stored in the memory. Examples of such applications include: (i) games; (ii) word processors; messaging applications; media-streaming applications; financial applications; calendars; clocks; communication interface modules for enabling wired and/or wireless connections between different respective electronic devices (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols);

As described herein, a communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs) and/or protocols like HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example Wrist-wearable Devices

FIGS. 13A and 13B illustrate the wrist-wearable device 6000 in accordance with some embodiments. FIG. 13A illustrates components of the wrist-wearable device 6000, which can be used individually or in combination, including combinations that include other electronic devices and/or electronic components.

FIG. 13A shows a wearable band 6010 and a watch body 6020 (or capsule) being coupled, as discussed below, to form the wrist-wearable device 6000. The wrist-wearable device 6000 can perform various functions and/or operations associated with navigating through user interfaces and selectively opening applications, as well as the functions and/or operations described above with reference to FIGS. 1-7.

As will be described in more detail below, operations executed by the wrist-wearable device 6000 can include: (i) presenting content to a user (e.g., displaying visual content via a display 6005); (ii) detecting (e.g., sensing) user input (e.g., sensing a touch on peripheral button 6023 and/or at a touch screen of the display 6005, a hand gesture detected by sensors (e.g., biopotential sensors); (iii) sensing biometric data via one or more sensors 6013 (e.g., neuromuscular signals, heart rate, temperature, and/or sleep); messaging (e.g., text, speech, and/or video); image capture via one or more imaging devices or cameras 6025; wireless communications (e.g., cellular, near field, Wi-Fi, and/or personal area network); location determination; financial transactions; providing haptic feedback; alarms; notifications; biometric authentication; health monitoring; sleep monitoring; etc.

The above-example functions can be executed independently in the watch body 6020, independently in the wearable band 6010, and/or via an electronic communication between the watch body 6020 and the wearable band 6010. In some embodiments, functions can be executed on the wrist-wearable device 6000 while an AR environment is being presented (e.g., via one of the AR systems 5000a to 5000d). As the skilled artisan will appreciate upon reading the descriptions provided herein, the novel wearable devices described herein can be used with other types of AR environments.

The wearable band 6010 can be configured to be worn by a user such that an inner surface of the wearable band 6010 is in contact with the user's skin. When worn by a user, sensors 6013 contact the user's skin. The sensors 6013 can sense biometric data such as a user's heart rate, saturated oxygen level, temperature, sweat level, neuromuscular signal sensors, or a combination thereof. The sensors 6013 can also sense data about a user's environment including a user's motion, altitude, location, orientation, gait, acceleration, position, or a combination thereof. In some embodiment, the sensors 6013 are configured to track a position and/or motion of the wearable band 6010. The one or more sensors 6013 can include any of the sensors defined above and/or discussed below with respect to FIG. 13B.

The one or more sensors 6013 can be distributed on an inside and/or an outside surface of the wearable band 6010. In some embodiments, the one or more sensors 6013 are uniformly spaced along the wearable band 6010. Alternatively, in some embodiments, the one or more sensors 6013 are positioned at distinct points along the wearable band 6010. As shown in FIG. 13A, the one or more sensors 6013 can be the same or distinct. For example, in some embodiments, the one or more sensors 6013 can be shaped as a pill (e.g., sensor 6013a), an oval, a circle a square, an oblong (e.g., sensor 6013c) and/or any other shape that maintains contact with the user's skin (e.g., such that neuromuscular signal and/or other biometric data can be accurately measured at the user's skin). In some embodiments, the one or more sensors 6013 are aligned to form pairs of sensors (e.g., for sensing neuromuscular signals based on differential sensing within each respective sensor). For example, sensor 6013b is aligned with an adjacent sensor to form sensor pair 6014a and sensor 6013d aligned with an adjacent sensor to form sensor pair 6014b. In some embodiments, the wearable band 6010 does not have a sensor pair. Alternatively, in some embodiments, the wearable band 6010 has a predetermined number of sensor pairs (e.g., one pair of sensors, three pairs of sensors, four pairs of sensors, six pairs of sensors, or sixteen pairs of sensors).

The wearable band 6010 can include any suitable number of sensors 6013. In some embodiments, the number and arrangement of sensors 6013 depends on the particular application for which the wearable band 6010 is used. For instance, a wearable band 6010 configured as an armband, wristband, or chest-band may include a plurality of sensors 6013 with different number of sensors 6013 and different arrangement for each use case, such as medical use cases as compared to gaming or general day-to-day use cases.

In accordance with some embodiments, the wearable band 6010 further includes an electrical ground electrode and a shielding electrode. The electrical ground and shielding electrodes, like the sensors 6013, can be distributed on the inside surface of the wearable band 6010 such that they contact a portion of the user's skin. For example, the electrical ground and shielding electrodes can be at an inside surface of coupling mechanism 6016 or an inside surface of a wearable structure 6011. The electrical ground and shielding electrodes can be formed and/or use the same components as the sensors 6013. In some embodiments, the wearable band 6010 includes more than one electrical ground electrode and more than one shielding electrode.

The sensors 6013 can be formed as part of the wearable structure 6011 of the wearable band 6010. In some embodiments, the sensors 6013 are flush or substantially flush with the wearable structure 6011 such that they do not extend beyond the surface of the wearable structure 6011. While flush with the wearable structure 6011, the sensors 6013 are still configured to contact the user's skin (e.g., via a skin-contacting surface). Alternatively, in some embodiments, the sensors 6013 extend beyond the wearable structure 6011 a predetermined distance (e.g., 0.1-2 mm) to make contact and depress into the user's skin. In some embodiment, the sensors 6013 are coupled to an actuator (not shown) configured to adjust an extension height (e.g., a distance from the surface of the wearable structure 6011) of the sensors 6013 such that the sensors 6013 make contact and depress into the user's skin. In some embodiments, the actuators adjust the extension height between 0.01 mm-1.2 mm. This allows the user to customize the positioning of the sensors 6013 to improve the overall comfort of the wearable band 6010 when worn while still allowing the sensors 6013 to contact the user's skin. In some embodiments, the sensors 6013 are indistinguishable from the wearable structure 6011 when worn by the user.

The wearable structure 6011 can be formed of an elastic material, elastomers, etc. configured to be stretched and fitted to be worn by the user. In some embodiments, the wearable structure 6011 is a textile or woven fabric. As described above, the sensors 6013 can be formed as part of a wearable structure 6011. For example, the sensors 6013 can be molded into the wearable structure 6011 or be integrated into a woven fabric (e.g., the sensors 6013 can be sewn into the fabric and mimic the pliability of fabric (e.g., the sensors 6013 can be constructed from a series of woven strands of fabric)).

The wearable structure 6011 can include flexible electronic connectors that interconnect the sensors 6013, the electronic circuitry, and/or other electronic components (described below in reference to FIG. 13B) that are enclosed in the wearable band 6010. In some embodiments, the flexible electronic connectors are configured to interconnect the sensors 6013, the electronic circuitry, and/or other electronic components of the wearable band 6010 with respective sensors and/or other electronic components of another electronic device (e.g., watch body 6020). The flexible electronic connectors are configured to move with the wearable structure 6011 such that the user adjustment to the wearable structure 6011 (e.g., resizing, pulling, and/or folding) does not stress or strain the electrical coupling of components of the wearable band 6010.

As described above, the wearable band 6010 is configured to be worn by a user. In particular, the wearable band 6010 can be shaped or otherwise manipulated to be worn by a user. For example, the wearable band 6010 can be shaped to have a substantially circular shape such that it can be configured to be worn on the user's lower arm or wrist. Alternatively, the wearable band 6010 can be shaped to be worn on another body part of the user, such as the user's upper arm (e.g., around a bicep), forearm, chest, or legs. The wearable band 6010 can include a retaining mechanism 6012 (e.g., a buckle or a hook and loop fastener) for securing the wearable band 6010 to the user's wrist or other body part. While the wearable band 6010 is worn by the user, the sensors 6013 sense data (referred to as sensor data) from the user's skin. In particular, the sensors 6013 of the wearable band 6010 obtain (e.g., sense and record) neuromuscular signals.

The sensed data (e.g., sensed neuromuscular signals) can be used to detect and/or determine the user's intention to perform certain motor actions. In particular, the sensors 6013 sense and record neuromuscular signals from the user as the user performs muscular activations (e.g., movements and/or gestures). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 6005 of the wrist-wearable device 6000 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 6013 can be used to provide a user with an enhanced interaction with a physical object (e.g., devices communicatively coupled with the wearable band 6010) and/or a virtual object in an artificial-reality application generated by an artificial-reality system (e.g., user interface objects presented on the display 6005, or another computing device (e.g., a smartphone)).

In some embodiments, the wearable band 6010 includes one or more haptic devices 6046 (FIG. 16B, e.g., a vibratory haptic actuator) that are configured to provide haptic feedback (e.g., a cutaneous and/or kinesthetic sensation) to the user's skin. The sensors 6013, and/or the haptic devices 6046 can be configured to operate in conjunction with multiple applications including, without limitation, health monitoring, social media, games, and artificial reality (e.g., the applications associated with artificial reality).

The wearable band 6010 can also include coupling mechanism 6016 (e.g., a cradle or a shape of the coupling mechanism can correspond to shape of the watch body 6020 of the wrist-wearable device 6000) for detachably coupling a capsule (e.g., a computing unit) or watch body 6020 (via a coupling surface of the watch body 6020) to the wearable band 6010. In particular, the coupling mechanism 6016 can be configured to receive a coupling surface proximate to the bottom side of the watch body 6020 (e.g., a side opposite to a front side of the watch body 6020 where the display 6005 is located), such that a user can push the watch body 6020 downward into the coupling mechanism 6016 to attach the watch body 6020 to the coupling mechanism 6016. In some embodiments, the coupling mechanism 6016 can be configured to receive a top side of the watch body 6020 (e.g., a side proximate to the front side of the watch body 6020 where the display 6005 is located) that is pushed upward into the cradle, as opposed to being pushed downward into the coupling mechanism 6016. In some embodiments, the coupling mechanism 6016 is an integrated component of the wearable band 6010 such that the wearable band 6010 and the coupling mechanism 6016 are a single unitary structure. In some embodiments, the coupling mechanism 6016 is a type of frame or shell that allows the watch body 6020 coupling surface to be retained within or on the wearable band 6010 coupling mechanism 6016 (e.g., a cradle, a tracker band, a support base, or a clasp).

The coupling mechanism 6016 can allow for the watch body 6020 to be detachably coupled to the wearable band 6010 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 6020 to the wearable band 6010 and to decouple the watch body 6020 from the wearable band 6010. For example, a user can twist, slide, turn, push, pull, or rotate the watch body 6020 relative to the wearable band 6010, or a combination thereof, to attach the watch body 6020 to the wearable band 6010 and to detach the watch body 6020 from the wearable band 6010. Alternatively, as discussed below, in some embodiments, the watch body 6020 can be decoupled from the wearable band 6010 by actuation of the release mechanism 6029.

The wearable band 6010 can be coupled with a watch body 6020 to increase the functionality of the wearable band 6010 (e.g., converting the wearable band 6010 into a wrist-wearable device 6000, adding an additional computing unit and/or battery to increase computational resources and/or a battery life of the wearable band 6010, adding additional sensors to improve sensed data, etc.). As described above, the wearable band 6010 (and the coupling mechanism 6016) is configured to operate independently (e.g., execute functions independently) from watch body 6020. For example, the coupling mechanism 6016 can include one or more sensors 6013 that contact a user's skin when the wearable band 6010 is worn by the user and provide sensor data for determining control commands.

A user can detach the watch body 6020 (or capsule) from the wearable band 6010 in order to reduce the encumbrance of the wrist-wearable device 6000 to the user. For embodiments in which the watch body 6020 is removable, the watch body 6020 can be referred to as a removable structure, such that in these embodiments the wrist-wearable device 6000 includes a wearable portion (e.g., the wearable band 6010) and a removable structure (the watch body 6020).

Turning to the watch body 6020, the watch body 6020 can have a substantially rectangular or circular shape. The watch body 6020 is configured to be worn by the user on their wrist or on another body part. More specifically, the watch body 6020 is sized to be easily carried by the user, attached on a portion of the user's clothing, and/or coupled to the wearable band 6010 (forming the wrist-wearable device 6000). As described above, the watch body 6020 can have a shape corresponding to the coupling mechanism 6016 of the wearable band 6010. In some embodiments, the watch body 6020 includes a single release mechanism 6029 or multiple release mechanisms (e.g., two release mechanisms 6029 positioned on opposing sides of the watch body 6020, such as spring-loaded buttons) for decoupling the watch body 6020 and the wearable band 6010. The release mechanism 6029 can include, without limitation, a button, a knob, a plunger, a handle, a lever, a fastener, a clasp, a dial, a latch, or a combination thereof.

A user can actuate the release mechanism 6029 by pushing, turning, lifting, depressing, shifting, or performing other actions on the release mechanism 6029. Actuation of the release mechanism 6029 can release (e.g., decouple) the watch body 6020 from the coupling mechanism 6016 of the wearable band 6010, allowing the user to use the watch body 6020 independently from wearable band 6010, and vice versa. For example, decoupling the watch body 6020 from the wearable band 6010 can allow the user to capture images using rear-facing camera 6025B. Although the is shown positioned at a corner of watch body 6020, the release mechanism 6029 can be positioned anywhere on watch body 6020 that is convenient for the user to actuate. In addition, in some embodiments, the wearable band 6010 can also include a respective release mechanism for decoupling the watch body 6020 from the coupling mechanism 6016. In some embodiments, the release mechanism 6029 is optional and the watch body 6020 can be decoupled from the coupling mechanism 6016 as described above (e.g., via twisting or rotating).

The watch body 6020 can include one or more peripheral buttons 6023 and 6027 for performing various operations at the watch body 6020. For example, the peripheral buttons 6023 and 6027 can be used to turn on or wake (e.g., transition from a sleep state to an active state) the display 6005, unlock the watch body 6020, increase or decrease a volume, increase or decrease a brightness, interact with one or more applications, and/or interact with one or more user interfaces. Additionally, or alternatively, in some embodiments, the display 6005 operates as a touch screen and allows the user to provide one or more inputs for interacting with the watch body 6020.

In some embodiments, the watch body 6020 includes one or more sensors 6021. The sensors 6021 of the watch body 6020 can be the same or distinct from the sensors 6013 of the wearable band 6010. The sensors 6021 of the watch body 6020 can be distributed on an inside and/or an outside surface of the watch body 6020. In some embodiments, the sensors 6021 are configured to contact a user's skin when the watch body 6020 is worn by the user. For example, the sensors 6021 can be placed on the bottom side of the watch body 6020 and the coupling mechanism 6016 can be a cradle with an opening that allows the bottom side of the watch body 6020 to directly contact the user's skin. Alternatively, in some embodiments, the watch body 6020 does not include sensors that are configured to contact the user's skin (e.g., including sensors internal and/or external to the watch body 6020 that configured to sense data of the watch body 6020 and the watch body 6020's surrounding environment). In some embodiment, the sensors 6013 are configured to track a position and/or motion of the watch body 6020.

The watch body 6020 and the wearable band 6010 can share data using a wired communication method (e.g., a Universal Asynchronous Receiver/Transmitter (UART) or a USB transceiver) and/or a wireless communication method (e.g., near field communication or Bluetooth). For example, the watch body 6020 and the wearable band 6010 can share data sensed by the sensors 6013 and 6021, as well as application and device specific information (e.g., active and/or available applications, output devices (e.g., display and/or speakers), input devices (e.g., touch screen, microphone, and/or imaging sensors).

In some embodiments, the watch body 6020 can include, without limitation, a front-facing camera 6025A and/or a rear-facing camera 6025B, sensors 6021 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 6063; FIG. 13B), a touch sensor, a sweat sensor, etc.). In some embodiments, the watch body 6020 can include one or more haptic devices 6076 (FIG. 13B; a vibratory haptic actuator) that is configured to provide haptic feedback (e.g., a cutaneous and/or kinesthetic sensation) to the user. The sensors 6021 and/or the haptic device 6076 can also be configured to operate in conjunction with multiple applications including, without limitation, health monitoring applications, social media applications, game applications, and artificial reality applications (e.g., the applications associated with artificial reality).

As described above, the watch body 6020 and the wearable band 6010, when coupled, can form the wrist-wearable device 6000. When coupled, the watch body 6020 and wearable band 6010 operate as a single device to execute functions (operations, detections, and/or communications) described herein. In some embodiments, each device is provided with particular instructions for performing the one or more operations of the wrist-wearable device 6000. For example, in accordance with a determination that the watch body 6020 does not include neuromuscular signal sensors, the wearable band 6010 can include alternative instructions for performing associated instructions (e.g., providing sensed neuromuscular signal data to the watch body 6020 via a different electronic device). Operations of the wrist-wearable device 6000 can be performed by the watch body 6020 alone or in conjunction with the wearable band 6010 (e.g., via respective processors and/or hardware components) and vice versa. In some embodiments, operations of the wrist-wearable device 6000, the watch body 6020, and/or the wearable band 6010 can be performed in conjunction with one or more processors and/or hardware components of another communicatively coupled device (e.g., the HIPD 8000; FIGS. 15A-15B).

As described below with reference to the block diagram of FIG. 13B, the wearable band 6010 and/or the watch body 6020 can each include independent resources required to independently execute functions. For example, the wearable band 6010 and/or the watch body 6020 can each include a power source (e.g., a battery), a memory, data storage, a processor (e.g., a central processing unit (CPU)), communications, a light source, and/or input/output devices.

FIG. 13B shows block diagrams of a wearable band computing system 6030 corresponding to the wearable band 6010, and a watch body computing system 6060 corresponding to the watch body 6020, according to some embodiments. A computing system of the wrist-wearable device 6000 includes a combination of components of the wearable band computing system 6030 and the watch body computing system 6060, in accordance with some embodiments.

The watch body 6020 and/or the wearable band 6010 can include one or more components shown in watch body computing system 6060. In some embodiments, a single integrated circuit includes all or a substantial portion of the components of the watch body computing system 6060 are included in a single integrated circuit. Alternatively, in some embodiments, components of the watch body computing system 6060 are included in a plurality of integrated circuits that are communicatively coupled. In some embodiments, the watch body computing system 6060 is configured to couple (e.g., via a wired or wireless connection) with the wearable band computing system 6030, which allows the computing systems to share components, distribute tasks, and/or perform other operations described herein (individually or as a single device).

The watch body computing system 6060 can include one or more processors 6079, a haptic controller 6077, a peripherals interface 6061, a power system 6095, and memory (e.g., a memory 6080), each of which are defined above and described in more detail below.

The power system 6095 can include a charger input 6057, a power-management integrated circuit (PMIC) 6097, and a battery 6096, each are which are defined above. In some embodiments, a watch body 6020 and a wearable band 6010 can have respective batteries (e.g., battery 6098 and 6059), and can share power with each other. The watch body 6020 and the wearable band 6010 can receive a charge using a variety of techniques. In some embodiments, the watch body 6020 and the wearable band 6010 can use a wired charging assembly (e.g., power cords) to receive the charge. Alternatively, or in addition, the watch body 6020 and/or the wearable band 6010 can be configured for wireless charging. For example, a portable charging device can be designed to mate with a portion of watch body 6020 and/or wearable band 6010 and wirelessly deliver usable power to a battery of watch body 6020 and/or wearable band 6010. The watch body 6020 and the wearable band 6010 can have independent power systems (e.g., power system 6095 and 6056) to enable each to operate independently. The watch body 6020 and wearable band 6010 can also share power (e.g., one can charge the other) via respective PMICs (e.g., PMICs 6097 and 6058) that can share power over power and ground conductors and/or over wireless charging antennas.

In some embodiments, the peripherals interface 6061 can include one or more sensors 6021, many of which listed below are defined above. The sensors 6021 can include one or more coupling sensor 6062 for detecting when the watch body 6020 is coupled with another electronic device (e.g., a wearable band 6010). The sensors 6021 can include imaging sensors 6063 (one or more of the cameras 6025, and/or separate imaging sensors 6063 (e.g., thermal-imaging sensors)). In some embodiments, the sensors 6021 include one or more SpO2 sensors 6064. In some embodiments, the sensors 6021 include one or more biopotential-signal sensors (e.g., EMG sensors 6065 and 6035, which may be disposed on a user-facing portion of the watch body 6020 and/or the wearable band 6010). In some embodiments, the sensors 6021 include one or more capacitive sensors 6066. In some embodiments, the sensors 6021 include one or more heart rate sensors 6067. In some embodiments, the sensors 6021 include one or more IMU sensors 6068. In some embodiments, one or more IMU sensors 6068 can be configured to detect movement of a user's hand or other location that the watch body 6020 is placed or held).

In some embodiments, the peripherals interface 6061 includes a near-field communication (NFC) component 6069, a global-position system (GPS) component 6070, a long-term evolution (LTE) component 6071, and/or a Wi-Fi and/or Bluetooth communication component 6072. In some embodiments, the peripherals interface 6061 includes one or more buttons 6073 (e.g., the peripheral buttons 6023 and 6027 in FIG. 13A), which, when selected by a user, cause operation to be performed at the watch body 6020. In some embodiments, the peripherals interface 6061 includes one or more indicators, such as a light emitting diode (LED), to provide a user with visual indicators (e.g., message received, low battery, active microphone and/or camera).

The watch body 6020 can include at least one display 6005, for displaying visual representations of information or data to the user, including user-interface elements and/or three-dimensional virtual objects. The display can also include a touch screen for inputting user inputs, such as touch gestures, swipe gestures, and the like. The watch body 6020 can include at least one speaker 6074 and at least one microphone 6075 for providing audio signals to the user and receiving audio input from the user. The user can provide user inputs through the microphone 6075 and can also receive audio output from the speaker 6074 as part of a haptic event provided by the haptic controller 6078. The watch body 6020 can include at least one camera 6025, including a front-facing camera 6025A and a rear-facing camera 6025B. The cameras 6025 can include ultra-wide-angle cameras, wide angle cameras, fish-eye cameras, spherical cameras, telephoto cameras, a depth-sensing cameras, or other types of cameras.

The watch body computing system 6060 can include one or more haptic controllers 6077 and associated componentry (e.g., haptic devices 6076) for providing haptic events at the watch body 6020 (e.g., a vibrating sensation or audio output in response to an event at the watch body 6020). The haptic controllers 6078 can communicate with one or more haptic devices 6076, such as electroacoustic devices, including a speaker of the one or more speakers 6074 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 6078 can provide haptic events to that are capable of being sensed by a user of the watch body 6020. In some embodiments, the one or more haptic controllers 6078 can receive input signals from an application of the applications 6082.

In some embodiments, the wearable band computing system 6030 and/or the watch body computing system 6060 can include memory 6080, which can be controlled by a memory controller of the one or more haptic controllers 6077. In some embodiments, software components stored in the memory 6080 include one or more applications 6082 configured to perform operations at the watch body 6020. In some embodiments, the one or more applications 6082 include games, word processors, messaging applications, calling applications, web browsers, social media applications, media streaming applications, financial applications, calendars, and/or clocks. In some embodiments, software components stored in the memory 6080 include one or more communication interface modules 6083 as defined above. In some embodiments, software components stored in the memory 6080 include one or more graphics modules 6084 for rendering, encoding, and/or decoding audio and/or visual data; and one or more data management modules 6085 for collecting, organizing, and/or providing access to the data 6087 stored in memory 6080. In some embodiments, one or more of applications 6082 and/or one or more modules can work in conjunction with one another to perform various tasks at the watch body 6020.

In some embodiments, software components stored in the memory 6080 can include one or more operating systems 6081 (e.g., a Linux-based operating system or an Android operating system). The memory 6080 can also include data 6087. The data 6087 can include profile data 6088A, sensor data 6089A, media content data 6090, and application data 6091.

It should be appreciated that the watch body computing system 6060 is an example of a computing system within the watch body 6020, and that the watch body 6020 can have more or fewer components than shown in the watch body computing system 6060, combine two or more components, and/or have a different configuration and/or arrangement of the components. The various components shown in watch body computing system 6060 are implemented in hardware, software, firmware, or a combination thereof, including one or more signal processing and/or application-specific integrated circuits.

Turning to the wearable band computing system 6030, one or more components that can be included in the wearable band 6010 are shown. The wearable band computing system 6030 can include more or fewer components than shown in the watch body computing system 6060, combine two or more components, and/or have a different configuration and/or arrangement of some or all of the components. In some embodiments, all, or a substantial portion of the components of the wearable band computing system 6030 are included in a single integrated circuit. Alternatively, in some embodiments, components of the wearable band computing system 6030 are included in a plurality of integrated circuits that are communicatively coupled. As described above, in some embodiments, the wearable band computing system 6030 is configured to couple (e.g., via a wired or wireless connection) with the watch body computing system 6060, which allows the computing systems to share components, distribute tasks, and/or perform other operations described herein (individually or as a single device).

The wearable band computing system 6030, similar to the watch body computing system 6060, can include one or more processors 6049, one or more controllers 6047 (including one or more haptics controller 6048), a peripherals interface 6031 that can includes one or more sensors 6013 and other peripheral devices, power source (e.g., a power system 6056), and memory (e.g., a memory 6050) that includes an operating system (e.g., an operating system 6051), data (e.g., data 6054 including profile data 6088B and/or sensor data 6089B), and one or more modules (e.g., a communications interface module 6052 and/or a data management module 6053).

The one or more sensors 6013 can be analogous to sensors 6021 of the watch body computing system 6060 and in light of the definitions above. For example, sensors 6013 can include one or more coupling sensors 6032, one or more SpO2 sensor 6034, one or more EMG sensors 6035, one or more capacitive sensor 6036, one or more heart rate sensor 6037, and one or more IMU sensor 6038.

The peripherals interface 6031 can also include other components analogous to those included in the peripheral interface 6061 of the watch body computing system 6060, including an NFC component 6039, a GPS component 6040, an LTE component 6041, a Wi-Fi and/or Bluetooth communication component 6042, and/or one or more haptic devices 6076 as described above in reference to peripherals interface 6061. In some embodiments, the peripherals interface 6061 includes one or more buttons 6043, a display 6033, a speaker 6044, a microphone 6045, and a camera 6055. In some embodiments, the peripherals interface 6061 includes one or more indicators, such as an LED.

It should be appreciated that the wearable band computing system 6030 is an example of a computing system within the wearable band 6010, and that the wearable band 6010 can have more or fewer components than shown in the wearable band computing system 6030, combine two or more components, and/or have a different configuration and/or arrangement of the components. The various components shown in wearable band computing system 6030 can be implemented in one or a combination of hardware, software, firmware, including one or more signal processing and/or application-specific integrated circuits.

The wrist-wearable device 6000 with respect to FIG. 13A is an example of the wearable band 6010 and the watch body 6020 coupled, so the wrist-wearable device 6000 will be understood to include the components shown and described for the wearable band computing system 6030 and the watch body computing system 6060. In some embodiments, wrist-wearable device 6000 has a split architecture (e.g., a split mechanical architecture, a split electrical architecture) between the watch body 6020 and the wearable band 6010. In other words, all of the components shown in the wearable band computing system 6030 and the watch body computing system 6060 can be housed or otherwise disposed in a wrist-wearable device 6000, or within individual components of the watch body 6020, wearable band 6010, and/or portions thereof (e.g., a coupling mechanism 6016 of the wearable band 6010).

The techniques described above can be used with any device for sensing neuromuscular signals, including the arm-wearable devices of FIG. 13A-13B, but could also be used with other types of wearable devices for sensing neuromuscular signals (such as body-wearable or head-wearable devices that might have neuromuscular sensors closer to the brain or spinal column).

In some embodiments, a wrist-wearable device 6000 can be used in conjunction with a head-wearable device described below (e.g., AR system 7000 and VR headset 7010) and/or an HIPD 8000; and the wrist-wearable device 6000 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). In some embodiments, a wrist-wearable device 6000 can also be used in conjunction with a wearable garment, such as the wearable gloves described below in reference to FIGS. 16A-16B. Having thus described example wrist-wearable device, attention will now be turned to example head-wearable devices, such as AR system 7000 and VR system 7010.

### Example Head-wearable Devices

FIGS. 14A to 10C show example artificial-reality systems, including the AR system 7000. In some embodiments, the AR system 7000 is an eyewear device as shown in FIG. 14A. In some embodiments, the VR system 7010 includes a head-mounted display (HMD) 7012, as shown in FIGS. 14B-1 and 14B-2. In some embodiments, the AR system 7000 and the VR system 7010 include one or more analogous components (e.g., components for presenting interactive artificial-reality environments, such as processors, memory, and/or presentation devices, including one or more displays and/or one or more waveguides), some of which are described in more detail with respect to FIG. 10C. As described herein, a head-wearable device can include components of the eyewear device 7002, and/or the head-mounted display (HMD) 7012. Some embodiments of head-wearable devices do not include any displays, including any of the displays described with respect to the AR system 7000 and/or the VR system 7010. While the example artificial-reality systems are respectively described herein as the AR system 7000 and the VR system 7010, either or both of the example AR systems described herein can be configured to present fully-immersive VR scenes presented in substantially all of a user's field of view, additionally or alternatively to, subtler augmented-reality scenes that are presented within a portion, less than all, of the user's field of view.

FIG. 14A show an example visual depiction of the AR system 7000 (which may also be described herein as augmented-reality glasses, and/or smart glasses). The AR system 7000 can include additional electronic components that are not shown in FIG. 14A, such as a wearable accessory device and/or an intermediary processing device, in electronic communication or otherwise configured to be used in conjunction with the eyewear device. In some embodiments, the wearable accessory device and/or the intermediary processing device may be configured to couple with the eyewear device via a coupling mechanism in electronic communication with a coupling sensor 7024, where the coupling sensor 7024 can detect when an electronic device becomes physically or electronically coupled with the eyewear device. In some embodiments, the eyewear device is configured to couple to an optional housing 7090, which may include one or more additional coupling mechanisms configured to couple with additional accessory devices. The components shown in FIG. 14A can be implemented in hardware, software, firmware, or a combination thereof, including one or more signal-processing components and/or application-specific integrated circuits (ASICs).

The eyewear device includes mechanical glasses components, including a frame 7004 configured to hold one or more lenses (e.g., one or both lenses 7006-1 and 7006-2). One of ordinary skill in the art will appreciate that the eyewear device can include additional mechanical components, such as hinges configured to allow portions of the frame 7004 of the eyewear device 7002 to be folded and unfolded, a bridge configured to span the gap between the lenses 7006-1 and 7006-2 and rest on the user's nose, nose pads configured to rest on the bridge of the nose and provide support for the eyewear device, earpieces configured to rest on the user's ears and provide additional support for the eyewear device, temple arms configured to extend from the hinges to the earpieces of the eyewear device, and the like. One of ordinary skill in the art will further appreciate that some examples of the AR system 7000 can include none of the mechanical components described herein. For example, smart contact lenses configured to present artificial reality to users may not include any components of the eyewear device.

The eyewear device includes electronic components, many of which will be described in more detail below with respect to FIG. 10C. Some example electronic components are illustrated in FIG. 14A, including acoustic sensors 7025-1, 7025-2, 7025-3, 7025-4, 7025-5, and 7025-1, which can be distributed along a substantial portion of the frame 7004 of the eyewear device. The eyewear device also includes a left camera 7039A and a right camera 7039B, which are located on different sides of the frame 7004. And the eyewear device includes a processor 7048 (e.g., an integral microprocessor, such as an ASIC) that is embedded into a portion of the frame 7004.

FIGS. 14B-1 and 14B-2 show a VR system 7010 that includes a head-mounted display (HMD) 7012 (e.g., also referred to herein as an artificial-reality headset, a head-wearable device, or a VR headset), in accordance with some embodiments. As noted, some artificial-reality systems may (e.g., the AR system 7000), instead of blending an artificial reality with actual reality, substantially replace one or more of a user's sensory perceptions of the real world with a virtual experience (e.g., the AR systems 5000c and 5000d).

The HMD 7012 includes a front body 7014 and a frame 7016 (e.g., a strap or band) shaped to fit around a user's head. In some embodiments, the front body 7014 and/or the frame 7016 includes one or more electronic elements for facilitating presentation of and/or interactions with an AR and/or VR system (e.g., displays, IMUs, tracking emitter or detectors). In some embodiments, the HMD 7012 includes output audio transducers (e.g., an audio transducer 7018-1), as shown in FIG. 14B-2. In some embodiments, one or more components, such as the output audio transducer(s) 7018-1 and the frame 7016, can be configured to attach and detach (e.g., are detachably attachable) to the HMD 7012 (e.g., a portion or all of the frame 7016, and/or the audio transducer 7018-1), as shown in FIG. 1B-2. In some embodiments, coupling a detachable component to the HMD 7012 causes the detachable component to come into electronic communication with the HMD 7012.

FIG. 14B-1 to 14B-2 also show that the VR system 7010 one or more cameras, such as the left camera 7039A and the right camera 7039B, which can be analogous to the left and right cameras on the frame 7004 of the eyewear device 7002. In some embodiments, the VR system 7010 includes one or more additional cameras (e.g., cameras 7039C and 7039D), which can be configured to augment image data obtained by the cameras 7039A and 7039B by providing more information. For example, the camera 7039C can be used to supply color information that is not discerned by cameras 7039A and 7039B. In some embodiments, one or more of the cameras 7039A to 7039D can include an optional IR cut filter configured to remove IR light from being received at the respective camera sensors.

FIG. 10C illustrates a computing system 7020 and an optional housing 7090, each of which show components that can be included in the AR system 7000 and/or the VR system 7010. In some embodiments, more or less components can be included in the optional housing 7090 depending on practical restraints of the respective AR system being described.

In some embodiments, the computing system 7020 and/or the optional housing 7090 can include one or more peripheral interfaces 7022, one or more power systems 7042, one or more controllers 7046 (including one or more haptic controllers 7047), one or more processors 7048 (as defined above, including any of the examples provided), and memory 7050, which can all be in electronic communication with each other. For example, the one or more processors 7048 can be configured to execute instructions stored in the memory 7050, which can cause a controller of the one or more controllers 7046 to cause operations to be performed at one or more peripheral devices of the peripherals interface 7022. In some embodiments, each operation described can occur based on electrical power provided by the power system 7042.

In some embodiments, the peripherals interface 7022 can include one or more devices configured to be part of the computing system 7020, many of which have been defined above and/or described with respect to wrist-wearable devices shown in FIGS. 13A and 13B. For example, the peripherals interface can include one or more sensors 7023. Some example sensors include: one or more coupling sensors 7024, one or more acoustic sensors 7025, one or more imaging sensors 7026, one or more EMG sensors 7027, one or more capacitive sensors 7028, and/or one or more IMU sensors 7029; and/or any other types of sensors defined above or described with respect to any other embodiments discussed herein.

In some embodiments, the peripherals interface can include one or more additional peripheral devices, including one or more NFC devices 7030, one or more GPS devices 7031, one or more LTE devices 7032, one or more Wi-Fi and/or Bluetooth devices 7033, one or more buttons 7034 (e.g., including buttons that are slidable or otherwise adjustable), one or more displays 7035, one or more speakers 7036, one or more microphones 7037, one or more cameras 7038 (e.g., including the left camera 7039A and/or a right camera 7039B), and/or one or more haptic devices 7040; and/or any other types of peripheral devices defined above or described with respect to any other embodiments discussed herein.

AR systems can include a variety of types of visual feedback mechanisms (e.g., presentation devices). For example, display devices in the AR system 7000 and/or the VR system 7010 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with the user's vision. Some embodiments of AR systems also include optical subsystems having one or more lenses (e.g., conventional concave or convex lenses, Fresnel lenses, or adjustable liquid lenses) through which a user can view a display screen.

For example, respective displays can be coupled to each of the lenses 7006-1 and 7006-2 of the AR system 7000. The displays coupled to each of the lenses 7006-1 and 7006-2 can act together or independently to present an image or series of images to a user. In some embodiments, the AR system 7000 includes a single display (e.g., a near-eye display) or more than two displays. In some embodiments, a first set of one or more displays can be used to present an augmented-reality environment, and a second set of one or more display devices can be used to present a virtual-reality environment. In some embodiments, one or more waveguides are used in conjunction with presenting artificial-reality content to the user of the AR system 7000 (e.g., as a means of delivering light from one or more displays to the user's eyes). In some embodiments, one or more waveguides are fully or partially integrated into the eyewear device 7002. Additionally, or alternatively to display screens, some artificial-reality systems include one or more projection systems. For example, display devices in the AR system 7000 and/or the VR system 7010 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s).

The computing system 7020 and/or the optional housing 7090 of the AR system 7000 or the VR system 7010 can include some or all of the components of a power system 7042. The power system 7042 can include one or more charger inputs 7043, one or more PMICs 7044, and/or one or more batteries 7045.

The memory 7050 includes instructions and data, some or all of which may be stored as non-transitory computer-readable storage media within the memory 7050. For example, the memory 7050 can include one or more operating systems 7051; one or more applications 7052; one or more communication interface applications 7053; one or more graphics applications 7054; one or more AR processing applications 7055; and/or any other types of data defined above or described with respect to any other embodiments discussed herein.

The memory 7050 also includes data 7060 which can be used in conjunction with one or more of the applications discussed above. The data 7060 can include: profile data 7061; sensor data 7062; media content data 7063; AR application data 7064; and/or any other types of data defined above or described with respect to any other embodiments discussed herein.

In some embodiments, the controller 7046 of the eyewear device 7002 processes information generated by the sensors 7023 on the eyewear device 7002 and/or another electronic device within the AR system 7000. For example, the controller 7046 can process information from the acoustic sensors 7025-1 and 7025-2. For each detected sound, the controller 7046 can perform a direction of arrival (DOA) estimation to estimate a direction from which the detected sound arrived at the eyewear device 7002 of the AR system 7000. As one or more of the acoustic sensors 7025 detects sounds, the controller 7046 can populate an audio data set with the information (e.g., represented in FIG. 10C as sensor data 7062).

In some embodiments, a physical electronic connector can convey information between the eyewear device and another electronic device, and/or between one or more processors of the AR system 7000 or the VR system 7010 and the controller 7046. The information can be in the form of optical data, electrical data, wireless data, or any other transmittable data form. Moving the processing of information generated by the eyewear device to an intermediary processing device can reduce weight and heat in the eyewear device, making it more comfortable and safer for a user. In some embodiments, an optional wearable accessory device (e.g., an electronic neckband) is coupled to the eyewear device via one or more connectors. The connectors can be wired or wireless connectors and can include electrical and/or non-electrical (e.g., structural) components. In some embodiments, the eyewear device and the wearable accessory device can operate independently without any wired or wireless connection between them.

In some situations, pairing external devices, such as an intermediary processing device (e.g., the HIPD 8000) with the eyewear device 7002 (e.g., as part of the AR system 7000) enables the eyewear device 7002 to achieve a similar form factor of a pair of glasses while still providing sufficient battery and computation power for expanded capabilities. Some, or all, of the battery power, computational resources, and/or additional features of the AR system 7000 can be provided by a paired device or shared between a paired device and the eyewear device 7002, thus reducing the weight, heat profile, and form factor of the eyewear device 7002 overall while allowing the eyewear device 7002 to retain its desired functionality. For example, the wearable accessory device can allow components that would otherwise be included on an eyewear device 7002 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the eyewear device 7002, standing alone. Because weight carried in the wearable accessory device can be less invasive to a user than weight carried in the eyewear device 7002, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, the AR system 7000 and/or the VR system 7010 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 14B-1 and 14B-2 show the VR system 7010 having cameras 7039A to 7039D, which can be used to provide depth information for creating a voxel field and a two-dimensional mesh to provide object information to the user to avoid collisions.

In some embodiments, the AR system 7000 and/or the VR system 7010 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., the haptic feedback system described with respect to FIGS. 16A to 16B).

In some embodiments of an AR system, such as the AR system 7000 and/or the VR system 7010, ambient light (e.g., a live feed of the surrounding environment that a user would normally see) can be passed through a display element of a respective head-wearable device presenting aspects of the AR system. In some embodiments, ambient light can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment. For example, a visual user interface element (e.g., a notification user interface element) can be presented at the head-wearable device, and an amount of ambient light (e.g., 15-50% of the ambient light) can be passed through the user interface element, such that the user can distinguish at least a portion of the physical environment over which the user interface element is being displayed.

### Example Handheld Intermediary Processing Devices

FIGS. 15A and 15B illustrate an example handheld intermediary processing device (HIPD) 8000, in accordance with some embodiments. The HIPD 8000 is an instance of the intermediary device described herein, such that the HIPD 8000 should be understood to have the features described with respect to any intermediary device defined above or otherwise described herein, and vice versa. FIG. 15A shows a top view 8005 and a side view 8025 of the HIPD 8000. The HIPD 8000 is configured to communicatively couple with one or more wearable devices (or other electronic devices) associated with a user. For example, the HIPD 8000 is configured to communicatively couple with a user's wrist-wearable device 6000 (or components thereof, such as the watch body 6020 and the wearable band 6010), AR system 7000, and/or VR system 7010. The HIPD 8000 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 8000 can successfully be communicatively coupled with an electronic device, such as a wearable device).

The HIPD 8000 can perform various functions independently and/or in conjunction with one or more wearable devices (e.g., wrist-wearable device 6000, AR system 7000, and/or VR headset 7010). The HIPD 8000 is configured to increase and/or improve the functionality of communicatively coupled devices, such as the wearable devices. The HIPD 8000 is configured to perform one or more functions or operations associated with interacting with user interfaces and applications of communicatively coupled devices, interacting with an AR environment, interacting with VR environment, and/or operating as a human-machine interface controller. Additionally, as will be described in more detail below, functionality and/or operations of the HIPD 8000 can include, without limitation, task offloading and/or handoffs; thermals offloading and/or handoffs; 6 degrees of freedom (6DoF) raycasting and/or gaming (e.g., using imaging devices or cameras 8014, which can be used for simultaneous localization and mapping (SLAM) and/or with other image processing techniques); portable charging; messaging; image capturing via one or more imaging devices or cameras 8022; sensing user input (e.g., sensing a touch on a touch input surface 8002); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 8000 and/or in communication between the HIPD 8000 and another wearable device described herein. In some embodiments, functions can be executed on the HIPD 8000 in conjunction with an AR environment. As the skilled artisan will appreciate upon reading the descriptions provided herein, the novel the HIPD 8000 described herein can be used with any type of suitable AR environment.

While the HIPD 8000 is communicatively coupled with a wearable device and/or other electronic device, the HIPD 8000 is configured to perform one or more operations initiated at the wearable device and/or the other electronic device. In particular, one or more operations of the wearable device and/or the other electronic device can be offloaded to the HIPD 8000 to be performed. The HIPD 8000 performs the one or more operations of the wearable device and/or the other electronic device and provides to data corresponded to the completed operations to the wearable device and/or the other electronic device. For example, a user can initiate a video stream using AR system 7000 and back-end tasks associated with performing the video stream (e.g., video rendering) can be offloaded to the HIPD 8000, which the HIPD 8000 performs and provides corresponding data to the AR system 7000 to perform remaining front-end tasks associated with the video stream (e.g., presenting the rendered video data via a display of the AR system 7000). In this way, the HIPD 8000, which has more computational resources and greater thermal headroom than a wearable device, can perform computationally intensive tasks for the wearable device improving performance of an operation performed by the wearable device.

The HIPD 8000 includes a multi-touch input surface 8002 on a first side (e.g., a front surface) that is configured to detect one or more user inputs. In particular, the multi-touch input surface 8002 can detect single tap inputs, multi-tap inputs, swipe gestures and/or inputs, force-based and/or pressure-based touch inputs, held taps, and the like. The multi-touch input surface 8002 is configured to detect capacitive touch inputs and/or force (and/or pressure) touch inputs. The multi-touch input surface 8002 includes a touch-input surface 8004 defined by a surface depression, and a touch-input surface 8006 defined by a substantially planar portion. The touch-input surface 8004 can be disposed adjacent to the touch-input surface 8006. In some embodiments, the touch-input surface 8004 and the touch-input surface 8006 can be different dimensions, shapes, and/or cover different portions of the multi-touch input surface 8002. For example, the touch-input surface 8004 can be substantially circular and the touch-input surface 8006 is substantially rectangular. In some embodiments, the surface depression of the multi-touch input surface 8002 is configured to guide user handling of the HIPD 8000. In particular, the surface depression is configured such that the user holds the HIPD 8000 upright when held in a single hand (e.g., such that the using imaging devices or cameras 8014A and 8014B are pointed toward a ceiling or the sky). Additionally, the surface depression is configured such that the user's thumb rests within the touch-input surface 8004.

In some embodiments, the different touch-input surfaces include a plurality of touch-input zones. For example, the touch-input surface 8006 includes at least a touch-input zone 8008 within a touch-input surface 8006 and a touch-input zone 8010 within the touch-input zone 8008. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the touch-input zone 8008 causes the HIPD 8000 to perform a first command and a user input detected within the touch-input surface 8006 causes the HIPD 8000 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the touch-input zone 8008 can be configured to detect force touch inputs (e.g., a magnitude at which the user presses down) and capacitive touch inputs, and the touch-input surface 8006 can be configured to detect capacitive touch inputs.

The HIPD 8000 includes one or more sensors 8051 for sensing data used in the performance of one or more operations and/or functions. For example, the HIPD 8000 can include an IMU sensor that is used in conjunction with cameras 8014 for 3-dimensional object manipulation (e.g., enlarging, moving, or destroying an object) in an AR or VR environment. Non-limiting examples of the sensors 8051 included in the HIPD 8000 include a light sensor, a magnetometer, a depth sensor, a pressure sensor, and a force sensor. Additional examples of the sensors 8051 are provided below in reference to FIG. 15B.

The HIPD 8000 can include one or more light indicators 8012 to provide one or more notifications to the user. In some embodiments, the light indicators are LEDs or other types of illumination devices. The light indicators 8012 can operate as a privacy light to notify the user and/or others near the user that an imaging device and/or microphone are active. In some embodiments, a light indicator is positioned adjacent to one or more touch-input surfaces. For example, a light indicator can be positioned around the touch-input surface 8004. The light indicators can be illuminated in different colors and/or patterns to provide the user with one or more notifications and/or information about the device. For example, a light indicator positioned around the touch-input surface 8004 can flash when the user receives a notification (e.g., a message), change red when the HIPD 8000 is out of power, operate as a progress bar (e.g., a light ring that is closed when a task is completed (e.g., 0% to 100%)), operates as a volume indicator, etc.).

In some embodiments, the HIPD 8000 includes one or more additional sensors on another surface. For example, as shown FIG. 15A, HIPD 8000 includes a set of one or more sensors (e.g., sensor set 8020) on an edge of the HIPD 8000. The sensor set 8020, when positioned on an edge of the of the HIPD 8000, can be pe positioned at a predetermined tilt angle (e.g., 26 degrees), which allows the sensor set 8020 to be angled toward the user when placed on a desk or other flat surface. Alternatively, in some embodiments, the sensor set 8020 is positioned on a surface opposite the multi-touch input surface 8002 (e.g., a back surface). The one or more sensors of the sensor set 8020 are discussed in detail below.

The side view 8025 of the of the HIPD 8000 shows the sensor set 8020 and camera 8014B. The sensor set 8020 includes one or more cameras 8022A and 8022B, a depth projector 8024, an ambient light sensor 8028, and a depth receiver 8030. In some embodiments, the sensor set 8020 includes a light indicator 8026. The light indicator 8026 can operate as a privacy indicator to let the user and/or those around them know that a camera and/or microphone is active. The sensor set 8020 is configured to capture a user's facial expression such that the user can puppet a custom avatar (e.g., showing emotions, such as smiles and/or laughter on the avatar or a digital representation of the user). The sensor set 8020 can be configured as a side stereo RGB system, a rear indirect Time-of-Flight (iToF) system, or a rear stereo RGB system. As the skilled artisan will appreciate upon reading the descriptions provided herein, the HIPD 8000 described herein can use different sensor set 8020 configurations and/or sensor set 8020 placements.

In some embodiments, the HIPD 8000 includes one or more haptic devices 8071 (e.g., a vibratory haptic actuator) that are configured to provide haptic feedback (e.g., kinesthetic sensation). The sensors 8051, and/or the haptic devices 8071 can be configured to operate in conjunction with multiple applications and/or communicatively coupled devices including, without limitation, wearable devices, health monitoring applications, social media applications, game applications, and artificial reality applications (e.g., the applications associated with artificial reality).

The HIPD 8000 is configured to operate without a display. However, in optional embodiments, the HIPD 8000 can include a display 8068 (FIG. 15B). The HIPD 8000 can also income one or more optional peripheral buttons 8067 (FIG. 15B). For example, the peripheral buttons 8067 can be used to turn on or turn off the HIPD 8000. Further, the HIPD 8000 housing can be formed of polymers and/or elastomer elastomers. The HIPD 8000 can be configured to have a non-slip surface to allow the HIPD 8000 to be placed on a surface without requiring a user to watch over the HIPD 8000. In other words, the HIPD 8000 is designed such that it would not easily slide off surfaces. In some embodiments, the HIPD 8000 include one or magnets to couple the HIPD 8000 to another surface. This allows the user to mount the HIPD 8000 to different surfaces and provide the user with greater flexibility in use of the HIPD 8000.

As described above, the HIPD 8000 can distribute and/or provide instructions for performing the one or more tasks at the HIPD 8000 and/or a communicatively coupled device. For example, the HIPD 8000 can identify one or more back-end tasks to be performed by the HIPD 8000 and one or more front-end tasks to be performed by a communicatively coupled device. While the HIPD 8000 is configured to offload and/or handoff tasks of a communicatively coupled device, the HIPD 8000 can perform both back-end and front-end tasks (e.g., via one or more processors, such as CPU 8077; FIG. 15B). The HIPD 8000 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 8000 can perform the above operations alone or in conjunction with a wearable device (or other communicatively coupled electronic device).

FIG. 15B shows block diagrams of a HIPD computing system 8040 of the HIPD 8000, in accordance with some embodiments. The HIPD 8000, described in detail above, can include one or more components shown in HIPD computing system 8040. The HIPD 8000 will be understood to include the components shown and described below for the HIPD computing system 8040. In some embodiments, all, or a substantial portion of the components of the HIPD computing system 8040 are included in a single integrated circuit. Alternatively, in some embodiments, components of the HIPD computing system 8040 are included in a plurality of integrated circuits that are communicatively coupled.

The HIPD computing system 8040 can include a processor (e.g., a CPU 8077, a GPU, and/or a CPU with integrated graphics), a controller 8075, a peripherals interface 8050 that includes one or more sensors 8051 and other peripheral devices, a power source (e.g., a power system 8095), and memory (e.g., a memory 8078) that includes an operating system (e.g., an operating system 8079), data (e.g., data 8088), one or more applications (e.g., applications 8080), and one or more modules (e.g., a communications interface module 8081, a graphics module 8082, a task and processing management module 8083, an interoperability module 8084, an AR processing module 8085, and/or a data management module 8086). The HIPD computing system 8040 further includes a power system 8095 that includes a charger input and output 8096, a PMIC 8097, and a battery 8098, all of which are defined above.

In some embodiments, the peripherals interface 8050 can include one or more sensors 8051. The sensors 8051 can include analogous sensors to those described above in reference to FIG. 13B. For example, the sensors 8051 can include imaging sensors 8054, (optional) EMG sensors 8056, IMU sensors 8058, and capacitive sensors 8060. In some embodiments, the sensors 8051 can include one or more pressure sensor 8052 for sensing pressure data, an altimeter 8053 for sensing an altitude of the HIPD 8000, a magnetometer 8055 for sensing a magnetic field, a depth sensor 8057 (or a time-of flight sensor) for determining a difference between the camera and the subject of an image, a position sensor 8059 (e.g., a flexible position sensor) for sensing a relative displacement or position change of a portion of the HIPD 8000, a force sensor 8061 for sensing a force applied to a portion of the HIPD 8000, and a light sensor 8062 (e.g., an ambient light sensor) for detecting an amount of lighting. The sensors 8051 can include one or more sensors not shown in FIG. 15B.

Analogous to the peripherals described above in reference to FIG. 13B, the peripherals interface 8050 can also include an NFC component 8063, a GPS component 8064, an LTE component 8065, a Wi-Fi and/or Bluetooth communication component 8066, a speaker 8069, a haptic device 8071, and a microphone 8073. As described above in reference to FIG. 15A, the HIPD 8000 can optionally include a display 8068 and/or one or more optional peripheral buttons 8067. The peripherals interface 8050 can further include one or more cameras 8070, touch surfaces 8072, and/or one or more light emitters 8074. The multi-touch input surface 8002 described above in reference to FIG. 17A is an example of touch surface 8072. The light emitters 8074 can be one or more LEDs, lasers, etcetera, and can be used to project or present information to a user. For example, the light emitters 8074 can include light indicators 8012 and 8026 described above in reference to FIG. 15A. The cameras 8070 (e.g., cameras 8014 and 8022 described above in FIG. 15A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 8070 can be used for SLAM; 6 DoF ray casting, gaming, object manipulation, and/or other rendering; facial recognition and facial expression recognition, etc.

Similar to the watch body computing system 6060 and the wearable band computing system 6030 described above in reference to FIG. 13B, the HIPD computing system 8040 can include one or more haptic controllers 8076 and associated componentry (e.g., haptic devices 8071) for providing haptic events at the HIPD 8000.

Memory 8078 can include high-speed random-access memory and/or non-volatile memory, such as one or more magnetic disk storage devices, flash memory devices, or other non-volatile solid-state memory devices. Access to the memory 8078 by other components of the HIPD 8000, such as the one or more processors and the peripherals interface 8050, can be controlled by a memory controller of the controllers 8075.

In some embodiments, software components stored in the memory 8078 include one or more operating systems 8079, one or more applications 8080, one or more communication interface modules 8081, one or more graphics modules 8082, one or more data management modules 8086, which are analogous to the software components described above in reference to FIG. 13B.

In some embodiments, software components stored in the memory 8078 include a task and processing management module 8083 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 8083 uses data 8088 (e.g., device data 8090) to distribute the one or more front-end and/or back-end tasks based on communicatively coupled devices'computing resources, available power, thermal headroom, ongoing operations, and/or other factors. For example, the task and processing management module 8083 can cause the performance of one or more back-end tasks (of an operation performed at communicatively coupled AR system 7000) at the HIPD 8000 in accordance with a determination that the operation is utilizing a predetermined amount (e.g., at least 70%) of computing resources available at the AR system 7000.

In some embodiments, software components stored in the memory 8078 include an interoperability module 8084 for exchanging and utilizing information received and/or provided to distinct communicatively coupled devices. The interoperability module 8084 allows for different systems, devices, and/or applications to connect and communicate in a coordinated way without user input. In some embodiments, software components stored in the memory 8078 include an AR processing module 8085 that is configured to process signals based at least on sensor data for use in an AR and/or VR environment. For example, the AR processing module 8085 can be used for 3D object manipulation, gesture recognition, facial and facial expression, and/or recognition.

The memory 8078 can also include data 8088, including structured data. In some embodiments, the data 8088 includes profile data 8089, device data 8090 (including device data of one or more devices communicatively coupled with the HIPD 8000, such as device type, hardware, software, and/or configurations), sensor data 8091, media content data 8092, and application data 8093.

It should be appreciated that the HIPD computing system 8040 is an example of a computing system within the HIPD 8000, and that the HIPD 8000 can have more or fewer components than shown in the HIPD computing system 8040, combine two or more components, and/or have a different configuration and/or arrangement of the components. The various components shown in HIPD computing system 8040 are implemented in hardware, software, firmware, or a combination thereof, including one or more signal processing and/or application-specific integrated circuits.

The techniques described above in FIG. 15A-15B can be used with any device used as a human-machine interface controller. In some embodiments, an HIPD 8000 can be used in conjunction with one or more wearable device such as a head-wearable device (e.g., AR system 7000 and VR system 7010) and/or a wrist-wearable device 6000 (or components thereof). In some embodiments, an HIPD 8000 is used in conjunction with a wearable garment, such as the wearable gloves of FIGS. 16A-16B. Having thus described example HIPD 8000, attention will now be turned to example feedback devices, such as device 9000.

### Example Feedback Devices

FIGS. 16A and 16B show example haptic feedback systems (e.g., hand-wearable devices) for providing feedback to a user regarding the user's interactions with a computing system (e.g., an artificial-reality environment presented by the AR system 7000 or the VR system 7010). In some embodiments, a computing system (e.g., the AR system 5000d) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 9062 of the device 9000 (e.g., haptic assemblies 9062-1, 9062-2, and 9062-3). For example, the haptic feedback may prevent (or, at a minimum, hinder/resist movement of) one or more fingers of a user from bending past a certain point to simulate the sensation of touching a solid coffee mug. In actuating such haptic effects, the device 9000 can change (either directly or indirectly) a pressurized state of one or more of the haptic assemblies 9062.

Each of the haptic assemblies 9062 includes a mechanism that, at a minimum, provides resistance when the respective haptic assembly 9062 is transitioned from a first pressurized state (e.g., atmospheric pressure or deflated) to a second pressurized state (e.g., inflated to a threshold pressure). Structures of haptic assemblies 9062 can be integrated into various devices configured to be in contact or proximity to a user's skin, including, but not limited to devices such as glove worn devices, body worn clothing device, and headset devices.

As noted above, the haptic assemblies 9062 described herein can be configured to transition between a first pressurized state and a second pressurized state to provide haptic feedback to the user. Due to the ever-changing nature of artificial reality, the haptic assemblies 9062 may be required to transition between the two states hundreds, or perhaps thousands of times, during a single use. Thus, the haptic assemblies 9062 described herein are durable and designed to quickly transition from state to state. To provide some context, in the first pressurized state, the haptic assemblies 9062 do not impede free movement of a portion of the wearer's body. For example, one or more haptic assemblies 9062 incorporated into a glove are made from flexible materials that do not impede free movement of the wearer's hand and fingers (e.g., an electrostatic-zipping actuator). The haptic assemblies 9062 are configured to conform to a shape of the portion of the wearer's body when in the first pressurized state. However, once in the second pressurized state, the haptic assemblies 9062 can be configured to restrict and/or impede free movement of the portion of the wearer's body (e.g., appendages of the user's hand). For example, the respective haptic assembly 9062 (or multiple respective haptic assemblies) can restrict movement of a wearer's finger (e.g., prevent the finger from curling or extending) when the haptic assembly 9062 is in the second pressurized state. Moreover, once in the second pressurized state, the haptic assemblies 9062 may take different shapes, with some haptic assemblies 9062 configured to take a planar, rigid shape (e.g., flat and rigid), while some other haptic assemblies 9062 are configured to curve or bend, at least partially.

As a non-limiting example, the device 9000 includes a plurality of haptic devices (e.g., a pair of haptic gloves, and a haptics component of a wrist-wearable device (e.g., any of the wrist-wearable devices described with respect to FIG. 13A. Each of which can include a garment component (e.g., a garment 9004) and one or more haptic assemblies coupled (e.g., physically coupled) to the garment component. For example, each of the haptic assemblies 9062-1, 9062-2, 9062-3, 9062-4, . . . 9062-N are physically coupled to the garment 9004 are configured to contact respective phalanges of a user's thumb and fingers. As explained above, the haptic assemblies 9062 are configured to provide haptic simulations to a wearer of the device 9000. The garment 9004 of each device 9000 can be one of various articles of clothing (e.g., gloves, socks, shirts, or pants). Thus, a user may wear multiple devices 9000 that are each configured to provide haptic stimulations to respective parts of the body where the devices 9000 are being worn.

FIG. 16B shows block diagrams of a computing system 9040 of the device 9000, in accordance with some embodiments. The computing system 9040 can include one or more peripheral interfaces 9050, one or more power systems 9095, one or more controllers 9075 (including one or more haptic controllers 9076), one or more processors 9077 (as defined above, including any of the examples provided), and memory 9078, which can all be in electronic communication with each other. For example, the one or more processors 9077 can be configured to execute instructions stored in the memory 9078, which can cause a controller of the one or more controllers 9075 to cause operations to be performed at one or more peripheral devices of the peripherals interface 9050. In some embodiments, each operation described can occur based on electrical power provided by the power system 9095. The power system 9095 includes a charger input 9096, a PMIC 9097, and a battery 9098.

In some embodiments, the peripherals interface 9050 can include one or more devices configured to be part of the computing system 9040, many of which have been defined above and/or described with respect to wrist-wearable devices shown in FIGS. 13A and 13B. For example, the peripherals interface 9050 can include one or more sensors 9051. Some example sensors include:
one or more pressure sensors 9052, one or more EMG sensors 9056, one or more IMU sensors 9058, one or more position sensors 9059, one or more capacitive sensors 9060, one or more force sensors 9061; and/or any other types of sensors defined above or described with respect to any other embodiments discussed herein.

In some embodiments, the peripherals interface can include one or more additional peripheral devices, including one or more Wi-Fi and/or Bluetooth devices 9068; one or more haptic assemblies 9062; one or more support structures 9063 (which can include one or more bladders 9064; one or more manifolds 9065; one or more pressure-changing devices 9067; and/or any other types of peripheral devices defined above or described with respect to any other embodiments discussed herein.

In some embodiments, each haptic assembly 9062 includes a support structure 9063, and at least one bladder 9064. The bladder 9064 (e.g., a membrane) is a sealed, inflatable pocket made from a durable and puncture resistance material, such as thermoplastic polyurethane (TPU), a flexible polymer, or the like. The bladder 9064 contains a medium (e.g., a fluid such as air, inert gas, or even a liquid) that can be added to or removed from the bladder 9064 to change a pressure (e.g., fluid pressure) inside the bladder 9064. The support structure 9063 is made from a material that is stronger and stiffer than the material of the bladder 9064. A respective support structure 9063 coupled to a respective bladder 9064 is configured to reinforce the respective bladder 9064 as the respective bladder changes shape and size due to changes in pressure (e.g., fluid pressure) inside the bladder.

The device 9000 also includes a haptic controller 9076 and a pressure-changing device 9067. In some embodiments, the haptic controller 9076 is part of the computer system 9040 (e.g., in electronic communication with one or more processors 9077 of the computer system 9040). The haptic controller 9076 is configured to control operation of the pressure-changing device 9067, and in turn operation of the device 9000. For example, the haptic controller 9076 sends one or more signals to the pressure-changing device 9067 to activate the pressure-changing device 9067 (e.g., turn it on and off). The one or more signals may specify a desired pressure (e.g., pounds-per-square inch) to be output by the pressure-changing device 9067. Generation of the one or more signals, and in turn the pressure output by the pressure-changing device 9067, may be based on information collected by the sensors in FIG. 16A. For example, the one or more signals may cause the pressure-changing device 9067 to increase the pressure (e.g., fluid pressure) inside a haptic assembly 9062 at a first time, based on the information collected by the sensors in FIG. 16A (e.g., the user makes contact with an artificial coffee mug). Then, the controller may send one or more additional signals to the pressure-changing device 9067 that cause the pressure-changing device 9067 to further increase the pressure inside the haptic assembly 9062 at a second time after the first time, based on additional information collected by the sensors 9051. Further, the one or more signals may cause the pressure-changing device 9067 to inflate one or more bladders 9064 in a device 9000-A, while one or more bladders 9064 in a device 9000-B remain unchanged. Additionally, the one or more signals may cause the pressure-changing device 9067 to inflate one or more bladders 9064 in a device 9000-A to a first pressure and inflate one or more other bladders 9064 in the device 9000-A to a second pressure different from the first pressure. Depending on the number of devices 9000 serviced by the pressure-changing device 9067, and the number of bladders therein, many different inflation configurations can be achieved through the one or more signals and the examples above are not meant to be limiting.

The device 9000 may include an optional manifold 9065 between the pressure-changing device 9067 and the devices 9000. The manifold 9065 may include one or more valves (not shown) that pneumatically couple each of the haptic assemblies 9062 with the pressure-changing device 9067 via tubing. In some embodiments, the manifold 9065 is in communication with the controller 9075, and the controller 9075 controls the one or more valves of the manifold 9065 (e.g., the controller generates one or more control signals). The manifold 9065 is configured to switchably couple the pressure-changing device 9067 with one or more haptic assemblies 9062 of the same or different devices 9000 based on one or more control signals from the controller 9075. In some embodiments, instead of using the manifold 9065 to pneumatically couple the pressure-changing device 9067 with the haptic assemblies 9062, the device 9000 may include multiple pressure-changing devices 9067, where each pressure-changing device 9067 is pneumatically coupled directly with a single (or multiple) haptic assembly 9062. In some embodiments, the pressure-changing device 9067 and the optional manifold 9065 are configured as part of one or more of the devices 9000 (not illustrated) while, in other embodiments, the pressure-changing device 9067 and the optional manifold 9065 are configured as external to the device 9000. A single pressure-changing device 9067 may be shared by multiple devices 9000.

In some embodiments, the pressure-changing device 9067 is a pneumatic device, hydraulic device, a pneudraulic device, or some other device capable of adding and removing a medium (e.g., fluid, liquid, gas) from the one or more haptic assemblies 9062.

The devices shown in FIGS. 16A to 16B may be coupled via a wired connection (e.g., via busing). Alternatively, one or more of the devices shown in FIGS. 16A to 16B may be wirelessly connected (e.g., via short-range communication signals).

The memory 9078 includes instructions and data, some or all of which may be stored as non-transitory computer-readable storage media within the memory 9078. For example, the memory 9078 can include one or more operating systems 9079; one or more communication interface applications 9081; one or more interoperability modules 9084; one or more AR processing applications 9085; one or more data management modules 9086; and/or any other types of data defined above or described with respect to any other embodiments discussed herein.

The memory 9078 also includes data 9088 which can be used in conjunction with one or more of the applications discussed above. The data 9088 can include: device data 9090; sensor data 9091; and/or any other types of data defined above or described with respect to any other embodiments discussed herein.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A wearable device configured to communicate via a body area network, comprising:
a transmitter integrated into the wearable device including at least one transmitter electrode electrically coupled to a body of a wearer, the transmitter configured to transmit one or more signals to a second wearable device;
a variable impedance component coupled to the transmitter; and
at least one floating ground integrated into the wearable device and electrically insulated from the body of the wearer.

2. The wearable device of claim 1, wherein the wearable device is a head-wearable device, and the transmitter is electrically coupled to a nose, temple, or forehead of the wearer.

3. The wearable device of claim 1, wherein the wearable device is an ear-wearable device, and the transmitter comprises one or more charging contacts integrated into the ear-wearable device.

4. The wearable device of claim 1, wherein the wearable device is a wrist-wearable device, and wherein the transmitter electrode is electrically coupled to a wrist of the wearer.

5. The wearable device of claim 1, wherein the transmitter electrode comprises a dry electrode contacting the wearer's skin.

6. The wearable device of claim 1, wherein the transmitter comprises multiple contact points positioned at different locations on the wearable device.

7. The wearable device of claim 1, wherein the variable impedance component is configured to generate a transmission impedance that matches a receiver impedance of the second wearable device.

8. The wearable device of claim 1, wherein the at least one floating ground is integrated with a wireless communication antenna of the wearable device.

9. The wearable device of claim 1, wherein the transmitter electrode is further configured to perform a second function distinct from transmitting the one or more signals, and wherein the wearable device further comprises a controller configured to manage operation of the transmitter electrode.

10. The wearable device of claim 1, wherein the transmitter comprises a transceiver.

11. The wearable device of claim 1, further comprising a receiver integrated into the wearable device including at least one receiver electrode electrically coupled to the body of the wearer, the receiver configured to receive one or more signals from the body area network.

12. The wearable device of claim 1, further comprising control circuitry configured to determine body movement of the wearer by analyzing signal transmission via the body area network.

13. A method of communicating via a body area network using a wearable device, comprising:
adjusting a variable impedance of a transmitter integrated into the wearable device based on an impedance of a body of a wearer of the wearable device;
maintaining electrical insulation between at least one floating ground integrated into the wearable device and the body of the wearer, wherein the floating ground provides a return path for body area network communications; and
transmitting one or more signals from the transmitter via at least one transmitter electrode electrically coupled to the body of the wearer.

14. The method of claim 13, wherein the transmitter includes a plurality of transmitter electrodes, and wherein the method further comprises selecting the at least one transmitter electrode from the plurality of transmitter electrodes based on a signal quality metric for the at least one transmitter.

15. The method of claim 13, wherein the electrical insulation between the at least one floating ground integrated into the wearable device and the body of the wearer is maintained using one or more frequency-based separation components.

16. The method of claim 13, further comprising performing an operation at the wearable device that comprises using the transmitter electrode for a function that is distinct from transmitting the one or more signals.

17. The method of claim 16, wherein the function that is distinct from transmitting the one or more signals comprises a sensing function.

18. The method of claim 13, further comprising receiving one or more incoming signals from the body area network using a receiver integrated into the wearable device, the receiver including at least one receiver electrode electrically coupled to the body of the wearer.

19. The method of claim 13, wherein the variable impedance of the transmitter is adjusted using open-loop feedback.

20. The method of claim 13, wherein the variable impedance of the transmitter is adjusted using closed-loop feedback.
